(19) United States
(12) Patent Application Publication
(10) Pub. No.: US 2024/0296185 A1
(43) Pub. Date: Sep. 5, 2024

(54) TIME-SERIES MESSAGE MANAGEMENT USING GRAPH-BASED MODELS

(71) Applicant: INFOSYS LIMITED, Bangalore (IN)

(72) Inventor: Steven SCHILDERS, Columbus, IN (US)

(73) Assignees: INFOSYS LIMITED, Bangalore (IN); INVERTIT INC., Columbus, IN (US)

(21) Appl. No.: 18/587,446

(22) Filed: Feb. 26, 2024

Related U.S. Application Data
(60) Provisional application No. 63/449,224, filed on Mar. 1, 2023.
(60) Provisional application No. 63/448,747, filed on Feb. 28, 2023.
(60) Provisional application No. 63/448,738, filed on Feb. 28, 2023.
(60) Provisional application No. 63/448,831, filed on Feb. 28, 2023.

(51) Int. Cl. G06F 16/901

(52) U.S. Cl. CPC G06F 16/9024

(57) ABSTRACT

An overlay system is provided that includes a storage element and processing circuitry. The storage element stores an executable graph-based model that includes various executable nodes that communicate with each other by way of messages. The executable graph-based model further includes a message node for each message associated with the overlay system. Each message node is associated with one or more time-series analytics overlay nodes that execute a corresponding set of time-series computation functions on the corresponding message node. A publisher overlay node associated with each time-series analytics overlay node may generate and publish a statistical insight based on an output of each corresponding time-series computation function. The processing circuitry may use the statistical insight to generate an analytics outcome.

### CROSS-REFERENCE TO RELATED APPLICATIONS/INCORPORATION BY REFERENCE

This patent application refers to, claims priority to, and claims the benefit of U.S. Provisional Application Ser. No. 63/449,224 filed Mar. 1, 2023; 63/448,747, filed Feb. 28, 2023; 63/448,738, filed Feb. 28, 2023, and 63/448,831, filed Feb. 28, 2023, the contents of which are hereby incorporated herein by reference in its entirety.

### FIELD OF THE DISCLOSURE

Various embodiments of the present disclosure relate generally to graph-based models. More specifically, various embodiments of the present disclosure relate to time-series message management using executable graph-based models.

### BACKGROUND

Most things that we come across in our day-to-day lives are linked with technology in some way. For example, books we read are written and published using technology, the water we drink gets purified using technology, the food we eat gets cooked using technology, vehicles we use have technology, and so on. These and many other technology-based processes employ multiple modules that communicate with each other to accomplish one or more associated tasks. As each module and tasks associated therewith are significantly dependent on the communication with other modules, optimal performance of the module may be achieved only when wait-time (latency) associated with the communication remains minimal. Hence, in order to optimize such processes, latency associated with the communication among the modules is required to be minimized. To minimize the latency, idle time and time-consuming processes associated with the communication need to be identified. Such identification may be performed by analysing transactional information associated with messages being communicated between the modules.

Traditionally, such analysis is performed by a separate analytics system that analyses the transactional information of the messages being communicated by the modules and generates analytics information associated with the modules. Further, based on the analytics information, functionalities of the modules are modified in order to minimize the latency and optimize the communication among the modules. However, such an approach to performing analytics is not optimal as sometimes the analytics information generated by the analytics system may become outdated before it gets implemented. Notably, use of such outdated analytics information may be harmful rather than beneficial to the communication among the modules. Moreover, the messages and transactional information associated therewith are to be communicated from a native system associated with the modules to the analytics system. Hence, such communication is dependent on network availability. Further, such analytics is not performed in real-time, hence, any measure to be taken to minimize the latency and optimize the performance of the modules gets delayed. Therefore, time that could have been productive gets spent on waiting for the analytics information. Consequently, the analytics system is inefficient and often causes loss of time and money due to delays in the generation of analytics information. Moreover, in some instances, the analytics system may require to access information that is inherent to the native system. Such information may not be communicated to the analytics system as it may not be part of any message being communicated. Hence, unavailability of such information may lead to generation of suboptimal analytics information.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating time-series message management using an executable graph-based model are provided substantially as shown in, and described in connection with, at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, in accordance with an embodiment of the present disclosure;

FIG. 2 is a block diagram that illustrates a system environment of an overlay system for execution, management, and configuration of executable graph-based models, in accordance with an embodiment of the present disclosure;

FIG. 3 is a block diagram that illustrates a generic structure of a node within the executable graph-based model, in accordance with an embodiment of the present disclosure;

FIG. 4 is a block diagram that illustrates an executable node within the executable graph-based model, in accordance with an embodiment of the present disclosure;

FIG. 5 is a block diagram that illustrates a composition of the executable node that enables persistent storage of data and processing logic associated therewith, in accordance with an embodiment of the present disclosure;

FIG. 6 is a graph that illustrates an implementation of the executable graph-based model, in accordance with an embodiment of the present disclosure;

FIG. 7 is a schematic diagram that illustrates a tier-based architecture of the executable graph-based model, in accordance with an embodiment of the present disclosure;

FIG. 8 is a block diagram that illustrates a composition of a message node, in accordance with an embodiment of the present disclosure;

FIG. 9 is a graph that represents the composition of the message node of FIG. 8 in the executable graph-based model, in accordance with an embodiment of the present disclosure;

FIG. 10A is a block diagram that illustrates a compact view of a set of correlated message nodes of the executable graph-based model, in accordance with an embodiment of the present disclosure;

FIG. 10B is a time-sequence diagram that illustrates a sequence in which milestones associated with the set of correlated messages of FIG. 10A are achieved, in accordance with an embodiment of the present disclosure;

FIGS. 11A-11H are graphs that, collectively, illustrate an elaborated view of the set of correlated message nodes of FIG. 10A in the executable graph-based model, in accordance with an embodiment of the present disclosure;

FIG. 12 is a schematic diagram that illustrates an example implementation of time-series message management in an executable graph-based robotic arm model, in accordance with an embodiment of the present disclosure;

FIG. 13 shows an example computing system for carrying out the methods of the present disclosure, in accordance with an embodiment of the present disclosure; and

FIG. 14 is a flowchart that illustrates a method for facilitating time-series message management using the executable graph-based model, in accordance with an embodiment of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Digitization in various domains (for example, industrial processes, security systems, production pipelines, and so forth) has led systems associated with such domains to employ various intelligent and unintelligent modules. Such modules facilitate one or more tasks associated with the corresponding systems. To facilitate the tasks, these modules are required to communicate with each other. Communication among the modules takes place by way of messages. Such messages include information (for example, a source module, a destination module, an action, data, or the like) associated with the tasks that are to be performed by the modules. Thus, such messages provide information regarding various aspects associated with one or more modules that participate in communication thereof. This information may be analyzed to determine an analytics output that may be used for various purposes, for example, for improving the performance of the modules, for making changes in the corresponding system, or the like.

Traditionally, an analytics system, that works in tandem with the system that is to be analysed, receives messages that are being communicated among the modules via a communication network and stores the messages in a data warehouse. The stored messages are then analysed by the analytics system and based on the analysis, an analytics output is generated. However, dependency on availability of the communication network may lead to unwanted delays in case of network breakdown. In some cases, such delays may also lead to the analytics output being outdated, and hence, being redundant. Further, the analysis of messages is not performed in real time. Therefore, the analytics output is also not provided to the native system in real-time, thereby restricting availability thereof in time for time-critical tasks. Such analysis of messages is performed for optimization of communication among the modules. Hence, identification of time-consuming and latency-inducing operations associated with such communication becomes crucial. Therefore, delayed reception of time consumption and latency related analytics leads to further delays, sub-par performance, or many other bottlenecks during the communication. Moreover, the messages stored in the data warehouse are the only source of historical messages for the analytics system. In an instance, when the data warehouse is not accessible, the analytics system fails to perform any analytics that requires analysis of the historical messages. Further, in some instances, the analytics system may require to access information that is inherent to the system being analysed. Such information may not be communicated to the analytics system as it may not be part of any message being communicated. Hence, unavailability of such information may lead to generation of suboptimal analytics information by the analytics system. To summarize, the traditionally used analytics system for performing analytics of messages is inefficient and has several drawbacks that restrict timely generation of analytics output.

The present disclosure is directed to facilitation of real-time time-series based analytics of messages using executable graph-based models of an overlay system. The executable graph-based models are customized hypergraphs having hyper-edges that include one or more roles and vertices that are realized by way of executable nodes. Each executable node is a base node that is extended by way of one or more overlays. Each executable node is associated with a particular node type. For example, an edge node corresponds to a base node with an edge node type. Nodes (for example, base nodes and executable nodes) are connected with other nodes by way of roles included in an edge node therebetween. In some embodiments, roles are represented by way of nodes of role node type. Role node between two nodes may be indicative of details regarding an association therebetween.

A system for which messages are to be analyzed may be integral to the executable graph-based model or may communicate messages to processing circuitry (for example, a controller module, a message management module, or the like) associated with the executable graph-based model. For each message, the processing circuitry may instantiate a message node in the executable graph-based model, where the instantiated message node represents the message. The message node may be extended by way of one or more time-series analytics overlay nodes. The one or more time-series analytics overlay nodes may perform time-series analytics on the message represented by the message node based on a composition of the message node. A composition of each message node includes a dynamic dataset and a static dataset associated with the message. The dynamic dataset includes timestamps associated with one or more milestones (for example, a creation event, a raise event, a subscription event, a process event, or the like). The static dataset includes data and other transactional information (for example, a source identifier, a message type, or the like) associated with the message. The composition of each message node is stored in attribute vertex nodes associated therewith. The composition of each message node includes value shared attributes and non-value shared attributes. The vertex nodes that store value shared attributes are coupled with each message node that has corresponding value in composition thereof. Such representation of message nodes provides for a quick and easy search for messages that are to be analyzed. The time-series analytics overlay nodes execute corresponding set of time-series computation functions on the composition of the message node and generate one or more computation outputs based on the execution. Throughout the description the terms ‘composition of a message node’ and ‘composition of a message’ are used interchangeably. It will be apparent to a person skilled in the art that composition of a message node represents composition of a message represented thereby.

Subsequently, another overlay node (for example, a publisher overlay node) that is associated with one or more time-series analytics overlay nodes may generate and publish one or more statistical insights that include the computation outputs as well as other relevant information associated with the computation outputs that provide context to the statistical insights. Further, the processing circuitry, using an analytics module and a message management module of the overlay system, may generate an analytics outcome based on the statistical insights. The analytics outcome may be indicative of one or more recommendations based on the statistical insights, a current state of the overlay system, a cause of the current state of the overlay system, a foreseeable state of the overlay system, or the like.

Notably, the present disclosure allows for facilitation of analytics of messages at node level which allows a significant increase in the degree of parallelism with which messages are analyzed. Hence, the analysis of messages associated with the executable graph-based model and the generation of the analytics outcome based on such analysis requires significantly less time. In addition to messages, the present disclosure allows for in-situ analytics to be performed further based on non-message data associated with the system. That is to say that, the present disclosure enables analytics to be performed based on messages as well as non-message data such as operational data, user preferences, and business rules. Therefore, the analytics outcome is generated based on not only messages but also other information associated with the system. Hence, such analytics outcome is optimal as it is generated while considering an overall performance and state of the system. Further, such analytics is performed in real-time and within the system (i.e., without being shared with any external system). Since the present disclosure does not require sharing of messages or any other information with any external entity, security and confidentiality of information associated with the system remains uncompromised.

The traditional analytics system involves communication with an external analytics system, whereas, the present disclosure allows for performing analytics while eliminating a requirement of communicating with another system. Further, the traditional analytics system requires the messages to be stored at the data warehouse, whereas, the present disclosure does not require the message to be stored at any external data storage. Moreover, the traditional analytics system does not provide the analytics outcome in real-time, whereas, the present disclosure allows for generation of the analytics outcome in real-time or near real-time. Further, the traditional analytics system requires sharing of the messages with an external system, whereas, the present disclosure does not require for sharing of data outside the system.

Thus, the systems and methods disclosed herein provide a solution for performing time-series message management. Such message management is performed by executing time-series computation functions at a single message level. The systems and methods disclosed herein allow for instantiation of a message node for each message associated therewith. Further, each message node is associated with one or more analytics overlay nodes that may perform corresponding analytics on the composition of the corresponding message node. The association of time-series analytics overlay nodes with the message nodes allows for time-series computation functions to be performed without any significant wait-time. Hence, the disclosed methods and systems allow for analytics of messages to be performed in such a way that it allows for generation of real-time analytics outcome which may be used for improving operational performance of modules that are associated with the messages being analyzed. Such generation of analytics outcome is crucial for time critical operations associated with various domains such as robotics, home security, autonomous vehicles, and so on where delay in communication may lead to undesirable results.

### Figure Description

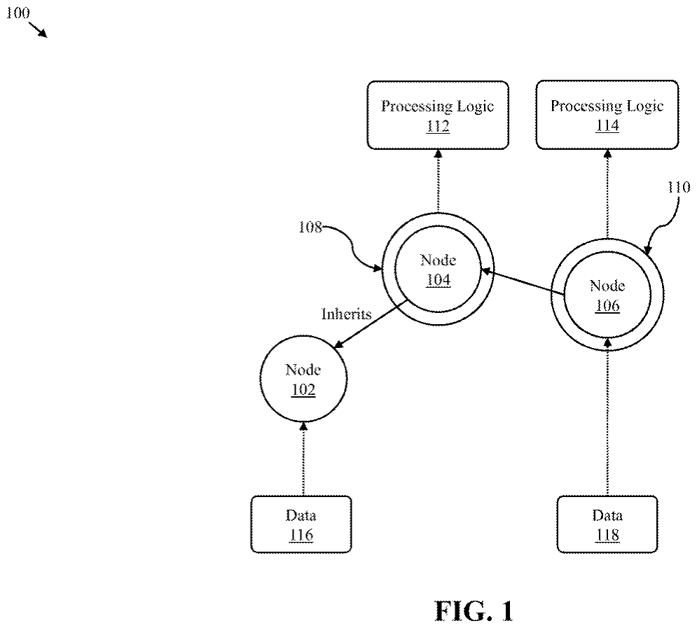

FIG. 1 is a graph that illustrates a composition of an executable graph-based model 100, in accordance with an embodiment of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlays 108 and 110, respectively. Although not shown, it will be apparent to a person skilled in the art that the node 102 can be similarly extended with processing logic via the use of one or more overlays. Each overlay includes processing logic, such as processing logic 112 and 114 which are associated with the overlays 108 and 110, respectively. At run-time, data, such as data 116 and 118, is associated with the nodes 102 and 106, respectively. Further, the overlays 108 and 110 of the nodes 104 and 106, respectively, provide the functionality to respond to stimuli and interact with, manipulate, or otherwise process the data for analytics based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

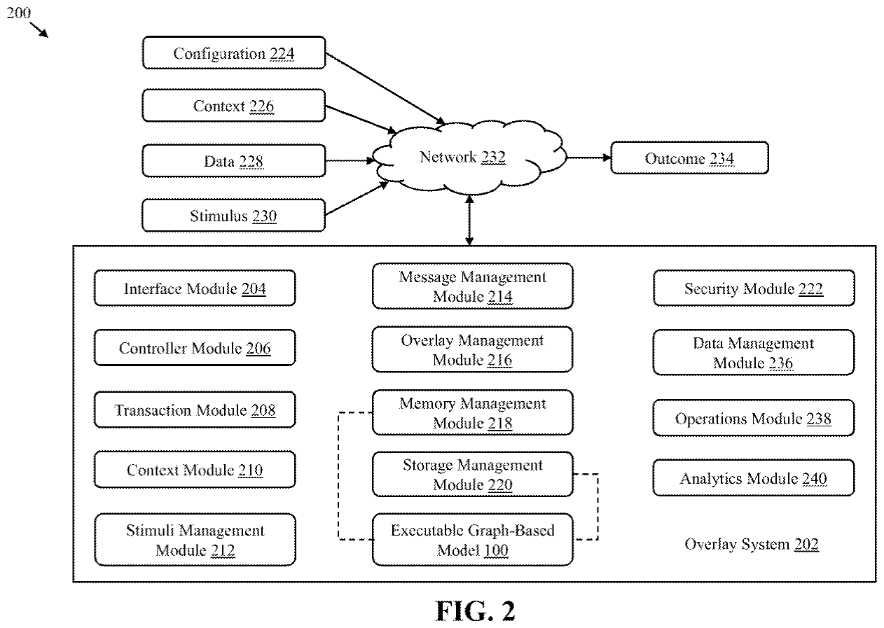

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2).

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 is applicable to a range of time-critical systems where efficient processing of the stimuli is required.

FIG. 2 is a block diagram that illustrates a system environment 200 of an overlay system 202 for execution, management, and configuration of executable graph-based models, in accordance with an embodiment of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a message management module 214, an overlay management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes a data management module 236, an operations module 238, and an analytics module 240. In some embodiments, all the modules of the overlay system 202 except for the executable graph-based model 100 may collectively form processing circuitry that performs time-series message management (for example, message analytics, message management, or the like) within the overlay system 202.

The overlay system 202 may include suitable logic, circuitry, interfaces, and/or code, executable by the circuitry, that may be configured to facilitate time-series message management in the executable graph-based models (such as, the executable graph-based model 100). Time-series message management in the overlay system 202 corresponds to performing time-series/timestamp-based analytics on message and non-message data associated with the overlay system 202 to generate one or more statistical insights regarding operational performance of the overlay system 202. The statistical insights may be used to improve the operational performance of the overlay system 202. The term ‘operational performance’ refers to the ability of the overlay system 202 to fulfill one or more tasks assigned thereto with minimal delay. In other words, the term ‘operational performance’ refers to an operational ability of the overlay system 202 to execute one or more tasks (for example, message creation, message subscription, message handling, message processing, message publishing, or the like) with negligible to no wait-time. The tasks may be associated with a business solution associated with the overlay system 202. The business solution associated with the overlay system 202 may refer to an application (for example, a business application, a robotic system, an autonomous vehicle system, an inventory system, a task assignment/allocation system, or the like) that may be implemented by way of the overlay system 202.

The overlay system 202 includes the executable graph-based model 100 that corresponds to an application-specific combination of data and processing functionality which is manipulated, processed, and/or otherwise handled by the other modules within the overlay system 202 for performing analytics of messages based on the stimulus 230 received by the overlay system 202.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as user name, password, access token, device information, time stamp, one or more relevant identifiers (IDs), or the like, that are required for processing of messages within the executable graph-based model 100. Each context within the overlay system 202 may be extended to include additional information that is required for the processing of the message (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of one or more messages associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of messages associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on the execution of a message by any of its nodes. In some examples, the processing of a stimulus (such as, the stimulus 230) results in the generation, communication, or processing of one or more messages that further result in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 and/or the analytics module 240 of the overlay system 202.

The message management module 214 may include suitable logic, circuitry, interfaces, and/or code, executable by the circuitry, configured to manage all data or information associated with messages communicated within the overlay system 202 (e.g., the data 228) for a given communication network implemented by way of the executable graph-based model 100. Operations performed by the message management module 214 include data loading, data unloading, data modeling, and data processing operations associated with the generation and communication of messages within the overlay system 202. The message management module 214 is communicatively coupled (e.g., connected either directly or indirectly) to one or more other modules within the overlay system 202 to complete some or all of these operations. For example, the storage of data or information associated with messages is handled in conjunction with the storage management module 220 (as described in more detail below).

The overlay management module 216 may include suitable logic, circuitry, interfaces, and/or code, executable by the circuitry, configured to manage all overlays within the overlay system 202. Operations performed by the overlay management module 216 include overlay storage management, overlay structure modeling, overlay logic creation and execution, and overlay loading and unloading (within the executable graph-based model 100). The overlay management module 216 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more of the modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with messages being communicated within the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100.

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device. In the present disclosure, the executable graph-based model 100 may be stored in a storage element. The storage element corresponds to a combination of the memory management module 218 and storage management module 220 that may be configured to store the executable graph-based model 100. In some embodiments, the storage element may be a storage module that is managed by the memory management module 218 and storage management module 220, collectively.

The security module 222 may include suitable logic, circuitry, interfaces, and/or code, executable by the circuitry, configured to manage the security of the overlay system 202. This includes the security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the message received or processed by the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the message management module 214 and the overlay management module 216 for managing and executing security-based overlays.

The data management module 236 may include suitable logic, circuitry, interfaces, and/or code, executable by the circuitry, configured to manage all data or information within the overlay system 202 (e.g., the data 228) for a given application. Operations performed by the data management module 236 include data loading, data unloading, data modeling, and data processing. The data management module 236 is communicatively coupled (e.g., connected either directly or indirectly) to one or more other modules within the overlay system 202 to complete some or all of these operations. For example, data storage is handled by the data management module 236 in conjunction with the storage management module 220.

The operations module 238 may include suitable logic, circuitry, interfaces, and/or code, executable by the circuitry, configured to track operational metrics and the behavior of all modules of the overlay system 202. Operational metrics of a module is indicative of statistics associated with performance of the module while performing an operation (for example, communication, data processing, stimulus processing, or the like). The performance of the module may be improved by taking one or more measures to improve operational metrics associated therewith. Such measures may be taken based on the one or more analytic insights that are indicative of the performance of the module.

The analytics module 240 may include suitable logic, circuitry, interfaces, and/or code, executable by the circuitry, configured to perform time-series analytics of messages associated with the overlay system 202. The analytics module 240 may perform such analytics by way of one or more time-series analytics overlay nodes. The analytics module 240 may perform descriptive analytics (e.g., ‘What happened?’), diagnostic analytics (e.g., ‘Why did it happen?’), predictive analytics (e.g., ‘What is likely to happen?’), prescriptive analytics (e.g., ‘What should be done?’), a combination of these, or any other type of analytics of messages associated with the overlay system 202. Such analytics may be performed based on compositions (for example, the dynamic dataset including timestamps, and the static dataset including communicated data, attributes, or the like) of one or more messages associated with the overlay system 202.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or programming languages.

It will be apparent to a person skilled in the art that whilst only one executable graph-based model 100 is shown in FIG. 2, in other embodiments the overlay system 202 stores and maintains more than one executable graph-based model, without deviating from the scope of the present disclosure. In such embodiments, communication in each executable graph-based model is executed in a manner that is similar to the executable graph-based model 100.

Having described the overlay system 202 for executing and managing executable graph-based models, the description will now turn to the elements of an executable graph-based model; specifically, the concept of a node. Unlike conventional graph-based systems, all elements (e.g., data, overlays, etc.) within the executable graph-based model (e.g., the executable graph-based model 100) are implemented as nodes. As will become clear, this allows executable graph-based models to be flexible, extensible, and highly configurable.

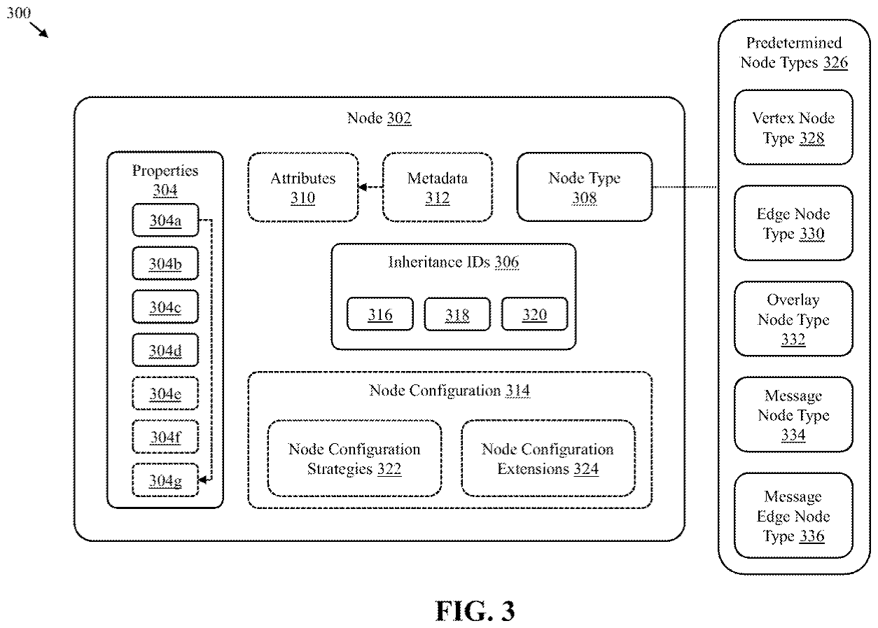

FIG. 3 is a block diagram 300 that illustrates a generic structure of a node 302 within the executable graph-based model 100 of FIG. 1, in accordance with an embodiment of the present disclosure. Referring to FIG. 3, the node 302 corresponds to the core structure of the executable graph-based model 100 and forms the foundational building block for all data and processing logic within the executable graph-based model 100. The node 302 includes properties 304, inheritance IDs 306, and a node type 308. The node 302 optionally includes one or more attributes 310, metadata 312 associated with the attributes 310, and a node configuration 314.

The properties 304 of the node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the node 302 include an abstract flag 316, a leaf flag 318, and a root flag 320. The node configuration 314 optionally includes one or more node configuration strategies 322 and one or more node configuration extensions 324. FIG. 3 further shows a plurality of predetermined node types 326 which include a vertex node type 328, an edge node type 330, an overlay node type 332, a message node type 334, and a message edge node type 336.

The unique ID 304a is unique for each node within the executable graph-based model 100. The unique ID 304a is used to register, manage, and reference the node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the node 302 is incremented when the node 302 undergoes transactional change. This allows the historical changes between versions of the node 302 to be tracked by modules or overlays within the overlay system 202. The namespace 304c of the node 302, along with the name 304d of the node 302, is used to help organize nodes within the executable graph-based model 100. That is, the node 302 is assigned a unique name 304d within the namespace 304c such that the name 304d of the node 302 need not be unique within the entire executable graph-based model 100, only within the context of the namespace 304c to which the node 302 is assigned. The node 302 optionally includes one or more icons 304e which are used to provide a visual representation of the node 302 when visualized via a user interface. The one or more icons 304e can include icons at different resolutions and display contexts such that the visualization of the node 302 is adapted to different display settings and contexts. The node 302 also optionally includes one or more labels 304f which are used to override the name 304d when the node 302 is rendered or visualized.

The node 302 supports the concept of inheritance of data and processing logic associated with any other node of the executable graph-based model 100 that is inherited by the node 302. This allows the behavior and functionality of the node 302 to be extended or derived from the inherited node of the executable graph-based model 100. The inheritance IDs 306 of the node 302 indicate the inheritance-based information, which may be applicable to the node 302. The inheritance IDs 306 comprise a set of Boolean flags which identify the inheritance structure of the node 302. The abstract flag 316 allows the node 302 to support the construct of abstraction. When the abstract flag 316 takes a value ‘true’, the node 302 is flagged as abstract that is to say that it cannot be instantiated or created within an executable graph-based model (e.g., the executable graph-based model 100). Thus, in an instance when the node 302 has the abstract flag 316 set to ‘true’, the node 302 may only form the foundation of other nodes that inherit therefrom. By default, the abstract flag 316 of the node 302 is set to ‘false’. The leaf flag 318 is used to indicate whether any other node may inherit from the node 302. If the leaf flag 318 is set to ‘true’, then no other node may inherit from the node 302 (but unlike an abstract node, a node with the leaf flag 318 set may be instantiated and created within the executable graph-based model 100). The root flag 320 is used to indicate whether the node 302 inherits from any other node. If the root flag 320 is set to ‘true’, the node 302 does not inherit from any other node. The node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node type. The node type 308 of the node 302 is used to extend the functionality of the node 302. All nodes within the executable graph-based model 100 comprise a node type that defines additional data structures and implements additional executable functionality. A node type thus includes data structures and functionality that are common across all nodes that share that node type. The composition of a node with a node type therefore improves extensibility by allowing the generation of specialized node functionalities for specific application areas. Such extensibility is not present in prior art graph-based models. As illustrated in FIG. 3, the node 302 and the node type 308 are one logical unit that is not separated in the context of an executing system at run-time (e.g., in the context of execution of an executable graph-based model).

FIG. 3 further shows the plurality of predetermined node types 326 which provides a non-exhaustive list of node types that may be associated with a node, such as the node 302. The vertex node type 328 (also referred to as a data node type or a value node type) includes common data structures and functionality related to the ‘things’ modeled in the graph (e.g., the data). The edge node type 330 includes common data structures and functionality related to joining two or more nodes. A node having the edge node type 330 may connect two or more nodes and thus the edge node type 330 constructs associations and connections between nodes (for example, objects or ‘things’) within the executable graph-based model 100. The edge node type 330 is not restricted to the number of nodes that can be associated or connected by a node having the edge node type 330. The data structures and functionality of the edge node type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node types 326 further includes the overlay node type 332, the message node type 334, and the message edge node type 336. As will be described in more detail below, a node with the overlay node type 332 is used to extend the functionality of a node, such as the node 302, to incorporate processing logic. Unlike non-overlay nodes, an overlay node includes processing logic which determines the functionality of the overlay node. The processing logic of an overlay node includes a block of executable code, or instructions, which carries out one or more operations associated with the communication of messages within the executable graph-based model 100. The block of executable code is pre-compiled code, code that requires interpretation at run-time, or a combination of both. Different overlay nodes provide different processing logic to realize different functionality. For example, a handler overlay node includes processing logic to receive a message and execute an operation associated with the received message, whilst a publishing overlay node includes processing logic to generate and publish a message based on the stimulus 230 received by the overlay system 202.

The overlay system 202 may have a plurality of messages associated therewith. A node with the message node type 334 represents a message of the plurality of messages associated with the overlay system 202. The processing circuitry may be configured to generate the executable graph-based model 100 based on the plurality of messages. Specifically, the processing circuitry may instantiate a message node for each message associated with the overlay system 202 to create the executable graph-based model 100. Each node with the message node type 334 is associated with one or more nodes with the vertex node type 328 that store a composition thereof. The composition of a message node refers to data and transactional information (for example, a message identifier, a source identifier, a message type, or the like) associated with the message that is represented by the corresponding message node. A message node may be one of a command node, a query node, and an event node. The command node, the query node, and the event node may represent a command message, a query message, and an event message, respectively. The event message may be instantiated as an event header node or a handled event node. The event header node may represent an event message that may be a source message of one or more handled event messages. The one or more handled event messages may be a clone of the event message represented by the event header node.

A node with the message edge node type 336 couples two message nodes by way of corresponding message roles. A message edge node establishes a causal association between two or more message nodes. A causal association between two message nodes is indicative of generation of one message node due to processing of another message node. That is to say, the message edge node that couples two or more message nodes establishes a correlation therebetween. Further, the message edge node includes one or more roles for each message node associated therewith. A message role associated with a message node may be one of ‘command’, ‘query’, and ‘event’. For example, a command node may be coupled to an event node via a message edge node, where a role associated with the command node is ‘command’ and a role associated with the event node is ‘event’.

In an instance, a message edge node may couple a command node with an event header node. In such an instance, the message edge node may be a command to event header edge. In an instance, a message edge node may couple an event header node with a handled event node. In such an instance, the message edge node may be an event header to handled event edge. In an instance, a message edge node may couple a query node with an event node. In such an instance, the message edge node may be a query to event edge. In an instance, a message edge node may couple a command node with an event node. In such an instance, the message edge node may be a command to event edge. Any combination of message-to-message edge is possible depending upon coupling of message types facilitated by the message edge node.

The one or more attributes 310 correspond to the data associated with the node 302 (e.g., the data represented by the node 302 within the executable graph-based model 100 as handled by the data management module 236). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, and a complex attribute behavior. The attribute behavior of each attribute defines the behavior of the corresponding attribute. The attribute behaviors of each attribute may be configured by associated attribute configurations. The attribute configurations are examples of attribute configuration extensions which are node configuration extensions (e.g., they are part of the one or more node configuration extensions 324 of the node 302 shown in FIG. 3). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with reference attribute behavior includes appropriate information to obtain a reference data set of possible values. The derived attribute behavior is a behavior that allows read only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the node 302 further includes the metadata 312 (e.g., data stored as a name, count of processed messages, time when last message was processed, an average processing time required for processing a message, or the like) which is associated with either the node 302 or an attribute (for example, the one or more attributes 310) of the node 302. An attribute within the one or more attributes 310 may either have an independent state or a shared state. That is to say that, an attribute may be a value shared attribute or a non-value shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, then updating the data (e.g., the value) of this shared attribute will be reflected across both nodes.

The node configuration 314 provides a high degree of configurations for the different elements of the node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the node 302, which creates message source IDs. A further example of a concrete node configuration strategy is a versioning strategy, associated with the configuration of the version ID 304b of the node 302, which supports major and minor versioning (depending on the type of transactional change incurred by the node 302). The versioning strategy may be adapted to a native filing system of a user device hosting the overlay system 202 or a third-party data storage (for example, Snowflake®, or the like) associated with the overlay system 202.

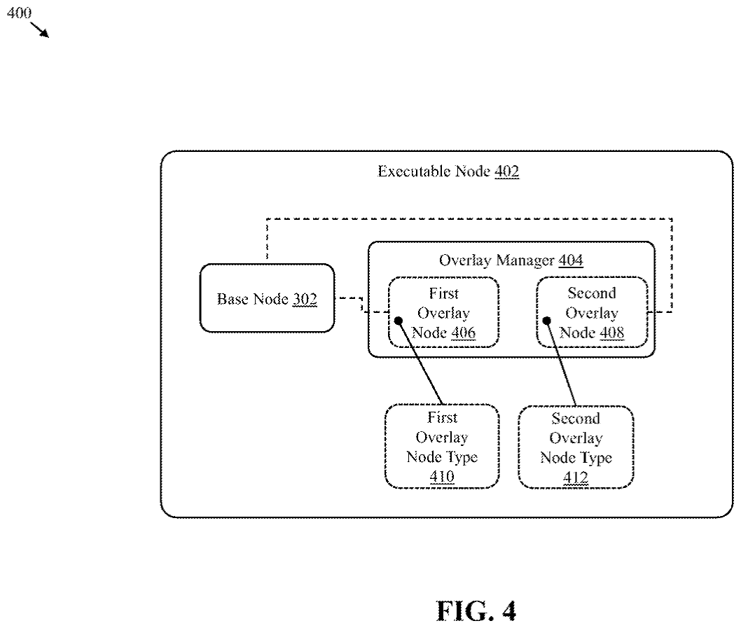

FIG. 4 is a block diagram 400 that illustrates an executable node 402 within the executable graph-based model 100, in accordance with an embodiment of the present disclosure. Referring to FIG. 4, the executable node 402 is shown to include a base node, e.g., the node 302 (hereinafter referred to as the “base node 302”) and an overlay manager 404. The overlay manager 404 includes a first overlay node 406 and a second overlay node 408. The executable node 402 provides processing functionality (e.g., processing logic) to the base node 302 via one or more associated overlay nodes (for example, the first and second overlay nodes 406 and 408). Beneficially, the data and processing capability of the base node 302 may be dynamically and significantly extended using the concept of an executable node (for example, the executable node 402).

As shown, the first overlay node 406 has a first overlay node type 410 and the second overlay node 408 has a second overlay node type 412. Examples of overlay node type include, but are not limited to, a handler overlay node, a publisher overlay node, a time-series analytics overlay node, or the like.

A handler overlay node is a node that includes processing logic for subscribing to one or more messages mapped to the corresponding executable node, and processing the subscribed messages in conjunction with the corresponding base node. The handler overlay node, being a node, adheres to the generic structure of a node described in conjunction with FIG. 3. The term ‘subscribe’ refers to an operation that is executed by a handler overlay node for receiving a message from another executable node or the message management module 214 of the overlay system 202.

A publisher overlay node is a node that includes processing logic for the generation and publication of one or more messages to be communicated by the corresponding executable node. The publisher overlay node may be an extension of a base node or an overlay node (e.g., a handler overlay node). The publisher overlay node, being a node, adheres to the generic structure of a node described in conjunction with FIG. 3. In an instance, when the publisher overlay node is an extension of a base node, the publisher overlay node may generate and publish messages that are to be communicated by the corresponding base node. In another instance, when the publisher overlay node is an extension of another overlay node (e.g., a time-series analytics overlay node), it may generate and publish analytics outcomes (e.g., the outcome 234) based on execution of a set of time-series computation functions by a time-series analytics overlay node.

A time-series analytics overlay node is a node that includes processing logic for time-series analysis of messages being communicated within the overlay system 202. Specifically, the time-series analytics overlay node includes a set of time-series computation functions that includes mathematical computations. Such mathematical computations include parameters. Parameter values for such parameters are specific to each message node. The parameter value for each parameter may be derived based on a dynamic dataset of a message node that represents a message being analyzed. The time-series analytics overlay node preforms such analytics based on timestamps for various milestones (for example, creation, raised, reception, handling, processing, or the like) associated with the message being analyzed. The time-series analytics overlay node may be associated with one or more message nodes that are instantiated in the executable graph-based model 100 to represent messages associated with the overlay system 202. The time-series analytics overlay node, being a node, adheres to the generic structure of a node described in conjunction with FIG. 3.

The time-series analytics overlay node may be one of a descriptive time-series analytics overlay node, a diagnostic time-series analytics overlay node, a predictive time-series analytics overlay node, and a prescriptive time-series analytics overlay node. Each of the first and second overlay nodes types 410 and 412 may correspond to a descriptive time-series analytics overlay node type, a diagnostic time-series analytics overlay node type, a predictive time-series analytics overlay node type, a prescriptive time-series analytics overlay node type, a combination of these, or any other type of time-series analytics overlay node type.

The descriptive time-series analytics overlay node includes a set of time-series computation functions that when executed is configured to process the composition of a message node associated therewith to determine a set of computation outputs associated with communication of a message represented by an associated message node. The diagnostic time-series analytics overlay node includes a set of time-series computation functions that when executed is configured to process the composition of an associated message node to determine a set of computation outputs that is indicative of one or more patterns describing a current performance of the overlay system 202. The predictive time-series analytics overlay node includes processing logic that when executed is configured to process the composition (transaction information and data) of an associated message node to determine one or more predictions regarding the performance of the overlay system 202 during a predefined time interval. The prescriptive time-series analytics overlay node includes processing logic that when executed is configured to analyze the composition of an associated message node to generate one or more recommendations to achieve a desired performance of the overlay system 202. Notably, each time-series analytics overlay node has a set of associated message nodes, where the time-series analytics overlay node is configured to execute a set of time-series computation functions on the set of associated message nodes. The term ‘associated message nodes’ refer to one or more message nodes that are associated with a corresponding time-series analytics overlay node.

Although, the executable node 402 is shown to include the first and second overlay nodes 406 and 408, in other embodiments, the executable node 402 may include any number of overlay nodes, without deviating from the scope of the present disclosure.

The executable node 402 extends the base node 302 (or is a subtype of the base node 302) such that all the functionality and properties of the base node 302 are accessible to the executable node 402. The executable node 402 also dynamically extends the functionality of the base node 302 by associating the overlay nodes maintained by the overlay manager 404 with the base node 302. The executable node 402 may thus be considered a combination of the base node 302 and the first and second overlay nodes 406 and 408. The executable node 402 may be alternatively referred to as a node with overlay(s). Therefore, the executable node 402 acts as a decorator of the base node 302 adding the functionality of the overlay manager 404 to the base node 302.

It will be apparent to a person skilled in the art that the base node 302 refers to any suitable node within the executable graph-based model 100. As such, the base node 302 may be a node having a type such as a vertex node type, an edge node type, a message node type, a message edge node type, or the like. Alternatively, the base node 302 may itself be an executable node such that the functionality of the (executable) base node 302 is dynamically extended. In this way, complex and powerful processing functionality can be dynamically generated by associating and extending overlay nodes.

The overlay manager 404 registers and maintains one or more overlay nodes (such as the first overlay node 406 and the second overlay node 408) associated with the base node 302. The assignment of the first and second overlay nodes 406 and 408 to the base node 302 (via the overlay manager 404) endows the base node 302 with processing logic and executable functionality defined within the first and second overlay nodes 406 and 408.

Extending the functionality of a base node through one or more overlay nodes is at the heart of the overlay system 202. As illustrated in FIG. 2, the data (e.g., a vertex node as represented by the base node 302 in FIG. 4) and the functionality that acts upon that data (e.g., an overlay node) can be separated and independently maintained offline, but at run-time, an association between the data node and the overlay node is determined and an executable node is generated (e.g., the executable node 402 shown in FIG. 4).

It will be apparent to a person skilled in the art that functionalities of the first and second overlay nodes 406 and 408 may be performed by a single overlay node that includes processing logic for performing descriptive analytics, diagnostic analytics, prescriptive analytics, predictive analytics, or any other operation associated with message management using the executable graph-based model 100.

It will be apparent to a person skilled in the art that the list of overlay types is not exhaustive and the number of different overlay types that can be realized is not limited. Because an overlay node is itself a node, all functionality of a node described in relation to the base node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node type of the node to which the overlay node is applied.

An overlay node, such as the first overlay node 406 or the second overlay node 408, is not bound to a single executable node or a single executable graph-based model (unlike nodes that have non-overlay node types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 404 of the executable node 402 is responsible for executing all overlays registered therewith. The overlay manager 404 also coordinates the execution of all associated overlay nodes. As shown in FIG. 4, the executable node 402 associates the base node 302 with two overlay nodes that is the first overlay node 406 and the second overlay node 408. Thus, the overlay manager 404 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 404 and are associated with an overlay via a node configuration extension for the overlay.

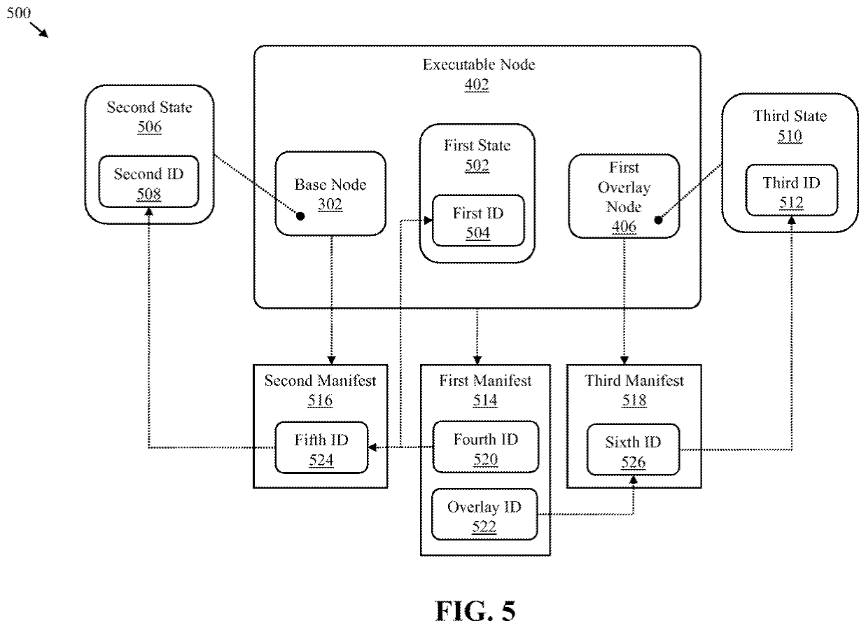

The data and the processing logic associated with one or more overlays of an executable node (for example, the executable node 402) are persistent. The persistent nature of the data and the processing logic are described in detail in conjunction with FIG. 5.

FIG. 5 is a block diagram 500 that illustrates a composition of the executable node 402 that enables persistent storage of data and the processing logic associated therewith, in accordance with an embodiment of the present disclosure.

As described in conjunction with FIG. 4, the executable node 402 includes the base node 302 and one or more overlay nodes (e.g., the first and second overlay nodes 406 and 408). For the brevity of ongoing description, the persistent storage is explained for the executable node 402 including only the first overlay node 406. One or more operations performed for ensuring the persistence of the first overlay node 406 may be performed for the second overlay node 408 as well.

Referring to FIG. 5, the executable node 402 includes the base node 302 and the first overlay node 406. The executable node 402 has a corresponding first state 502 having a first ID 504. The base node 302 has a second state 506 having a second ID 508, and the first overlay node 406 has a third state 510 having a third ID 512. A manifest (for example, first through third manifests 514-518) is generated for each of the base node 302, the executable node 402, and the first overlay node 406. In an embodiment, the manifests may be generated by the storage management module 220. The first manifest 514 is associated with the executable node 402 and has a fourth ID 520 and an overlay ID 522. The second manifest 516 is associated with the base node 302 and has a fifth ID 524. The third manifest 518 is associated with the first overlay node 406 and has a sixth ID 526. Further, the manifests are stored at respective storage locations that may be centralized or distributed storage locations associated with the overlay system 202. The manifests may be stored by the storage management module 220.

The first state 502 of the executable node 402 includes data required to reconstruct the executable node 402 (e.g., attributes, properties, etc.). The first state 502 of the executable node 402 is persistently stored along with the first ID 504. The first manifest 514 is generated for the executable node 402 and has (i) the fourth ID 520 (which is the same as the first ID 504), (ii) the storage location of the first state 502 of the executable node 402, and (iii) the overlay ID 522 (which is the same as the sixth ID 526). Notably, the fourth ID 520 is the same as the first ID 504 and the fifth ID 524, hence, the first manifest 514 includes the ID of the state of the base node 302 and the executable node 402. Further, the overlay ID 522 is the same as the sixth ID 526 of the state of the first overlay node 406. Therefore, the first manifest 514 may be used to identify and retrieve the states of the base node 302, the executable node 402, and the first overlay node 406. Subsequently, the retrieved states may be used to reconstruct the executable node 402 and the first overlay node 406. In an instance, the executable node 402 may be further extended to include additional overlay nodes. In such an instance, the first manifest 514 may include state IDs of the additional overlay nodes as well. A first manifest state (not shown) is then generated for the first manifest 514 and persistently stored along with the fourth ID 520.

The second state 506 of the base node 302 includes data required to reconstruct the base node 302 (e.g., attributes, properties, etc.) and is persistently stored along with the second ID 508. The second manifest 516 is generated for the base node 302 and has (i) the fifth ID 524 and (ii) the storage location of the second state 506 of the base node 302. The second ID 508 of the second state 506 and the fifth ID 524 of the second manifest 516 are the same as the first ID 504 of the first state 502 of the executable node 402 (which is also the same as the fourth ID 520 of the first manifest 514 of the executable node 402). As mentioned above, along with the first state 502, the first manifest 514 may also be used to identify and retrieve the second manifest 516 which in turn may be used to identify the second state 506 of the base node 302. A second manifest state (not shown) is then generated for the second manifest 516 and persistently stored along with the fifth ID 524. Thus, the states, manifests, and manifest states for the executable node 402 and the base node 302 include the same, shared, ID. A shared ID can be used in this instance because the states, manifests, and manifest states are stored separately. The separate storage of the states, manifests, and manifest states exhibits a distributed architecture of the overlay system 202.

The third state 510 of the first overlay node 406 includes data required to reconstruct the first overlay node 406 (e.g., attributes, properties, processing logic, etc.) and is persistently stored along with the third ID 512. The third manifest 518 is generated for the first overlay node 406 and includes the sixth ID 526, which is the same as the third ID 512. Therefore, the first manifest 514 may be further used to identify and retrieve the third manifest 518 which in turn may be used to identify and retrieve the third state 510 of the first overlay node 406. A third manifest state (not shown) is then generated for the third manifest 518 and is persistently stored along with the sixth ID 526.

In operation, when the executable node 402 is to be loaded, the transaction module 208, in conjunction with the storage management module 220, may execute one or more operations to retrieve the first manifest state stored at a known storage location. Based on the first manifest state, the storage management module 220 may re-construct the first manifest 514 which includes the fourth ID 520 which is the same as the fifth ID 524 of the second manifest 516. Based on the fifth ID 524, the storage management module 220 may identify the second manifest state and may generate the second manifest 516 based on which the second state 506 is identified. Subsequently, the base node 302 is loaded and the storage management module 220 may determine that the base node is a node with overlay. Based on the fourth ID 520 (that is the same as the first ID 504 of the first state 502 of the executable node 402) of the first manifest 514, the first state 502 is identified and retrieved. Subsequently, the executable node 402 is loaded. Moreover, based on the overlay ID 522 (that is the same as the sixth ID 526 of the third manifest 518) of the first manifest 514, the third manifest state is identified and the third manifest 518 is generated. Subsequently, based on the sixth ID 526 (that is the same as the third ID of the third state) of the third manifest 518, the third state 510 is identified and retrieved. Based on the third state 510, the first overlay node 406 is reconstructed and loaded in the executable graph-based model 100.

In some embodiments, the first overlay node 406 may not be loaded in case it is not required for executing the operation associated with the stimulus 230. The loaded executable node 402 and the first overlay node 406 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node may be transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, all manifest states are stored together at a storage location that is known to the storage management module 220. Such centralized storage of the manifest states ensures that node states associated therewith are easily accessible.

It will be apparent to a person skilled in the art that although FIG. 5 illustrates only a single overlay node, in other embodiments, the executable node may include additional or different overlay nodes (for example, the second overlay node 408). It will also be apparent to a person skilled in the art that only those overlay nodes that are required for responding to the stimulus 230 may be loaded.

The overlay system 202 described above may be used to implement systems and methods for performing time-series management of messages by performing analytics thereof using the executable graph-based models (for example, the executable graph-based model 100). In an example, the executable graph-based model 100 may be implemented for a business solution (for example, a task assignment system, a production pipeline, or the like). In such implementations, the executable graph-based model 100 may include a node for each module of the business solution. The executable graph-based model 100 may be used for facilitating communication among modules of the business solution. In such an example, messages being communicated among the modules may be analyzed to determine one or more statistical insights associated with performance of the business solution. Such statistical insights may be used for optimizing performance of the overlay system 202.

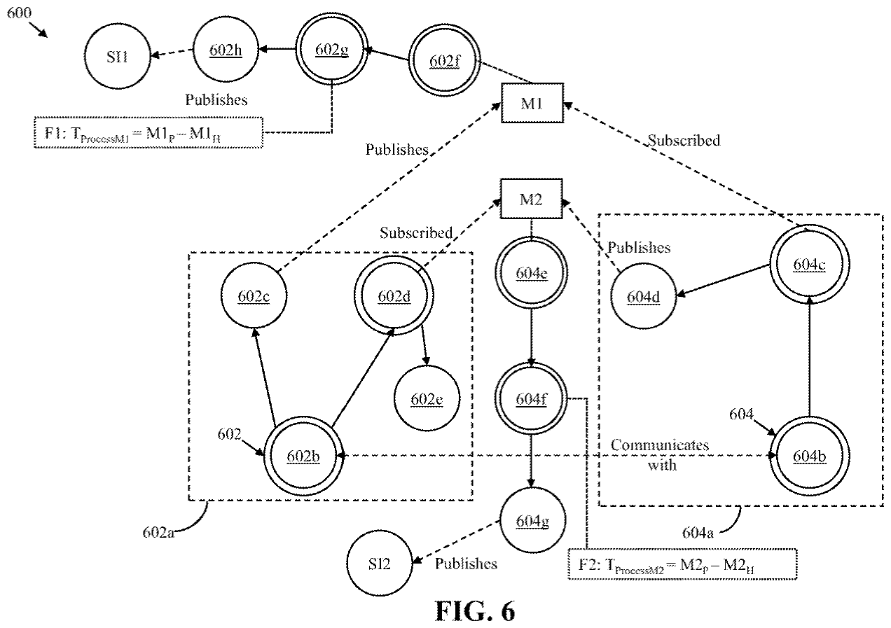

FIG. 6 is a graph 600 that illustrates an implementation of the executable graph-based model 100, in accordance with an embodiment of the present disclosure. Referring to FIG. 6, the executable graph-based model 100 is shown to include a plurality of executable nodes (e.g., a first executable node 602 and a second executable node 604). Each executable node includes a base node and a set of overlay nodes (for example, time-series analytics overlay nodes, handler overlay nodes and/or publisher overlay nodes). In an embodiment, the base node of each executable node corresponds to a message node, a message edge node, a hyper-edge node, or a vertex node. However, in other embodiments, the base node may correspond to any other node type, without deviating from the scope of the present disclosure.

As shown in FIG. 6, the first executable node 602 logically includes the base node and overlay nodes shown within a dotted box 602a. That is to say that, the first executable node 602 logically includes a base node 602b, a publisher overlay node 602c, a handler overlay node 602d, and another publisher overlay node 602e. The publisher overlay node 602c and the handler overlay node 602d correspond to overlays of the base node 602b, whereas the publisher overlay node 602e is an overlay of the handler overlay node 602d. Similarly, the second executable node 604 logically includes a base node and overlay nodes shown within another dotted box 604a. The second executable node 604 logically includes a base node 604b and a handler overlay node 604c that is extended by a publisher overlay node 604d. The handler overlay node 604c corresponds to an overlay of the base node 604b, whereas, the publisher overlay node 604d corresponds to an overlay of the handler overlay node 604c. The base nodes 602b and 604b are communicatively coupled and communicate with each other by way of corresponding overlay nodes.

As shown in FIG. 6, the first and second executable nodes 602 and 604 are represented in the executable graph-based model 100 by way of two concentric circles, with the inner circles representing the base nodes 602b and 604b, and outer circles indicating the presence of overlays for extending the functionalities of the base nodes 602b and 604b. In such a scenario, the association between the base nodes 602b and 604b is represented by an arrow linking the two inner circles. Similarly, some overlay nodes (e.g., the publisher overlay node 602c) are represented in the executable graph-based model 100 by way of single circles as they are not extended using overlays. In such a scenario, the association of the first executable node 602 with the publisher overlay node 602c is represented by an arrow linking the outer circle of the first executable node 602 to the publisher overlay node 602c. On the other hand, the handler overlay nodes 604c and 602d are represented in the executable graph-based model 100 by way of two concentric circles, with the inner circle representing the corresponding overlay node and the outer circle indicating the presence of overlays. In such a scenario, the association between the second executable node 604 and the handler overlay node 604c is represented by an arrow linking the outer circle of the second executable node 604 to the inner circle of the handler overlay node 604c. Further, the publisher overlay node 604d is represented in the executable graph-based model 100 by way of a single circle, and the association between the handler overlay node 604c and the publisher overlay node 604d is represented by an arrow linking the outer circle of the handler overlay node 604c to the publisher overlay node 604d. Similarly, the association between the first executable node 602 and the handler overlay node 602d is represented by an arrow linking the outer circle of the first executable node 602 to the inner circle of the handler overlay node 602d. Further, the publisher overlay node 602e is represented in the executable graph-based model 100 by way of a single circle, and the association between the handler overlay node 602d and the publisher overlay node 602e is represented by an arrow linking the outer circle of the handler overlay node 602d to the publisher overlay node 602e.

The controller module 206 may receive a first contextualized stimulus. The first contextualized stimulus may include a first stimulus and a context associated therewith. The first stimulus may correspond to a command-type message, a query-type message, or an event-type message. The context module 210 may process the context and generate an operation execution context. The operation execution context indicates that processing of the first stimulus requires communication between the first and second executable nodes 602 and 604.

Based on the first stimulus, the first executable node 602 communicates a first message M1 (represented by a rectangular box in FIG. 6) to the second executable node 604. The first message M1 is generated and published by way of the publisher overlay node 602c of the first executable node 602. A first message node 602f is instantiated for the first message M1. The message management module 214 is configured to instantiate the first message node 602f for the first message M1. The second executable node 604 receives the first message M1 via the handler overlay node 604c that subscribes the first message M1. The handler overlay node 604c processes the first message M1. In response to the processing of the first message M1 by the handler overlay node 604c, the publisher overlay node 604d generates and publishes a second message M2 (represented by a rectangular box in FIG. 6). A second message node 604e is instantiated for the second message M2. The message management module 214 is configured to instantiate the second message node 604e for the second message M2. Notably, each message node includes a corresponding composition that includes data and transactional information associated therewith. The composition of each message node includes a static dataset and a dynamic dataset. The static dataset includes data and transactional information associated with milestones of a message represented thereby that do not change based on subsequent milestones achieved by the corresponding message. The dynamic dataset includes one or more timestamps associated with the milestones achieved by the corresponding message.

The milestones associated with each message includes, but are not limited to, a creation event, a raise event, a subscription event, a handle event, and a process event. The creation event is a milestone that occurs due to creation of a message by an executable node or an overlay node of the executable graph-based model 100. A timestamp associated with the creation event is the time instance of creation of the corresponding message. The raise event is a milestone that occurs when the message is raised/placed, by an executable node or an overlay node of the executable graph-based model 100, on a message bus of the overlay system 202. A timestamp associated with the raise event is the time instance when the corresponding message was raised. The subscription event is a milestone that occurs when the message is received by a subscriber that is an executable node or an overlay node of the executable graph-based model 100. A timestamp associated with the subscription event is the time instance when the corresponding message was subscribed. The handle event is a milestone that occurs when the message is handled by an executable node or an overlay node of the executable graph-based model 100. The handle event indicates an initiation of processing of the message. A timestamp associated with the handle event is the time instance when processing of the corresponding message is initiated. The process event is a milestone that occurs when processing of the message by an executable node or an overlay node of the executable graph-based model 100 gets completed. A timestamp associated with the process event is the time instance of completion of processing of the corresponding message.

To summarize, the dynamic dataset associated with the message node keeps getting updated and modified based on each milestone achieved by the corresponding message. Hence, a current dynamic dataset reflects a current state of a message and milestones associated therewith.

For the sake of simplicity, compositions of the first and second message nodes 602f and 604e are not shown in FIG. 6.

The first and second message nodes 602f and 604e are shown by way of two concentric circles. Therefore, the first and second message nodes 602f and 604e are associated with one or more overlay nodes (for example, a time-series analytics overlay node, an encryption overlay node, or the like). The message management module 214 may be configured to instantiate one or more time-series analytics overlay nodes for each of the first and second message nodes 602f and 604e. As shown, the message management module 214 may instantiate the first time-series analytics overlay node 602g for the first message node 602f, and the second time-series analytics overlay node 604f for the second message node 604e. Notably, the message management module 214 may instantiate one or more executable nodes, one or more message nodes, one or more overlay nodes, or the like, for creation of the executable graph-based model 100.

The first time-series analytics overlay node 602g may include processing logic to perform a corresponding set of time-series analytics functions on the composition of the first message node 602f. The second time-series analytics overlay node 604f may include processing logic to perform a corresponding set of time-series computation functions on the composition of the second message node 604e. Each time-series computation function of the first and second time-series analytics overlay nodes 602g and 604f includes one or more mathematical computations. Such mathematical computations include one or more parameters. That is to say that, each time-series computation function includes the one or more parameters. For each time-series computation function associated with the first and second time-series analytics overlay nodes 602g and 604f, the analytics module 240 is configured to derive parameter values of the one or more parameters based on the composition of the first and second message nodes 602f and 604e, respectively. Each parameter of each time-series computation function corresponds to a milestone achieved by the corresponding message node. The parameter values of the parameters for each time-series computation function of the first and second time-series analytics overlay nodes 602g and 604f are determined based on timestamps associated with corresponding milestones of the first and second messages M1 and M2, respectively. The timestamps associated with each milestone of the first and second messages M1 and M2 are derived from the dynamic dataset of the composition of the first and second message nodes 602f and 604e, respectively. Specifically, the timestamps associated with each milestone of the first and second messages M1 and M2 is determined based on attribute values of attributes included in the dynamic portion of the compositions thereof.

In some embodiments, the analytics module 240 may be configured to define the parameters of each time-series computation function based on the one or more milestones associated with the corresponding message. That is to say that, the analytics module 240 defines the parameters of each time-series computation function such that the parameters correspond to timestamps associated with the milestones achieved by the corresponding message. In some embodiments, the parameters of each time-series computation function may be defined based on a first user input received via a user interface associated with the overlay system 202. The first user input may be indicative of an operation to be performed on timestamps associated with one or more milestones of the corresponding message.

In some embodiments, one or more time-series computation functions of the set of time-series computation functions may be defined based on a second user input received via the user interface associated with the overlay system 202. The second user input may be indicative of a mathematical computation. Additionally, or alternatively, one or more time-series computation functions of the set of time-series computation functions may be defined based on a third user input received via the user interface, where such the third user input may be indicative of an intent of an operation to be performed for determining the analytics outcome. The one or more time-series computation functions may be defined by the analytics module 240 based on the intent such that the one or more time-series computation functions perform the intended operation.

Further, each time-series computation function is executed on the derived parameter values. That is to say that, the mathematical computations included in each time-series computation function is executed on the dynamic portion of the composition of the corresponding message node. Further, the mathematical computations included in each time-series computation function, when executed on the dynamic portion of the composition of the corresponding message node, generates computation outputs that are indicative of the performance of the overlay system 202 while completing the milestones. Further, the analytics module 240 may be configured to execute one or more database operations such as a union operation or an intersection operation on the computation outputs of the set of time-series computation functions of the first and second time-series analytics overlay nodes 602g and 604f to generate a unified computation output.

In an example, the first and second messages M1 and M2 may have completed their processing. Therefore, each of the first and second messages M1 and M2 may have achieved handle event and process event milestones. Therefore, the dynamic portion of the composition of the first and second message nodes 602f and 604e includes attribute values corresponding to attributes ‘Handled On’ and ‘Processed On’. In such an example, the set of time-series computation functions corresponding to the first and second time-series analytics overlay nodes 602g and 604f may include time-series computation functions F1: ‘T_{ProcessM1}=M1_{P}−M1_{H}’ and ‘F2: T_{ProcessM2}=M2_{P}−M2_{H}’, respectively.

Parameters included in the time-series computation function F1 are M1_{P} and M1_{H}, where M1_{P} refers to timestamp associated with completion of process event of the first message M1 and M1_{H} refers to timestamp associated with handle event of the first message M1. A computation output T_{ProcessM1} of the time-series computation function F1 is indicative of time required for processing of the first message M1. Similarly, the time-series computation function F2 generates another computation output T_{ProcessM2}. Notably, a collective processing time for the first and second messages M1 and M2 is a time required for completion of execution of the first and second messages M1 and M2 by the first and second executable nodes 602 and 604, respectively. The analytics module 240 may be configured to execute a database operation, e.g., a union operation, on computation outputs T_{ProcessM1} and T_{ProcessM2} to determine the time required for the completion of communication between the first and second executable nodes 602 and 604.

In some embodiments, the analytics module 240 may determine the unified computation output by executing one or more database or mathematical operations on the computation outputs of the set of time-series computation functions (for example, the first time-series analytics overlay node 602g).

In some embodiments, the set of time-series computation functions of each time-series analytics overlay node (e.g., the first and second time-series analytics overlay nodes 602g and 604f) includes a set of non-executable time-series computation functions. Each of the set of non-executable time-series computation functions includes at least one parameter with an absence of corresponding parameter value. Such an absence of parameter value may be due to an incomplete status of a milestone associated with the parameter. In addition, the parameter value of such parameter may be derived based on dynamic dataset of corresponding message node once a message represented by the corresponding message node achieves the milestone and the milestone associated with the parameter attains a complete status.

In an example, the first message M1 may have achieved the milestone raised event. However, the first message M1 may not have achieved the milestone process event. Therefore, the parameter M1_{H} has the corresponding parameter value based on a complete status of the milestone handle event associated with the first message M1 represented by the first message node 602f, whereas the parameter M1_{P} does not have corresponding parameter value based on an incomplete status of the milestone process event associated with the first message M1. Subsequently, once the first message M1 gets processed and achieves the milestone process event, the parameter value for the parameter M1_{P} may be derived based on the dynamic dataset of the first message node 602f which now includes the timestamp associated with the milestone process event of the first message M1.

Although the first and second message nodes 602f and 604e are shown to be extended to have a single time-series analytics overlay node (e.g., the first and second time-series analytics overlay nodes 602g and 604f, respectively), the scope of the present disclosure is not limited to it. In other embodiments, each of the first and second message nodes 602f and 604e may be further extended to include one or more other time-series analytics overlay nodes. Such time-series analytics overlay nodes may be shared among two or more message nodes (for example, the first and second message nodes 602f and 604e). Alternatively, such time-series analytics overlay nodes may be exclusive to a single message node (for example, the first and second message nodes 602f and 604e). In an example, the first message node 602f may be associated with a third time-series analytics overlay node (not shown) that is configured to execute a set of time-series computation functions that are different from the set of time-series computation functions associated with the first time-series analytics overlay node 602g.

The message management module 214 may be further configured to instantiate publisher overlay nodes 602h and 604g for the first and second time-series analytics overlay nodes 602g and 604f, respectively. Each of the publisher overlay nodes 602h and 604g is configured to generate and publish one or more statistical insights based on the set of computation outputs generated by the corresponding first and second time-series analytics overlay nodes 602g and 604f, respectively. Subsequently, the analytics module 240 may be configured to generate an analytics outcome based on the one or more statistical insights published by each of the publisher overlay nodes 602h and 604g.

In operation, the controller module 206 may receive a second contextualized stimulus. The second contextualized stimulus may include a second stimulus (for example, the stimulus 230) and the context 226 associated therewith. The context module 210 may process the context 226 and generate operation execution context that is indicative of one or more message nodes, one or more message edge nodes, one or more time-series analytic overlay nodes, one or more publisher overlay nodes, or the like, that are required for stimulus processing of the stimulus 230. The stimulus 230 may be indicative of an instruction to analyze the first and second messages M1 and M2 in order to determine the operational performance of the overlay system 202. The stimulus 230 may be further indicative of a type of time-series analytics (e.g., descriptive time-series analytics, diagnostic time-series analytics, predictive time-series analytics, and/or prescriptive time-series analytics) to be performed on the first and second messages M1 and M2. Based on the operation execution context, the stimuli management module 212 may be configured to identify, in the executable graph-based model 100, the first and second message nodes 602f and 604e that represent the first and second messages M1 and M2, respectively.

Subsequently, based on the type of analytics to be performed, the stimuli management module 212 may be further configured to identify one or more time-series analytics overlay nodes that may be associated with the first and second message node 602f and 604e. For the sake of ongoing discussion, it is assumed that the stimuli management module 212 may identify the first time-series analytics overlay node 602g and the second time-series analytics overlay node 604f for performing the analysis. The first and second time-series analytics overlay nodes 602g and 604f may be any one of the descriptive time-series analytics overlay node, the diagnostic time-series analytics overlay node, the predictive time-series analytics overlay node, the prescriptive time-series analytics overlay node, a combination of these, or any other time-series analytics overlay node. The analytics module 240 may be configured to execute the operation associated with the stimulus 230 using the first and second message nodes 602f and 604e and the first and second time-series analytics overlay nodes 602g and 604f. In an instance, the stimuli management module 212 may determine that one or more nodes required for stimulus processing of the second stimulus are not loaded in the executable graph-based model 100. In such an instance, the one or more nodes required for the stimulus processing are loaded in the executable graph-based model by the memory management module 218 and the storage management module 220.

The first time-series analytics overlay node 602g executes the corresponding set of time-series computation functions on the composition (e.g., the dynamic portion and the static portion) of the first message node 602f, and determines a computation output for each time-series computation function. Similarly, the second time-series analytics overlay node 604f executes a corresponding set of time-series computation functions on the composition of the second message node 604e and determines a computation output for each time-series computation function.

In some embodiments, the first time-series analytics overlay node 602g may use the static dataset in addition to the dynamic dataset, of the first message node 602f for stimulus processing of the second stimulus. A first set of attribute values of a first set of attributes in the static dataset may be used to identify, from the dynamic dataset, a second set of attribute values of a second set of attributes in the dynamic dataset. The first set of attribute values may be a subset of the static dataset and the second set of attribute values may be a subset of the dynamic dataset. The second set of attribute values may be used by the first time-series analytics overlay node 602g for execution of the first set of time-series computation functions.

In an example, the second stimulus may be indicative of an instruction to analyze one or more messages associated with the overlay system 202 to determine processing time associated therewith. The second stimulus may also indicate that the messages being analyzed must have an attribute value ‘maintenance’ for an attribute ‘topic’. An attribute value for the attribute ‘topic’ may be included in static datasets of the plurality of message nodes that represent the plurality of messages. Therefore, from the plurality of messages associated with the overlay system 202, each message that has the attribute value ‘maintenance’ for the attribute ‘topic’ is identified for stimulus processing of the second stimulus. Therefore, the static dataset of the plurality of message nodes may be used as a filter to identify relevant messages and corresponding message nodes for stimulus processing of the second stimulus. Therefore, the static dataset provides one or more filters that are to be adhered to while determining the set of computation outputs. The set of computation outputs is indicative of the operational performance of the overlay system 202 while completing each milestone of the corresponding message node.

In some embodiments, the first time-series analytics overlay node 602g may further use non-message data associated with the overlay system 202 for stimulus processing of the second stimulus. Examples of non-message data may include, but are not limited to, business rules, user preferences, administrative data, and device configurations associated with the overlay system 202. Such non-message data may be used to perform operations such as filtering, sorting, pruning, normalizing, or the like, while generating the computation output.

The analytics module 240 may execute the operation associated with the stimulus 230 further based on the publisher overlay nodes 602h and 604g of the first and second time-series analytics overlay nodes 602g and 604f, respectively. The execution of the operation associated with the stimulus 230 further includes generation and publication of statistical insights SI1 and SI2 by the publisher overlay nodes 602h and 604g, respectively. The publisher overlay node 602h that extends the first time-series analytics overlay node 602g generates and publishes the statistical insight SI1 based on the set of computation outputs generated by the first time-series analytics overlay node 602g. Subsequently, the analytics module 240 generates an analytics outcome based on the statistical insight SI1. The analytics outcome may be indicative of an evaluation of one or more tasks associated with the overlay system 202 that are performed by communicating and processing the first message M1. Similarly, the publisher overlay node 604g, that extends the second time-series analytics overlay node 604f, generates and publishes the statistical insight SI2 and another analytics outcome is generated based on the statistical insight SI2. The analytics outcomes may be indicative of one or more recommendations based on the statistical insights SI1 and SI2, a current state of the overlay system 202, a cause of the current state of the overlay system 202, a foreseeable state of the overlay system 202, or the like.

In some embodiments, the first and second message nodes 602f and 604e may include confidential data (for example, PHI data or PII data). Hence, the analytics outcome associated therewith also requires to be protected. In such embodiments, the first and second time-series analytics overlay nodes 602g and 604f and/or the publisher overlay nodes 602h and 604g may also be extended to include an encryption overlay node or an obfuscation overlay node that may include processing logic that when executed protects the set of computational outcomes associated with the confidential data stored at the first and second message nodes 602f and 604e. In other embodiments, the first and second message nodes 602f and 604e may be extended to include other types of overlay nodes, without deviating from the scope of the disclosure.

In an embodiment, the stimulus management module 212 may identify the first message node 602f for stimulus processing of the stimulus 230. In such an embodiment, the first message M1 may be associated with a set of messages. That is to say that, the first message node 602f may be associated with a set of message nodes that represents the set of messages. In an example, the set of messages may include the second message M2, hence, the set of message nodes may include the second message node 604e. The first message M1 and the set of messages may be correlated such that the first message M1 may have a causal association with at least one other message (for example, the second message M2) of the set of messages. Further, the set of messages is correlated such that each message of the set of messages has a causal association with at least one other message of the set of messages. The set of messages is generated based on one or more stimuli (for example, the first stimulus) received prior to the stimulus 230. The message management module 214 may have instantiated the set of message nodes based on the generation of the set of messages upon reception of the first stimulus. The analytics module 240 may be configured to execute the operation associated with the stimulus 230 based on the first message M1 and the set of messages.

For performing the operation associated with the stimulus 230, the message management module 214 is further configured to identify, in the executable graph-based model 100, the set of message nodes (e.g., the second message node 604e) associated with the set of messages (the second message M2) and at least one time-series analytics overlay node (the second time-series analytics overlay node 604f) associated with each message node of the set of message nodes. The analytics module 240 executes the operation associated with the stimulus 230 further based on the identified set of message nodes and the identified time-series analytics overlay node associated with each message node of the set of message nodes. Notably, the first message node 602f and the set of message nodes are linked (e.g., correlated) by way of one or more correlation IDs, one or more message edge nodes, source ID, or the like.

As mentioned above, data and processing logic are stored separately to ensure segregation and independent control thereof. Therefore, prior to the execution of the operation associated with the stimulus 230, the message management module 214 may be configured to determine all nodes that are required for executing the operation associated with the stimulus 230 and load, in the executable graph-based model 100, nodes, that are currently not loaded, with corresponding data and processing logic. For example, in case only the first and second message nodes 602f and 604e are not loaded, the storage management module 220 may be configured to load, in the executable graph-based model 100, the compositions of the first and second message nodes 602f and 604e. In case only the first and second time-series analytics overlay nodes 602g and 604f are not loaded, the storage management module 220 may be configured to load such nodes in the executable graph-based model 100 with corresponding data and processing logic. In case, in the executable graph-based model 100, only the publisher overlay nodes 602h and 604g are not loaded, the storage management module 220 may be configured to load such nodes with corresponding data and processing logic. Multiple combinations may be possible without deviating from the scope of the present disclosure. The loading of the message nodes, time-series analytics overlay nodes, publisher overlay nodes, or a combination thereof, is performed as described above in FIG. 5.

Although FIG. 6 describes two messages (e.g., the first and second messages M1 and M2), the scope of the present disclosure is not limited to it. In various other embodiments, multiple messages may be analyzed, and the analytics may be performed separately for each message or collectively for a set of correlated messages. The set of correlated messages include messages that have an association (for example, a causal association) therebetween.

It will be appreciated by a person skilled in the art that although FIG. 6 illustrates the executable nodes to be extended only by way of time-series analytics overlay nodes, handler overlay nodes, and publisher overlay nodes, the scope of the present disclosure is not limited to it. In other embodiments, the executable nodes may further include other overlay nodes such as an encryption overlay node, an obfuscation overlay node, or the like. Throughout the description, the terms “overlay” and “overlay node” are used interchangeably.

It will be apparent to a person skilled in the art that the structure of the executable graph-based model 100 is non-limiting. The structure of the executable graph-based model 100 is dynamic and may be modified based on an input (e.g., internal/external) received by the overlay system 202.

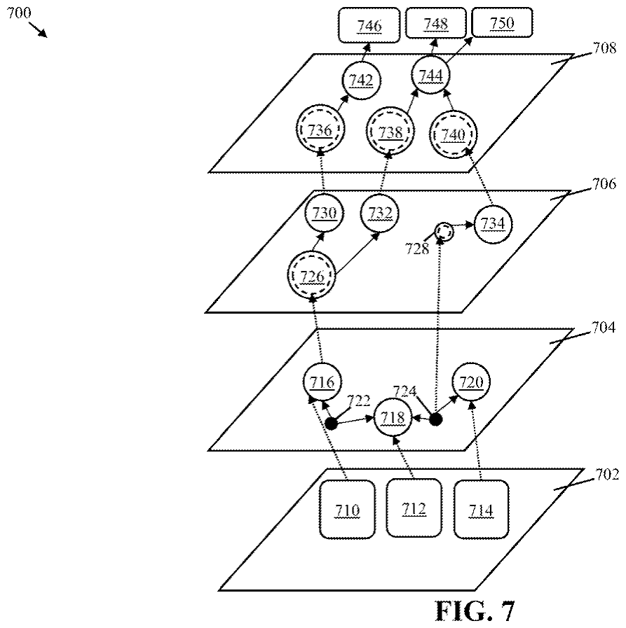

Further, the executable graph-based model 100 has a tier-based architecture (shown later in FIG. 7). The nodes (for example, the first and second message nodes 602f and 604e, the first and second time-series analytics overlay nodes 602g and 604f, the publisher overlay nodes 602h and 604g, or the like) shown in FIG. 6 may belong to different tiers of the executable graph-based model 100. Each tier encompasses a set of nodes. For example, a first tier includes messages associated the overlay system 202, a second tier includes message nodes instantiated for the messages associated with the overlay system 202, a third tier may include time-series analytics overlay nodes associated with the message nodes, and a fourth tier includes publisher overlay nodes associated with the time-series analytics overlay nodes.

FIG. 7 is a schematic diagram that illustrates the tier-based architecture 700 of the executable graph-based model 100, in accordance with an embodiment of the present disclosure. Referring to FIG. 7, a first tier of the executable graph-based model 100 is a message-tier 702 and includes messages associated with the overlay system 202. A second tier of the executable graph-based model 100 is a graph-tier 704 and includes message nodes instantiated for the messages at the message-tier 702. The graph-tier 704 may also include one or more non-message nodes of the executable graph-based model 100. A third tier of the executable graph-based model 100 is an analytics-tier 706 and includes one or more time-series analytics overlay nodes associated with the message nodes at the graph-tier 704. A fourth tier of the executable graph-based model 100 is an analytics outcome tier 708 that includes one or more publisher overlay nodes associated with the time-series analytics overlay nodes at the analytics-tier 706. The message-tier 702, the graph-tier 704, the analytics-tier 706, and the analytics outcome tier 708, collectively, form the executable graph-based model 100.

In operation, the messages associated with the overlay system 202 are created at the message-tier 702. As shown, the message-tier 702 includes messages 710-714. Each of the messages 710-714 may be one of a command message, a query message, and an event message. Further, for the messages 710-714, message nodes 716-720 are instantiated at the graph-tier 704, respectively. In some embodiments, the messages 710-714 may be correlated by way of a causal association and such correlation may be reflected in the message nodes 716-720 by coupling thereof via message edge nodes 722 and 724. As shown, the message edge node 722 couples the message nodes 716 and 718, whereas, the message edge node 724 couples the message nodes 718 and 720. Further, based on the stimulus 230, analysis of the messages 710-714 may have to be performed. Therefore, one or more message nodes (for example, the message node 716) for which the analysis is to be performed is identified. Subsequently, a message node reference 726 (represented by way of a dashed circle) of the message node 716 is created at the analytics-tier 706 The message node reference 726 is a pointer to the message node 716. The message node reference 726 is represented by way of two concentric circles where an outer circle is formed by a solid line and an inner circle is formed by a dashed line. Further, the message edge node 724 is able to access each of the message nodes 718 and 720. As the stimulus 230 further indicates that the messages 712 and 714 are also to be analyzed, hence, a message edge node reference 728 (represented by way of a dashed circle) of the message edge node 724 is created at the analytics-tier 706. It will be apparent to a person skilled in the art that, for each executable node that is to be analyzed, a corresponding node reference is created at the analytics-tier 706. A node reference is a pointer to a node that is being referred. The node reference is immutable and may not be modified without modifying the node that is being referred. It will be apparent to a person skilled in the art that each node reference that is encompassed within another circle is indicative of the corresponding node having an overlay associated therewith.

At the analytics-tier 706, the message node reference 726 is associated with time-series analytics overlay nodes 730 and 732, where each of the time-series analytics overlay nodes 730 and 732 have distinct overlay node types. Hence, the time-series analytics overlay nodes 730 and 732 may perform corresponding sets of time-series computation functions on a composition of the message node 716. The time-series analytics overlay nodes 730 and 732 may access the message node 716 by way of corresponding message node reference 726. Similarly, the message edge node reference 728 is associated with a time-series analytics overlay node 734 that may have similar or different overlay node type from the time-series analytics overlay nodes 730 and 732. The time-series analytics overlay node 734 may perform the corresponding set of time-series computation functions on compositions of the message nodes 718 and 720. The time-series analytics overlay node 734 may access the message nodes 718 and 720 by way of corresponding message edge node reference 728. Each time-series computation function corresponding to each of the time-series analytics overlay nodes 730, 732, and 734 generates a computation output.

At the analytics outcome tier 708, time-series analytics overlay node references 736, 738, and 740 (shown by way of corresponding dashed circles) are created for the time-series analytics overlay nodes 730, 732, and 734, respectively. As shown, at the analytics outcome tier 708, the time-series analytics overlay node reference 736 is associated with a publisher overlay node 742, and the time-series analytics overlay node references 738 and 740 are associated with a publisher overlay node 744. The publisher overlay node 742 may generate, based on the set of computation outputs generated by the time-series analytics overlay node 730, a statistical insight (not shown) that may be used by the analytics module 240. Further, the analytics module 240 may generate an analytics outcome 746 based on the set of computational outputs. The analytics outcome 746 includes statistical insights associated with the performance of the overlay system 202. Similarly, the publisher overlay node 744 may also generate statistical insights (not shown) based on the sets of computation outputs generated by the time-series analytics overlay nodes 732 and 734. The statistical insights may be used by the analytics module 240 to generate analytics outcomes 748 and 750. The analytics outcomes 746, 748, and 750 may have different statistical insights associated with the performance of the overlay system 202. In an example, the analytics outcome 748 may be indicative of predictive analysis of the message 712, whereas, the analytics outcome 750 may be indicative of prescriptive analysis of the message 714.

To summarize, the abovementioned operations are executed for performing the stimulus processing of the stimulus 230. Hence, the stimulus processing of the stimulus 230 includes each of the operations performed at the message-tier 702, the graph-tier 704, the analytics-tier 706, and the analytics outcome tier 708.

It will be apparent to a person skilled in the art that, in other embodiments, the executable graph-based model 100 may include different or additional layers in its architecture, without deviating from the scope of the disclosure. Such layers may include a plurality of non-message nodes (for example, vertex nodes, edge nodes, and overlay nodes). One or more non-message nodes of the plurality of non-message nodes may be associated with the message nodes at the graph-tier 704. The one or more non-message nodes may have participated in generation, publication, handling, processing, or any other processes associated with messages at the message-tier 702 that are represented by the corresponding message nodes at the graph-tier 704. Also, the time-series analytics overlay nodes at the analytics-tier 706 and the publisher overlay nodes 742 and 744 at the analytics outcome tier 708 may directly or indirectly communicate with the one or more non-message nodes at different layers of the executable graph-based model 100 in order to acquire data required for generation of the analytics outcome. Additionally, the time-series analytics overlay nodes at the analytics-tier 706 and the publisher overlay nodes 742 and 744 at the analytics outcome tier 708 may be coupled with or inherit from the non-message nodes (for example, vertex nodes, edge nodes, and overlay nodes) in order to acquire data and/or processing logic required for generation of the statistical insight or the analytics outcome.

As mentioned earlier, the analytics outcomes 746-750 are results of analysis performed on the compositions of the message nodes 716, 718, and 720. The compositions of the message nodes 716, 718, and 720 are indicative of data and transactional information associated with the messages 710-714, respectively.

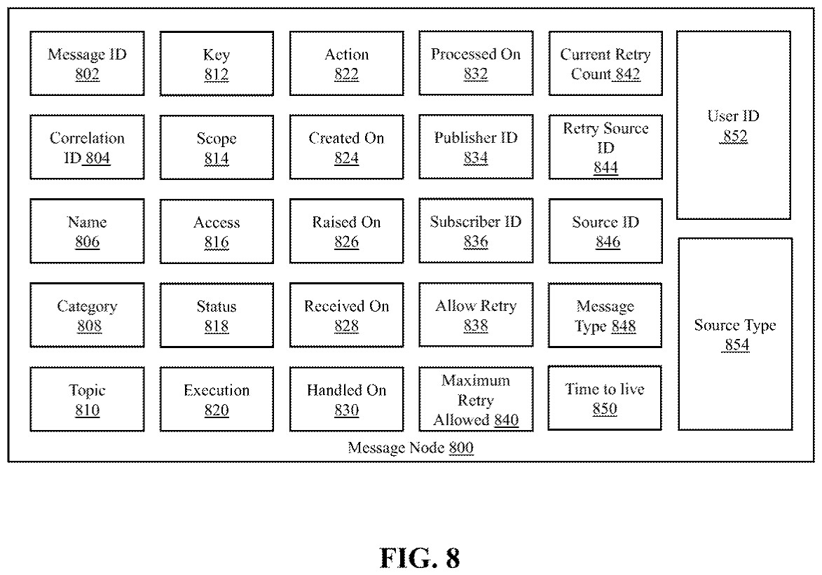

FIG. 8 is a block diagram that illustrates a composition of a message node 800, in accordance with an embodiment of the present disclosure. The message node 800 may represent one of a command-type message, a query-type message, and an event-type message. The message node 800 may be one of the message nodes 716-720 or any other message node associated with the overlay system 202. A message associated with the overlay system 202 includes data and transactional information that may be used for communication, processing, and auditing associated with the overlay system 202. Data included in composition of a message node refers to message payload associated with a message being represented by the message node. In other words, the data in the composition of the message node refers to a statement, an instruction, a message, a command, a query, or the like, that is being communicated via the message.

Referring to FIG. 8, the composition of the message node 800 includes a plurality of attributes that form the transactional information associated with the message node 800. The plurality of attributes include attributes ‘Message ID’ 802, ‘Correlation ID’ 804, ‘Name’ 806, ‘Category’ 808, ‘Topic’ 810, ‘Key’ 812, ‘Scope’ 814, ‘Access’ 816, ‘Status’ 818, ‘Execution’ 820, ‘Action’ 822, ‘Created On’ 824, ‘Raised On’ 826, ‘Received On’ 828, ‘Handled On’ 830, ‘Processed On’ 832, ‘Publisher ID’ 834, ‘Subscriber ID’ 836, ‘Allow Retry’ 838, ‘Maximum Retry Allowed’ 840, ‘Current Retry Count’ 842, ‘Retry Source ID’ 844, ‘Source ID’ 846, ‘Message Type’ 848, ‘Time to live’ 850, ‘User ID’ 852, and ‘Source Type’ 854. Though the data associated with the message node 800 is not shown in FIG. 8, it will be apparent to a person skilled in the art that the composition of the message node 800 includes the data to be communicated by the message that is being represented by the message node 800.

The attribute ‘Message ID’ 802 included in the message node 800 is a unique ID associated with the message represented by the message node 800 and may be used by modules (for example, the message management module 214) of the overlay system 202 to identify the message node 800.

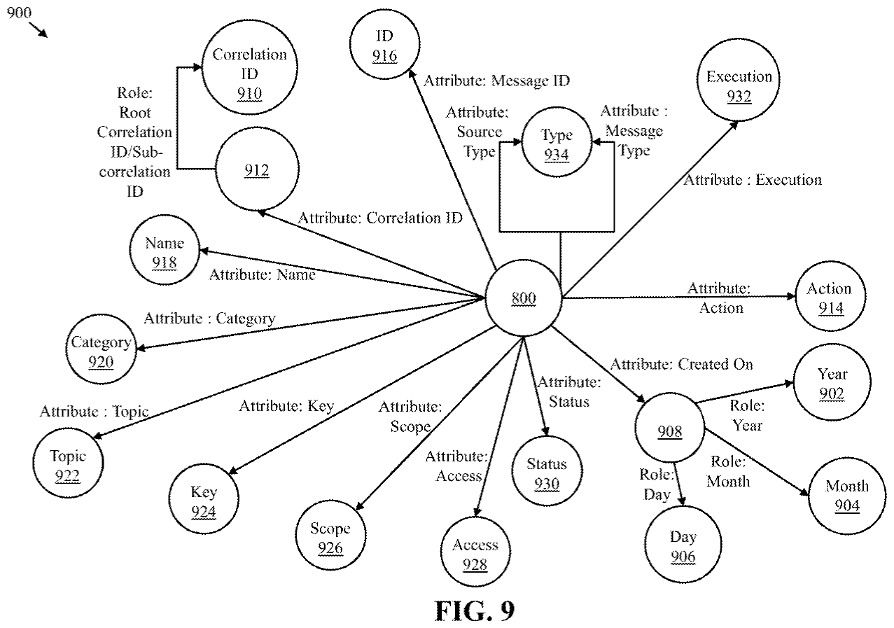

The attribute ‘Correlation ID’ 804 included in the message node 800 is an ID that is shared among messages that are related. The attribute ‘Correlation ID’ 804 is used to link and correlate one or more messages in a transaction flow such as a command to event, a query to event, or the like. Each sub-message (child message) of a compound message (parent message) includes a hierarchical correlation ID. Further, sub-messages at the same level of hierarchy have identical attribute value for the attribute ‘Correlation ID’ 804. Sub-messages at each subsequent hierarchical level further include attribute values of the attribute ‘Correlation ID’ 804 of sub-messages at previous hierarchical levels. Each sub-message also includes a root ID that is associated with the parent message. Correlation among messages is described in detail in conjunction with FIG. 9.

The attribute ‘Name’ 806 included in the message node 800 is a human-understandable descriptor of the message and is solely included for the ease of understanding of users associated with the overlay system 202.

The attribute ‘Category’ 808 included in the message node 800 is a human-understandable descriptor of a domain or criterion of the message. For example, an attribute value of the attribute ‘Category’ 808 of the message node 800 may be a ‘status message’. Messages that have attribute value ‘status message’ for the attribute ‘Category’ 808 are indicative status of one or more components (for example, module, node, message, or the like) associated with the overlay system 202.

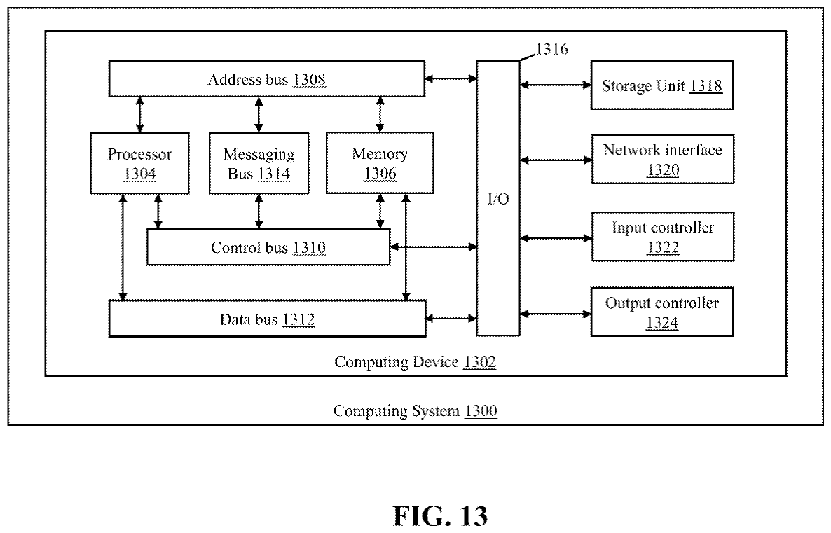

The attribute ‘Topic’ 810 included in the message node 800 is a human-understandable descriptor of a topic/domain/subject/agenda associated with which the message node 800 has been published. Notably, the attribute ‘Topic’ 810 allows grouping of multiple messages irrespective of their category. Each message may be associated with a single attribute value of the attribute ‘Topic’ 810, whereas, each attribute value of the attribute ‘Topic’ 810 may be associated with multiple messages. Each attribute value of the attribute ‘Topic’ 810 may have one or more subscribers. Each attribute value of the attribute ‘Topic’ 810 may be published/scheduled for processing using a specific pipeline of a messaging bus (shown in FIG. 13) and then subscribed to by one or more handler overlay nodes.

The attribute ‘Key’ 812 included in the message node 800 corresponds to a target object unique ID that is an ID of a destination executable node of the message node 800. Messages having the same attribute value of the attribute ‘Key’ 812 have the same target object unique ID. The attribute ‘Key’ 812 allows messages with the same attribute values of the attributes ‘Topic’ 810 and ‘Key’ 812 to be queued together, so they are processed in order by the target object (destination executable node).

The attribute ‘Scope’ 814 included in the message node 800 ensures appropriate security of the message node 800. Attribute values of the attribute ‘Scope’ 814 may be internal or external. When the attribute value of the attribute ‘Scope’ 814 is internal, the message represented by the message node 800 may be internal, e.g., the message node 800 is to be communicated among executable nodes of the executable graph-based model 100. Alternatively, when the attribute value of the attribute ‘Scope’ 814 is external, the message represented by the message node 800 may be external, e.g., the message is to be communicated from one or more executable nodes of the executable graph-based model 100 to one or more modules that are external to the overlay system 202. Therefore, the attribute value of the attribute ‘Scope’ 814 in the composition of the message node 800 may be one of ‘internal’, ‘external’, and ‘internal and external’.

The attribute ‘Access’ 816 included in the message node 800 determines access permission to the message node 800. In an instance, when an attribute value of the attribute ‘Access’ 816 is public, a user trying to access the message node 800 is not required to be authenticated prior to accessing the message node 800. In another instance, when the attribute value of the attribute ‘Access’ 816 is private, a user trying to access the message node 800 is required to be authenticated prior to accessing the message node 800.

The attribute ‘Status’ 818 included in the message node 800 is indicative of the progress of execution of the message node 800. An attribute value of the attribute ‘Status’ 818 of the message node 800 may be one of created, raised, received, handled, and processed.

The attribute ‘Execution’ 820 included in the message node 800 is indicative of a path that is to be traveled by the message node 800 to reach its destination executable node. The attribute ‘Execution’ 820 may have an attribute value ‘synchronous’ or ‘asynchronous’. In an instance, when the attribute value of the attribute ‘Execution’ 820 may be ‘asynchronous’, the message node 800 may follow a hierarchical path associated with the hierarchical structure of the executable graph-based model 100. In another instance, when the attribute value of the attribute ‘Execution’ 820 may be ‘synchronous’, the message node 800 may be published directly from a source executable node (an executable node that has received the stimulus 230) to a subscriber channel of the destination executable node. Synchronous communication requires less time for communication of the message represented by the message node 800 and can be used when the message is only directed to the destination executable node and does not require any sequence in operation(s) to be performed based on the processing of the message.

The attribute ‘Action’ 822 included in the message node 800 is indicative of an action or operation to be performed by the target object. The terms ‘target object’ and ‘destination executable node’ are used interchangeably. The target object may execute, based on processing of the message represented by the message node 800, an operation indicated by the attribute ‘Action’ 822 in conjunction with the corresponding base node.

The attribute ‘Created On’ 824 included in the message node 800 includes timestamp (including time, date, day, month, or the like) associated with the creation event of the message, represented by the message node 800, by its source executable node.

The attribute ‘Raised On’ 826 included in the message node 800 includes timestamp (including time, date, day, month, or the like) associated with a publication that is occurrence of a raise event of the message node 800 in a communication/message bus by its source executable node. The communication bus forms a channel between a source and a destination of the message represented by the message node 800.

The attribute ‘Received On’ 828 included in the message node 800 includes timestamp (including time, date, day, month, or the like) associated with the reception of the message represented by the message node 800 by the destination executable node but has not been processed. The attribute ‘Received On’ 828 may also be referred to ‘Subscribed On’ and includes timestamp associated with subscription of the message by one or more executable nodes or overlay nodes.

The attribute ‘Handled On’ 830 included in the message node 800 includes timestamp (including time, date, day, month, or the like) associated with initiation of the processing of the message represented by the message node 800. That is to say that, the attribute ‘Handled On’ 830 included in the message node 800 includes timestamp (including time, date, day, month, or the like) associated with the handled event of the message represented by the message node 800.

The attribute ‘Processed On’ 832 included in the message node 800 includes timestamp (including time, date, day, month, or the like) associated with completion of the processing of the message represented by the message node 800.

The attribute ‘Publisher ID’ 834 included in the message node 800 is a unique ID for a publisher overlay node that has published the message represented by the message node 800. An attribute value of the attribute ‘Publisher ID’ 834 may be associated with the source executable node or an intermediate executable node.

The attribute ‘Subscriber ID’ 836 included in the message node 800 is a unique ID for a handler overlay node(s) that subscribes to the message node 800. Notably, a command-type message and a query-type message may be subscribed by a single executable node, whereas an event-type message may be subscribed by multiple executable nodes and each executable node receives a copy of the event-type message.

The attribute ‘Allow Retry’ 838 included in the message node 800 ensures successful communication and processing of the message represented by the message node 800. An attribute value of the attribute ‘Allow Retry’ 838 determines if the message represented by the message node 800 is to be re-published in case a status of the message node 800 is a failure or partial failure. The re-published message may be a clone of the original message represented by the message node 800.

The attribute ‘Maximum Retry Allowed’ 840 included in the message node 800 determines a maximum count for which the message represented by the message node 800 is to be re-published in case the status of the message is a failure or partial failure.

The attribute ‘Current Retry Count’ 842 included in the message node 800 keeps track of a number of times for which the message represented by the message node 800 is re-published. That is to say that, the attribute ‘Current Retry Count’ 842 is indicative of a current count of re-publications of the message represented by the message node 800. An attribute value of the attribute ‘Current Retry Count’ 842 gets incremented with each re-publication of the message represented by the message node 800.

The attribute ‘Retry Source ID’ 844 included in the message node 800 is a unique ID of an original message (e.g., the message represented by the message node 800) that is being re-published. The attribute ‘Retry Source ID’ is required as during the re-publication of the message represented by the message node 800, a clone message thereof with a different ID is generated and published. The clone message has timestamps (e.g., created on timestamp, received on timestamp, or the like) that are different from the timestamps included in the message node 800. Therefore, in order to link the clone message to the message represented by the message node 800, an attribute value of the attribute ‘Retry Source ID’ 844 is included in the clone message.

The attribute ‘Source ID’ 846 is included in the message node 800 if the message represented by the message node 800 has originated from another message. For example, an event-type message that is created in response to the processing of a command-type message may have an attribute value of the attribute ‘Source ID’ 846 that is identical to an attribute value ‘Message ID’ 802 of the command-type message.

The attribute ‘Message Type’ 848 is indicative of the message node 800 being one of a command message, a query message, or an event message. The message type 848 may further include a flag, where a value ‘1’ of the flag may indicate that the message represented by the message node 800 is a leaf message whereas a value ‘0’ of the flag may indicate that the message represented by the message node 800 is a composite message. The leaf message does not have any sub-messages, whereas, the composite message is a message having two or more sub-messages. In other embodiments, composite and leaf messages may be indicated differently without deviating from the scope of the disclosure.

The attribute ‘Time to live’ 850 may be indicative of a time period during which the message represented by the message node 800 may be valid. Therefore, the message should be communicated and processed within a duration that is indicated by an attribute value of the attribute ‘Time to live’ 850. In an instance of failure or partial failure, the message node 800 should not be re-published once the time period indicated by the attribute value of the attribute ‘Time to live’ 850 has lapsed. Notably, the lapse of the time period indicated by the attribute value of the attribute ‘Time to live’ 850 is indicative of the message represented by the message node 800 being invalid.

The attribute ‘User ID’ 852 has a corresponding attribute value that is a unique ID associated with a user of the overlay system 202 that may have generated the message represented by the message node 800.

The attribute ‘Source Type’ 854 refers to a type of message (e.g., command, query, and event), processing of which may have caused generation of the message represented by the message node 800. An attribute value of the attribute ‘Source Type’ 854 may be one of command, query, and event.

The composition of the message node 800 described in FIG. 8 may be used by the overlay system 202 for performing the analysis of the message represented thereby. Such analysis may be performed to determine one or more analytic outcomes associated with performance of the business solution associated with the overlay system 202.

In an example, the analytics module 240 may analyze the composition of the message node 800 by way of a time-series analytics overlay node associated with the message node 800. The time-series analytics overlay node may determine one or more correlated messages based on an attribute value of the ‘Correlation ID’ 804 of the message node 800. Further, based on an attribute value of the status 818 of the message node 800, the time-series analytics overlay node may execute the corresponding set of time-series computation functions and may generate a computation output for each time-series computation function, where the computation output is indicative of time-consuming processing of message represented by the message node 800 leading to delayed execution of its correlated messages. Further, a publisher overlay node, associated with the time-series analytics overlay node, may generate and publish a statistical insight that indicates excessive time consumption in processing of the message with a first message ID. Subsequently, the analytics module 240 may generate, based on the statistical insight, an analytics outcome that is indicative of one or more diagnostic steps to be taken in order to ensure a timely execution of the message represented by the message node 800 and its correlated messages.

It will be apparent to a person skilled in the art that the composition of the message node 800 described in conjunction with FIG. 8 is non-limiting and in other embodiments components included in the message node 800 may differ from the components depicted in FIG. 8.

As mentioned above, the composition of the message node 800 includes the plurality of attributes (e.g., the attributes 310). Each attribute of the plurality of attributes is stored at a corresponding attribute vertex node of the executable graph-based model 100, where attribute vertex node is a vertex node that stores attribute value of a corresponding attribute. In embodiments, when an attribute stores a composite data, every data of the composite data is stored at a corresponding vertex node and are collectively joined to the message node 800 by way of an attribute edge node that also includes role for every data of the composite data.

To summarize, the executable graph-based model 100 includes a plurality of attribute vertex nodes and a plurality of attribute edge nodes that, collectively, store composition of each message node of the executable graph-based model 100. Each message node is associated with one or more attribute vertex nodes of the plurality of attribute vertex nodes, with the one or more attribute vertex nodes configured to store the composition of the corresponding message node. Further, each message node of the plurality of message nodes is associated with one or more attribute vertex nodes that store composite data (e.g., attribute value for the attribute ‘Created On’ is a combination of ‘Year’, ‘Month’, and ‘Day’ data) by way of one or more attribute edge nodes of the plurality of attribute edge nodes, respectively, with the one or more attribute edge nodes defining the association between the one or more vertex nodes and the corresponding message node.

Moreover, the composition of the message node 800 is not permanently stored in the executable graph-based model 100. The composition of the message node 800 is loaded in such attribute vertex nodes whenever the message node 800 is to be analyzed.

FIG. 9 is a graph 900 that represents the composition of the message node 800 of FIG. 8 in the executable graph-based model 100, in accordance with an embodiment of the present disclosure. Referring to FIG. 9, the plurality of attributes of the message node 800 are stored by way of a plurality of nodes 902-934 that includes a set of attribute vertex nodes and a set of attribute edge nodes. Each attribute of the plurality of attributes is stored in the set of attribute vertex nodes as a value shared attribute or a non-value shared attribute. An attribute vertex node that stores an attribute value of a value shared attribute is coupled to the message node 800 as well as one or more other message nodes. Therefore, the attribute value of such value shared attribute may be included in the composition of the message node 800 and compositions of the one or more other message nodes. An attribute vertex node that stores an attribute value of a non-value shared attribute of the message node 800 is coupled only to the message node 800. Therefore, non-value shared attributes are exclusive to a single message node.

As shown, the message node 800 is coupled to the attribute vertex nodes 902-906 that, collectively, store the attribute value of the attribute ‘Created On’ 824 of the message node 800, where the attribute value of the attribute ‘Created On’ 824 is composite data. The attribute vertex nodes 902-906 are associated with the message node 800 by way of an attribute edge node 908. The attribute edge node 908 includes roles for the message node 800 and the attribute vertex nodes 902-906. The roles are indicative of an association between the message node 800 and the attribute vertex nodes 902-906. The attribute edge node 908 includes a role (not shown) ‘is created on’ for the message node 800 and roles ‘Year’, ‘Month’, and ‘Day’ for the attribute vertex nodes 902, 904, and 906, respectively.

Notably, the attribute ‘Created On’ 824 is a value shared attribute. Hence, the attribute vertex nodes 902-906 that, collectively, store the attribute value for the attribute ‘Created On’ 824 may also be coupled to one or more other message nodes that may have same attribute value for at least one of the attributes ‘Created On’ 824, ‘Raised On’ 826, ‘Received On’ 828, ‘Handled On’ 830, and ‘Processed On’ 832. Similarly, the message node 800 may be coupled to other attribute vertex nodes, that store other composite data for attribute values of corresponding attributes, via other attribute edge nodes with roles ‘raised on’, ‘received on’, ‘processed on’, ‘handled on’, and ‘subscribed on’. Such attribute vertex nodes may store attribute values for the attributes ‘Raised On’ 826, ‘Received On’ 828, ‘Handled On’ 830, and ‘Processed On’ 832 of the message node 800. For the sake of brevity, only the attribute vertex nodes 902, 904, and 906 that store the attribute values for the attribute ‘Created On’ 824 of the message node 800 are shown in FIG. 9.

The message node 800 is further coupled to one or more attribute vertex nodes such as an attribute vertex node ‘Correlation ID’ 910 that stores attribute values for the attribute ‘Correlation ID’ 804 of the message node 800. In embodiments, when the message node 800 is not correlated to any other node or is a root node, an attribute value associated with the attribute ‘Correlation ID’ 804 is non-composite data. In embodiments, when the message node 800 is correlated to one or more other message nodes and may not be a root message node, the attribute value associated with the attribute ‘Correlation ID’ 804 is composite data. In such embodiments, the attribute value associated with the attribute ‘Correlation ID’ 804 may be stored at two or more attribute vertex nodes that may be couped to the message node 800 via a corresponding attribute edge node. As shown, the attribute vertex node ‘Correlation ID’ 910 is coupled to the message node 800 by way of an attribute edge node 912. The attribute edge node 912 may include role (not shown) for the message node 800 and role ‘Root Correlation ID’ or ‘Sub-Correlation’ ID for the attribute vertex node ‘Correlation ID’ 910.

For the sake of brevity, FIG. 9 is shown to include a single attribute vertex node that stores an attribute value for the attribute ‘Correlation ID 804’ associated with the message node 800. In other embodiments, the message node 800 may be associated with one or more other attribute vertex nodes that may store one or more correlation IDs associated with the message node 800.

As shown, the message node 800 is coupled to an attribute vertex node 914 that stores the attribute value of the attribute ‘Action’ 822 of the plurality of attributes shown in FIG. 8. The attribute ‘Action’ 822 is a value shed attribute.

As shown, the message node 800 is further associated with the attribute vertex node 916 that stores the attribute value of the attribute ‘Message ID’ 802 of the message node 800. The attribute value of the attribute ‘Message ID’ 802 stored at the attribute vertex node ‘ID’ 916 may be a non-value shared attribute. Similarly, the message node 800 may be associated with other attribute vertex nodes that store attribute values of the attributes ‘Publisher ID’ 834, ‘Subscriber ID’ 836, ‘Retry Source ID’ 844 and additional attributes such as ‘User ID’ and ‘Source ID’, of the message node 800.

The message node 800 may be associated with attribute vertex nodes 918-932 that may store attribute values of the attributes ‘Name’ 806, ‘Category’ 808, ‘Topic’ 810, ‘Key’ 812, ‘Scope’ 814, ‘Access’ 816, ‘Status’ 818, and ‘Execution’ 820, respectively, associated with the message node 800. The message node 800 may be further associated with the attribute vertex node 934 that stores an attribute value of the attribute ‘Message Type’ 848 of the message node 800. The attribute vertex node 934 may store attribute values for attributes ‘Message Type’ 848 and ‘Source type 854’ of the message node 800. For the sake of brevity, a single attribute vertex node 934 is shown to store attribute values for the attributes ‘Message Type’ 848 and ‘Source type 854’. In other embodiments, the attribute values for the attributes ‘Message Type’ 848 and ‘Source type 854’ may be stored at different attribute vertex nodes. In an instance, the attribute vertex node 934 may store the attribute value for the attribute ‘Message Type’ 848. That is to say that, the attribute vertex node 934 may store a message type (for example, a command message or an event message) of the message represented by the message node 800. In another instance, the attribute vertex node 934 may store the attribute value for the attribute ‘Source Type’ 854. That is to say that, the attribute vertex node 934 may store a message type of a message, processing of which has led to generation of the message represented by the message node 800.

In some embodiments, during stimulus processing of the stimulus 230, when the composition of the message node 800 is to be determined, the analytics module 240 is configured to track the attribute vertex nodes and/or the attribute edge nodes coupled with the message node 800 to determine the set of attribute vertex nodes that, collectively, store the composition of the message node 800. As mentioned above, an attribute vertex node that stores a value shared attribute may be associated with multiple message nodes. Therefore, based on an attribute value of an attribute, one or more messages that are associated with the value of the attribute may be identified. For example, a query may include a publisher ID that may be stored at an attribute vertex node. Therefore, tracking of the message edge nodes associated with the attribute vertex node may lead to identification of message nodes that have the publisher ID that is stored at the attribute vertex node. Hence, all the messages that are published by a publisher overlay node having the publisher ID may be identified with a single query and without having to search for each message node in the executable graph-based model 100.

In some embodiments, the storage management module 220 may be configured to process one or more attributes associated with the message node 800 and corresponding attribute values prior to storage thereof at corresponding attribute vertex nodes of the set of vertex nodes. The processing may be performed when a data structure associated with the one or more attributes may be incompatible with a native data structure/file system associated with the overlay system 202. In an example, the message node 800 may represent a message that is received by the overlay system 202 from another system for performing message management. The received message may be generated by a file system having a data structure which is incompatible with the overlay system 202. In such an example, the storage management module 220 may process attributes associated with the message node 800 prior to its storage at the set of attribute vertex nodes.

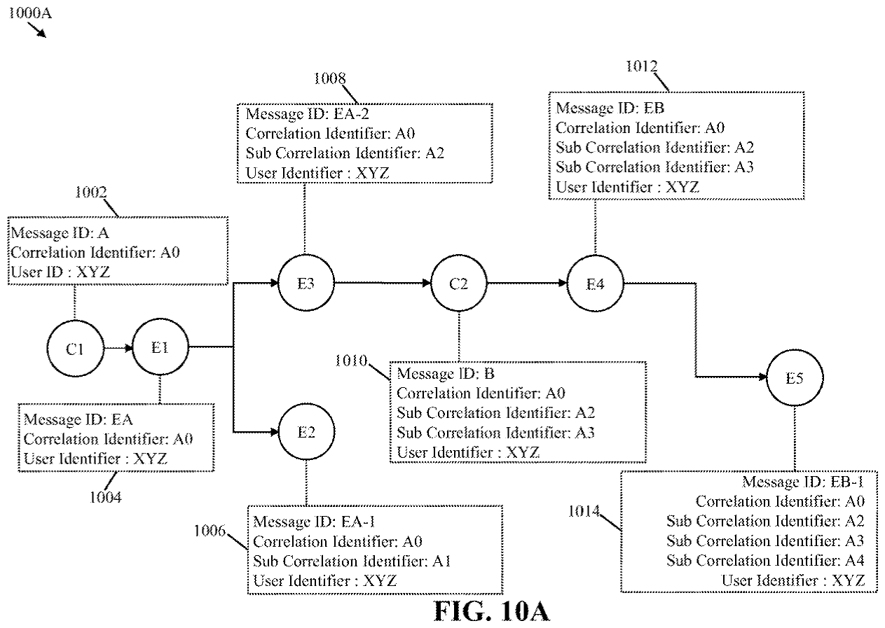

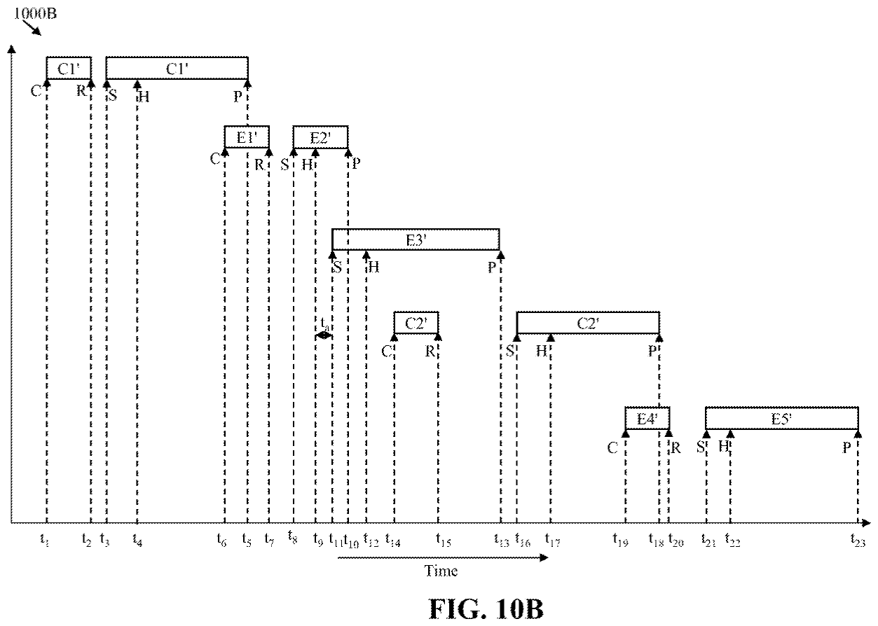

As mentioned above, the executable graph-based model 100 may include a plurality of message nodes (for example, the message nodes 602f, 604e, 800) that represent a plurality of messages associated with the overlay system 202. One or more messages of the plurality of messages may be generated within the overlay system 202 or may be received by the overlay system 202 from an external system associated therewith. The plurality of messages may include messages that may be correlated with each other. Such correlation of messages is described in conjunction with FIG. 10A.

FIG. 10A is a block diagram 1000A that illustrates a compact view of a set of correlated message nodes of the executable graph-based model 100, in accordance with an embodiment of the present disclosure. Referring to FIG. 10A, the set of correlated messages nodes (for example, command nodes C1 and C2 and event nodes E1, E2, E3, E4, and E5) of the executable graph-based model 100 is illustrated. The set of correlated message nodes represents a set of correlated messages associated with the overlay system 202. The set of correlated messages may include a first command message that may be correlated with one or more other messages. The first command message may be an initial message of the set of correlated messages. The initial message may be a parent/root message to a first set of child messages that includes a first event message. The first set of child messages may be generated based on processing of the parent/root message. That is to say, the first event message may be generated based on the processing of the first command message. Further, a second set of child messages including second and third event messages may be generated based on processing of at least one message (for example, the first event message) of the first set of child messages.

A parent message node (for example, a first command node C1) that represents the parent message (for example, the first command message), and a first set of child message nodes (for example, a first event node E1) that represents the first set of child messages (for example, the first event message) are instantiated by the message management module 214.

The parent message node and the first set of child message nodes are associated with a root correlation ID (for example, root correlation ID ‘A0’) that is indicative of a transactional operation associated with the root message for executing a first transaction in the executable graph-based model 100 in response to the one or more stimuli received before the stimulus 230. The association of the root correlation ID (for example, root correlation ID ‘A0’) with the parent message node (for example, the command node C1) and the first set of child message nodes (for example, the first event node E1) indicates a causal association between the root message and the first set of child messages. The root correlation ID is further associated with each message node of the second set of child message nodes (for example, the second and third event nodes E2 and E3) that indicates existence of a causal association between the parent message node, the first set of child message nodes, and the second set of child message nodes. That is to say that each message of the second set of child messages is associated with the first transaction.

The second set of child messages (for example, the second and third event messages) are instantiated by the message management module 214 by way of the second and third event nodes E2 and E3.

Further, each message of the second set of child message nodes is associated with a corresponding first sub-correlation ID (for example, the second event node E2 is associated with a first sub-correlation ID ‘A1’ and the third event node is associated with a unique value of the first sub-correlation ID, for example a first sub-correlation ID ‘A2’). That is to say that, the first sub-correlation ID associated with each child message node of the second set of child message nodes is unique and is indicative of a distinct transactional operation associated with a corresponding child message of the second set of child messages. The transactional operation is executed for performing a corresponding transaction in the executable graph-based model 100.

For the sake ongoing description, the parent/root message is assumed to be a command message, the first set of child messages is assumed to include the first event message, and the second set of child messages is assumed to include the second and third event messages. The root message is depicted by way of the command node C1, the first event message is depicted by way of the first event node E1, and the second set of child messages is depicted by way of the second and third event nodes E2 and E3.

As shown in FIG. 10A, the second event message terminates after its processing. That is to say that processing of the second event message does not lead to generation of any child message. The third event message, based on its processing, leads to generation of a second command message that is represented by the second command node C2. Further, the second command message when executed leads to generation of a fourth event message that is represented by the fourth event node E4. Moreover, the fourth event message is subscribed by a handler overlay node of the executable graph-based model 100. Therefore, a clone message of the fourth event message is created. The clone message of the fourth event message is represented by the fifth event node E5.

The first and second command nodes C1 and C2 and the first through fifth event nodes E1, E2, E3, E4, and E5 are generated based on the stimulus that is different from the stimulus 230. Such stimulus is indicative of communication and processing of the parent/root message and various sets of child messages. Also, such stimulus is received prior to the stimulus 230, where the stimulus 230 is received for analysis of the set of correlated messages.

Since, the first command node C1 shown herein is a parent message node to the first event node E1, the first command node C1 has a causal association with the first event node E1. The first command node C1 is coupled with the first event node E1 by way of a corresponding message edge node that includes roles for each of the first command node C1 and the first event node E1. Such roles are indicative of the causal association between the first command node C1 and the first event node E1 and further indicates a manner in which the first command node C1 and the first event node E1 are associated with each other. In an embodiment, identification of one or more correlated messages may be performed based on tracking of message edge nodes associated with a message node of a message that is to be analyzed.

As shown within a dotted box 1002, the command node C1 is associated with a message ID ‘A’, a root correlation ID ‘A0’, and a user ID ‘XYZ’. The message ID ‘A’ is unique and is used to identify the command node C1. The root correlation ID ‘A0’ is indicative of the first transaction associated with the first command node C1 that is to be executed in the executable graph-based model 100. The processing of the first command message represented by the first command node C1 leads to generation of the first event message that is represented by the first event node E1. As shown within another dotted box 1004, the first event node E1 is associated with a message ID ‘EA’, the root correlation ID ‘A0’, and the user ID ‘XYZ’. The message ID ‘EA’ is unique and is used to identify the first event node E1. The association of the root correlation ID ‘A0’ with the first event node E1 is indicative of a causal association between the first command node C1 and the first event node E1. The term ‘causal association’ is indicative of generation of one message being caused by processing of another message. That is to say that, the first event message represented by the first event node E1 is generated based on processing of the first command message represented by the first command node C1. Hence, the first command node C1 is the parent message node to the first event node E1. The association of the root correlation ID ‘A0’ with the first event node E1 is further indicative of the first event message being generated as a part of execution of the first transaction associated with the first command node C1.

Based on processing of the first event message, the second and third event messages represented by the second and third event nodes E2 and E3, respectively, are generated. The second and third event messages are generated because the first event message is subscribed by two handler overlay nodes of the executable graph-based model 100. Therefore, the second and third event messages represented by the second and third event nodes E2 and E3, respectively, are clone event messages of the first event message represented by the first event node E1. A static dataset of compositions of the second and third event nodes E2 and E3 is common and a dynamic dataset of the compositions of the second and third event nodes E2 and E3 are exclusive. The static dataset of the compositions of the second and third event nodes E2 and E3 may include attributes such as, source ID, category, topic, publisher ID, or the like. The dynamic dataset of the compositions of the second and third event nodes E2 and E3 may include attributes such as subscribed on, processed on, raised on, published on, created on, handled on, or the like.

As shown within a dotted box 1006, the second event node E2 is associated with a message ID ‘EA-1’, the root correlation ID ‘A0’, the first sub-correlation ID ‘A1’, and the user ID ‘XYZ’. The association of the root correlation ID with the second event node E2 indicates that the corresponding event message (namely, the second event message) is generated as a part of the execution of the first transaction and that the second event node E2 is a child message node to the first command node C1 and the first event node E1. The association of the first sub-correlation ID ‘A1’ with the second event node E2 is indicative of a second transaction being initiated and executed for processing of the second event message. The first sub-correlation ID ‘A1’ is different from the root correlation ID ‘A0’ which indicates that the second transaction is different from the first transaction. Further, the association of both the root correlation ID ‘A0’ and the first sub-correlation ID ‘A1’ is indicative of the second transaction being a sub-transaction to the first transaction. The second transaction terminates after completion processing of the second event message represented by the second event node E2.

As shown within another dotted box 1008, the third event node E3 is associated with a message ID ‘EA-2’, the root correlation ID ‘A0’, the first sub-correlation ID ‘A2’, and the user Id ‘XYZ’. The association of the root correlation ID ‘A0’ with the third event node E3 indicates that the first command node C1 and the first event node E1 are parent message nodes to the third event node E3. The association of the root correlation ID ‘A0’ with the third event node E3 further indicates that the third event message is generated as a part of the execution of the first transaction. A value ‘A2’ of the first sub-correlation ID associated with the third event node ‘A3’ is different from the value ‘A1’ of the first sub-correlation ID associated with the second event node E2. Such difference in values of the first sub-correlation ID associated with the second and third event nodes E2 and E3 is indicative of a third transaction (different from the second transaction) being executed in response to execution of the third event message represented by the third event node E3. The first sub-correlation ID ‘A2’ is different from the root correlation ID ‘A0’ which indicates that the third transaction is different from the first transaction. Further, the association of both the root correlation ID ‘A0’ and the first sub-correlation ID ‘A2’ is indicative of the third transaction being a sub-transaction to the first transaction.

As shown with a dotted box 1010, the second command node C2 is associated with a message ID ‘B’, the root correlation ID ‘A0’, the first sub-correlation ID ‘A2’, a second sub-correlation ID ‘A3’, and the user Id ‘XYZ’. The association of the root correlation ID ‘A0’ with the second command node C2 indicates that the first command node C1 and the first event node E1 are parent message nodes to the second command node C2. The association of the root correlation ID ‘A0’ with the second command node C2 further indicates that the second command message is generated as a part of the execution of the first transaction. The association of the first sub-correlation ID ‘A2’ with the second command node C2 indicates that the second command message represented by the second command node C2 is generated as a part of execution of the third transaction associated with the third event message represented by the third event node E3. The second sub-correlation ID ‘A3’ associated with the second command node C2 is different from the root correlation ID ‘A0’ and the first sub-correlation ID ‘A2’ which indicates that it is associated with a fourth transaction that is different from the first and third transactions. Further, the association of the root correlation ID ‘A0’, the first sub-correlation ID ‘A2’, and the second sub-correlation ID ‘A3’ is indicative of the fourth transaction being a sub-transaction to the third transaction which in turn is a sub-transaction of the first transaction.

As shown with a dotted box 1012, the fourth event node E4 is associated with a message ID ‘EB’, the root correlation ID ‘A0’, the first sub-correlation ID ‘A2’, the second sub-correlation ID ‘A3’, and the user Id ‘XYZ’. The association of the root correlation ID ‘A0’ with the fourth event node E4 indicates that the first command node C1 and the first event node E1 are parent message nodes to the fourth event node E4. The association of the root correlation ID ‘A0’ with the fourth event node E4 further indicates that the fourth event message is generated as a part of the execution of the first transaction. The association of the first sub-correlation ID ‘A2’ with the fourth event node E4 indicates that the fourth event message represented by the fourth event node E4 is generated as a part of execution of the third transaction associated with the third event message represented by the third event node E3. The second sub-correlation ID ‘A3’ associated with the fourth event node E4 is different from the root correlation ID ‘A0’ and the first sub-correlation ID ‘A2’ which indicates that it is associated with the fourth transaction.

As shown within another dotted box 1014, the fifth event node E5 is associated with a message ID ‘EB-1’, the root correlation ID ‘A0’, the first sub-correlation ID ‘A2’, the second sub-correlation ID ‘A3’, a third sub-correlation ID ‘A4’, and the user ID ‘XYZ’. The association of the root correlation ID ‘A0’ with the fifth event node E5 indicates that the first command node C1 and the first event node E1 are parent message nodes to the fifth event node E5. The association of the root correlation ID ‘A0’ with the fifth event node E5 further indicates that the fifth event message is generated as a part of the execution of the first transaction. The association of the first sub-correlation ID ‘A2’ with the fifth event node E5 indicates that the fifth event message is generated as a part of execution of the third transaction associated with the third event message represented by the third event node E3. The association of the second sub-correlation ID ‘A3’ with the fifth event node E5 indicates that the fifth event message is generated as a part of execution of the fourth transaction associated with the second command message represented by the second command node C2. Further, the third sub-correlation ID ‘A4’ associated with the fifth event node E5 is different from the root correlation ID ‘A0’ and the first and second sub-correlation IDs ‘A2’ and ‘A3’, which indicates that it is associated with a fifth transaction that is different from the first, third, and fourth transactions and is a sub-transaction of the first, third, and fourth transactions. Also, the fifth event node E5 is generated based on subscription of the fourth event message represented by the fourth event node E4. Hence, the fifth event node E5 represents a clone message of the fourth event message represented by the fourth event node E4.

Notably, the association of two or more message nodes with a common correlation ID (for example, the root correlation ID ‘A0’) is indicative of a causal association therebetween. Further, an association of a message node with a new correlation ID (for example, association of the first sub-correlation ID ‘A1’ with the second event node E2) is indicative of a new transaction being initiated based on processing of a message represented by the message node. Moreover, the association of the user ID ‘XYZ’ with the first and second command nodes C1 and C2 and the first through fifth event nodes E1, E2, E3, E4, and E5 indicates association thereof with the same user that has the user ID ‘XYZ’.

In an embodiment, the stimulus 230 may be indicative of a time-series analytics to be performed for the first command message represented by the first command node C1. In such an embodiment, the analytics module 240 may be configured to track the second command node C2 and the first through fifth event nodes E1-E5 that are correlated with the first command node C1. Such tracking may be performed based on the correlation IDs, for example, the root correlation ID ‘A0’, the first sub-correlation IDs ‘A1’ and ‘A2’, the second sub-correlation ID ‘A3’, and the third sub-correlation ID ‘A4’ associated with message nodes in the executable graph-based model 100. The analytics module 240 may be configured to execute the operation associated with the stimulus 230 based on the first and second command nodes C1 and C2 and the first through fifth event nodes E1, E2, E3, E4, and E5.

In some embodiments, correlation among two or more message nodes may be further identified based on message edge nodes and attribute values of attributes such as source ID, publisher ID, topic, category, user ID, a combination thereof, or any other element of compositions of the two or more message nodes. Such correlation may be established based on identical attribute values of such attributes in the compositions of the two or more messages.

Although not shown, as mentioned above, two or more message nodes may be associated by way of corresponding message edge nodes. For example, the first command node C1 and the first event node E1 may be coupled together by way of a message edge node that may be a command to event header message edge node. In some embodiments, the command to event header message edge node may be associated with one or more time-series analytics overlay nodes. Such a time-series analytics overlay node may include a second set of time series computation functions, where each time-series computation function includes a mathematical computation that may be executed on dynamic and static datasets included in compositions of both the first command node C1 and the first event node E1. Parameter values of one or more parameters included in such mathematical computations may be derived from the dynamic datasets associated with the first command node C1 and the first event node E1. That is to say that, the parameter values of the one or more parameters included in such mathematical computations may be derived based on attribute values (e.g., timestamps) of attributes included in the dynamic datasets of the first command node C1 and the first event node E1.

It will be apparent to a person skilled in the art that the executable graph-based model 100 may include a plurality of message nodes that may include multiple sets of correlated message nodes as well as one or more message nodes that may not be correlated with any other message node. Further, each message has a corresponding lifecycle that encompasses each operation associated therewith. During its lifecycle, the message may go through various operations and may achieve multiple milestones. The lifecycle of each message may include milestones such as the creation event followed by the raise event that is followed by the subscription event that is followed by the handle event that is in turn followed by the process event. Such lifecycle of messages and the milestones achieved by the messages is shown in FIG. 10B.

FIG. 10B is a time-sequence diagram 1000B that illustrates a sequence in which the milestones associated with the set of correlated messages of FIG. 10A are achieved, in accordance with an embodiment of the present disclosure. Referring to FIG. 10B, a horizontal line ‘Time’ shows time-instances at which one or more milestones associated with each message of the set of correlated messages gets achieved (e.g., completed). It will be apparent to a person skilled in the art that rectangular boxes shown herein collectively represent the set of correlated messages described in conjunction with FIG. 10A. Hereinafter, the first command message and the second command message are referred to as a first command message C1′ and a second command message C2′. Hereinafter, the first through fifth event messages are referred to as a first event message E1′, a second event message E2′, a third event message E3′, a fourth event message E4′, and a fifth event message E5′, respectively.

At time instance t1, the milestone creation event (denoted by C) is achieved by the first command message C1′. The milestone creation event refers to creation of the first command message C1′ by a publisher overlay node of the executable graph-based model 100. The time instance t1 is determined by the message management module 214 as a timestamp associated with the milestone creation event. Also, the timestamp associated with the milestone creation event is determined as an attribute value for attribute ‘Created On’ associated with the first command node C1.

At time instance t2, another milestone raise event (denoted by R) is achieved by the first command message C1′. The milestone raise event refers to placing/loading of the first command message C1′ on the message bus (for example, the data bus shown in FIG. 13) for being subscribed by one or more handler overlay nodes of the executable graph-based model 100. The time instance t2 is determined by the message management module 214 as a timestamp associated with the milestone raise event. Also, the timestamp associated with the milestone raise event is determined as an attribute value for attribute ‘Raised On’ associated with the first command node C1. As mentioned in conjunction with FIG. 10A, the first command message C1′ is processed during the first transaction. The creation event and the raise event of the first command message C1′ takes place within a first processing thread of the first transaction. Once the first command message C1′ achieves the milestone raise event, a second processing thread is initiated for further execution of the first command message C1′. That is to say that, the subscribe event, the handle event, and the process event of the first command message C1′ occurs within the second processing thread of the first transaction.

At time instance t3, another milestone subscription event (denoted by S) is achieved by the first command message C1′. The milestone subscription event refers to subscription of the first command message C1′ by a handler overlay node of the executable graph-based model 100. Notably, a command message (for example, the first command message C1′) is subscribed by a single handler overlay node. The time instance t3 is determined by the message management module 214 as a timestamp associated with the milestone subscription event. Also, the timestamp associated with the milestone subscription event is determined as an attribute value for attribute ‘Subscribed On’ associated with the first command node C1. Notably, a time-interval between the time instances t2 and t3 indicates a time duration for which the first command message C1′ is waiting on the message bus to be subscribed. In some embodiments, such time duration may be predefined while in other embodiments, such time duration may be determined based on availability of executable nodes, overlay nodes, or other resources required for processing of the first command message C1′.

At time instance t₄, another milestone handle event (denoted by H) is achieved by the first command message C1′. The milestone handle event refers to reception of the first command message C1′ by the handler overlay node. Notably, the first command message C1′ is handled by a single handler overlay node. The time instance t₄ is determined by the message management module 214 as a timestamp associated with the milestone handled event. Also, the timestamp associated with the milestone handled event is determined as an attribute value for attribute ‘Handled On’ associated with the first command node C1. Further, the first command message C1′ may be, immediately or after some time, queued for processing by an executable node associated with the handler overlay node. Such queuing of the first command message C1′ is performed as only a single transaction may be performed by corresponding handler overlay node or executable overlay node at a time.

At time instance t₅, another milestone process event (denoted by P) is achieved by the first command message C1′. The milestone process event refers to completion of execution/processing of the first command message C1′ by the handler overlay node. The time instance t₅ is determined by the message management module 214 as a timestamp associated with the milestone process event. Also, the timestamp associated with the milestone process event is determined as an attribute value for attribute ‘Processed On’ associated with the first command node C1.

Notably, each command message (e.g., the first command message C1′) results in creation of an event message in response to execution of a corresponding operation. Thus, creation of the event message is operationally connected to the processing of the command message. That is to say that, the event message is created by a transaction associated with the processing of the command message. Hence, the event message is created after completion of the handle event and before completion of the process event of the command message. That is to say that, the event message is created after handling and before processing of the command message. In other words, the first event message E1′ is created between time instances t₄ and t₅.

At time instance t₆, the first event message E1′ gets created. The time instance t₆ occurs prior to the time instance t₅ and after the time instance t₄. At time instance t₇, the first event message E1′ gets raised. The time instance t₇ occurs after the time instance t₆. Further, communication of the first event message E1′ is performed in an asynchronous manner. That is to say that, the first event message E1′ is communicated to its destination node via one or more intermediate nodes that form a communication route/channel for its communication. This is reflected as the first event message E1′ gets raised after the processing of the first command message C1′ gets completed at the time instance t₅. Such occurrence of the milestone raise event associated with the first event message E1′ indicates that the first event message E1′ gets raised by a transaction that is different from the transaction that leads to the creation of the first command message C1′. Such occurrence of the milestone raise event associated with the first event message E1′ may also be due to less number of active transactions, waiting time in queue at corresponding publisher node, or the like.

Subsequently, the first event message E1′ gets subscribed by one or more handler overlay nodes. As mentioned in conjunction with FIG. 10A, the first event message E1′ gets subscribed by two handler overlay nodes. Hence, two clone messages that are second and third event messages E2′ and E3′ are created. Hence, the first event message E1′ becomes a header message and the second and third event messages E2′ and E3′ become handled event messages. An event header message is represented in the executable graph-based model 100 by way of a header message node, whereas a handled event message is represented in the executable graph-based model 100 by way of a handled event node. Notably, the creation of the second and third event messages E2′ and E3′ happens only after the first event message E1′ gets raised. As mentioned throughout the description, for each subscriber node (e.g., a handler overlay node) of an event message, a corresponding clone of the event message gets created. Such clones are subsequently, published (raised) on a subscriber channel that corresponds to the subscriber node.

At time instance t₈, the first event message E1′ gets subscribed by a handler overlay node. That is to say that, the second event messages E2′ gets subscribed by the handler overlay node at the time instance t₈. Subsequently, at time instance t₉, the second event message E2′ gets handled. At time instance t₁₀, the second event message E2′ gets processed and terminated. That is to say that, the second transaction associated with the second event message E2′ gets terminated.

At time instance t₁₁, the first event message E1′ gets subscribed by another handler overlay node. That is to say that, the third event messages E3′ gets subscribed by another handler overlay node at time instance t₁₁. The time instance t₁₁ occurs after the time instance t₈, which indicates that the second event message E2′ and the third event message E3′ are subscribed as part of two different transactions. A time-interval tₐ between the handle event and the subscribe event of the first event message E1′ indicates subscription of the first event message E1′ based on availability as well as allocation of resources. That is to say that, a gap of the time-interval tₐ between the handle event and the subscribe event of the first event message E1′ indicates that the first event message E1′ waits to get subscribed either due to unavailability of resources or due to resources being not allocated. Such a wait-time ensures that the asynchronous communication provides maximum resiliency and throughput while corresponding handler overlay node only takes up tasks that are within its processing capability. At time instance t12, the third event messages E3′ gets handled. At time instance t₁₃, the third event message E3′ gets processed.

Further, based on handling of the third event message E3′ at the time instance t₁₂, the second command message C2′ gets created at time instance t₁₄. creation of the second command message C2′ based on the handling of the third event message E3′ is performed in a manner that is similar to creation of the first event message E1′ based on the handling of the first command message C1′.

Further, raising (namely, publishing) of the second command message C2′ is performed in a synchronous manner. That is to say that, the second command message C2′ is published directly from its publisher overlay node to a subscriber channel of its destination (e.g., a handler overlay node) without involving any intermediate node. This is reflected in FIG. 10B as the second command message C2′ gets raised at time instance tis which is prior to a time instance t₁₃ when the third event message E3′ gets processed. Such occurrence of the milestone raise event associated with the second command message C2′ indicates creation thereof within the third transaction that is associated with the third event message E3′. Therefore, the milestone process event associated with the third event message E3′ may never occur prior to the milestone raise event associated with the second command message C2′. Further, the second command message C2′ gets subscribed, handled, and processed at time instances t₁₆, t₁₇, and tis, respectively.

Based on the handling of the second command message C2′, the fourth event message E4′ gets created. It will be apparent to person skilled in the art that the creation of the fourth event message E4′ based on the handling of the second command message C2′ is performed in a manner that is similar to the creation of the first event message E1′ based on the handling of the first command message C1′. As shown, the fourth event message E4′ is created and raised at time instances t19, and t20, respectively. Further, the fourth event message E4′ gets subscribed by a handler overlay node. Hence, a clone message, such as the fifth event message E5′ gets created. The fifth event message E5′ gets subscribed at time instance t₂₁. Subsequently, the fifth event message E5′ gets handled and processed at time instances t₂₂ and t₂₃, respectively.

It will be apparent to person skilled in the art that various timestamps associated with the second command message C2′ and the first through fifth event messages E1′, E2′, E3′, E4′, and E5′ are determined in a manner that is similar to the first command message C1′.

It will be apparent to a person skilled in the art that the milestones shown in FIG. 10B are exemplary and do not limit that scope of the disclosure. In other embodiments, each message may have additional or different milestones.

Moreover, in FIG. 10A, the set of correlated message nodes are illustrated in the compact form. That is to say that, compositions, overlays, attribute vertex nodes, attribute edge nodes, and message edge nodes associated therewith are not shown in FIG. 10A. While performing time-series analytics on any message node, compositions, overlays, attribute vertex nodes, attribute edge nodes, and message edge nodes associated therewith may be used by the analytics module 240. Therefore, it is important to understand an organization of the compositions, overlays, attribute vertex nodes, attribute edge nodes, and message edge nodes associated with the set of correlated messages in the executable graph-based model 100.

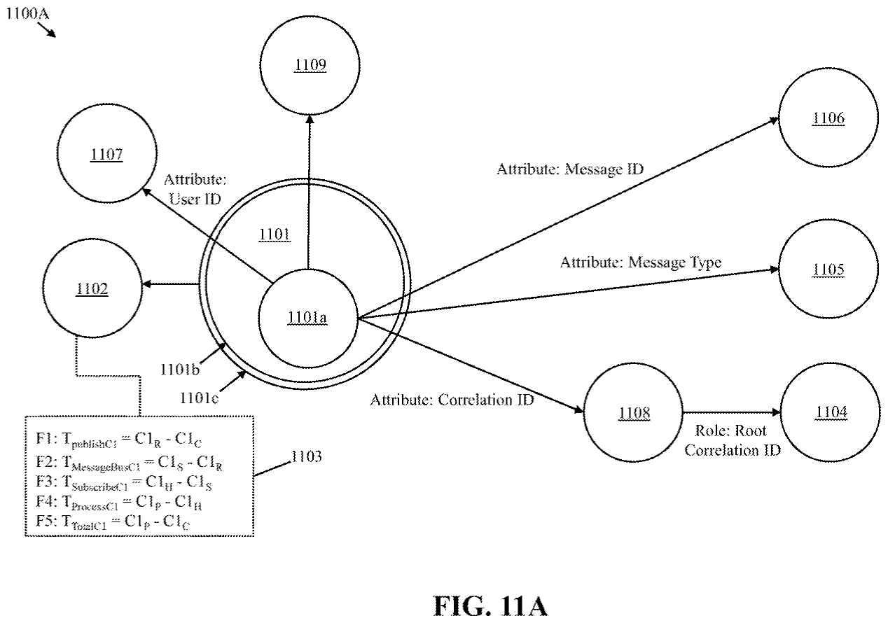

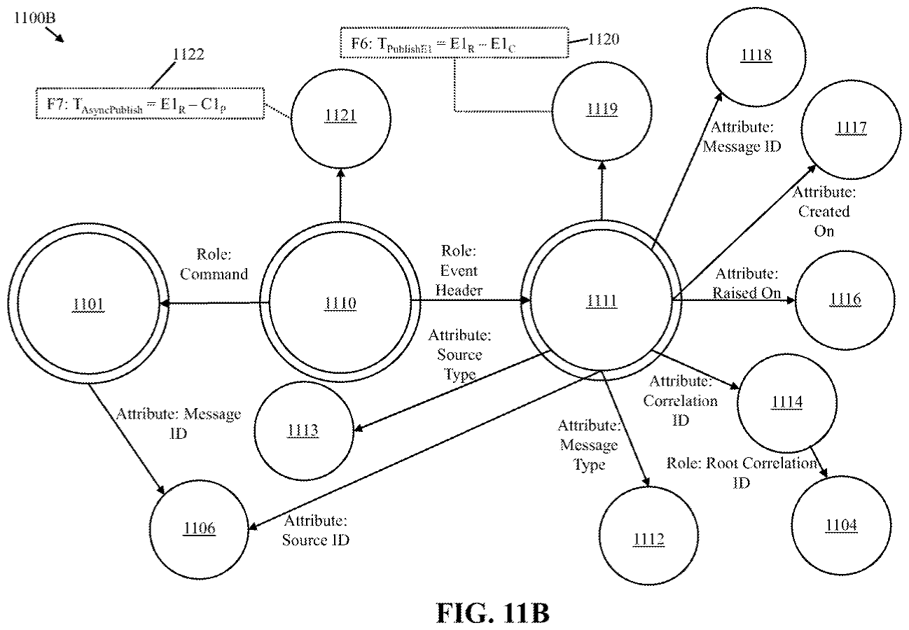

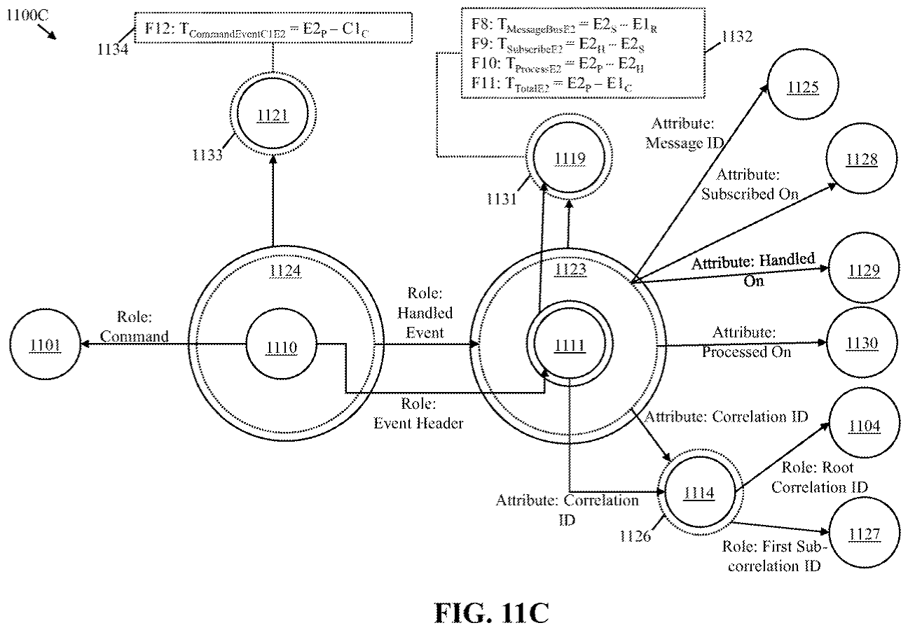

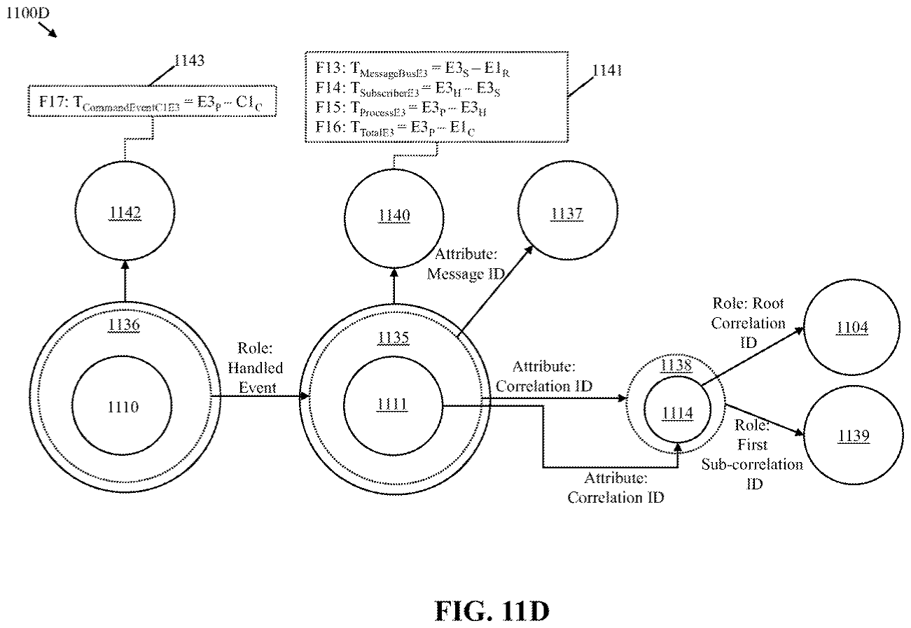

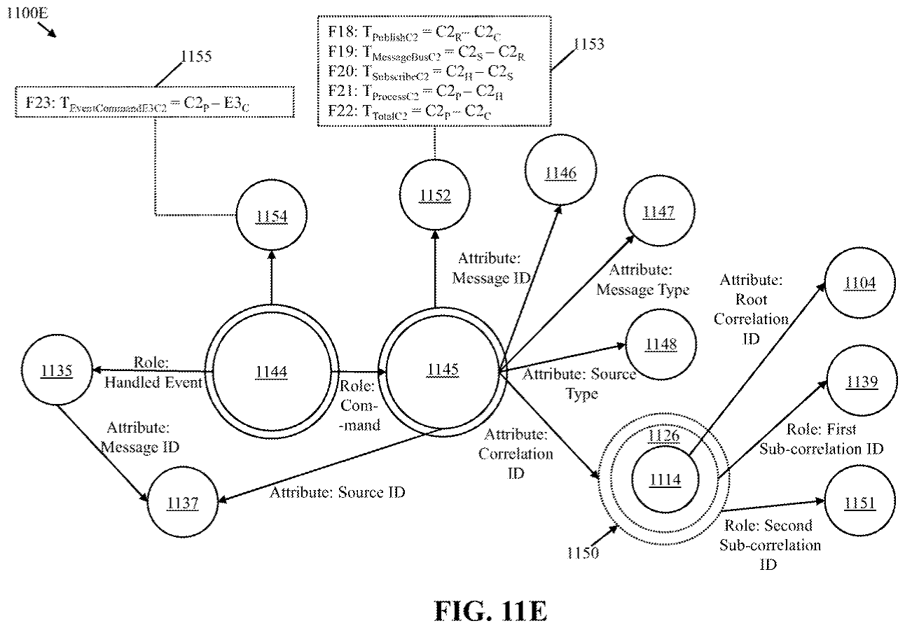

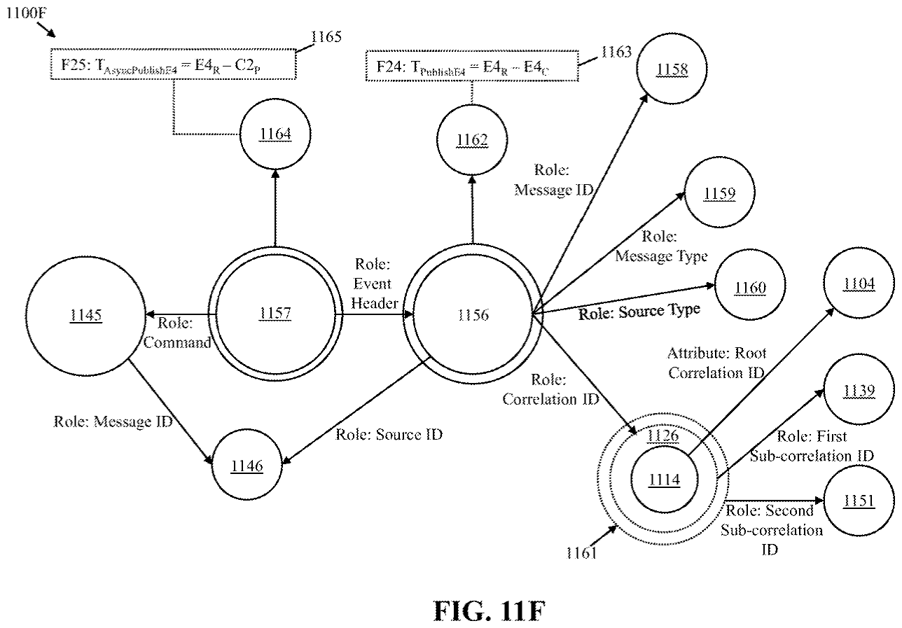

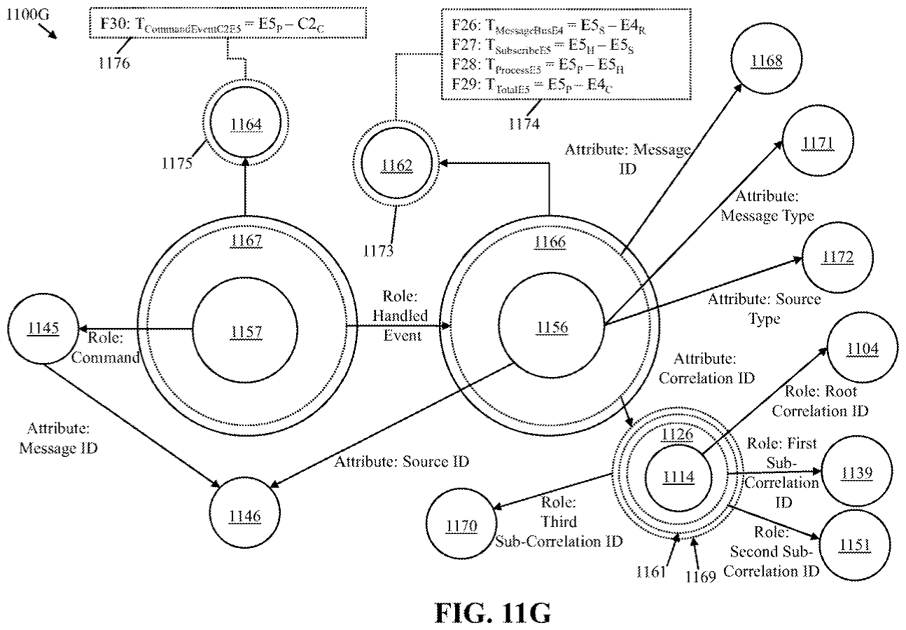

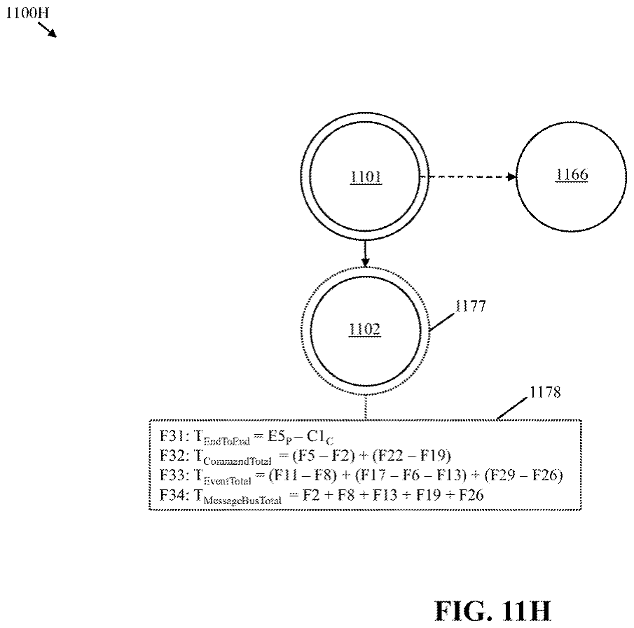

FIGS. 11A-11H are graphs 1100A-1100H that, collectively, illustrate an elaborated view of the set of correlated message nodes of FIG. 10A in the executable graph-based model 100, in accordance with an embodiment of the present disclosure.

Referring to FIG. 11A, the first command node C1 (hereinafter referred to as “a command node 1101”) of the set of correlated message nodes is an executable node and is shown to include a message base node 1101a represented as a circle that is enclosed within another circle 1101b that, collectively, represent the first command message C1′ of the set of correlated messages. Further, an outer circle 1101c encloses the command node 1101 which indicates that the command node 1101 is extended by way of an overlay, for example, a time-series analytics overlay node 1102. The time-series analytics overlay node 1102 includes a corresponding set of time-series computation functions. As shown within a box 1103, the set of time-series computation functions associated with the time-series analytics overlay node 1102 includes below mentioned time-series computation functions.

$${T}_{publishC 1} = C {1}_{R} - C {1}_{C} , \qquad F1$$

where T_{publishC1} is time required for publication of the first command message C1′, CIR is the time instance of raising of the first command message C1′, and Clc is the time instance of creation of the first command message C1′.

$${T}_{MessageBusC 1} = C {1}_{S} - C {1}_{R} , \qquad F2$$

where T_{MessageBusC1} is time spent by the first command message C1′ on the message bus and C1ₛ is the time instance of subscription of the first command message C1′.

$${T}_{SubscribeC 1} = C {1}_{H} - C {1}_{S} , \qquad F3$$

where T_{SubscribeC1} is time interval for which the first command message C1′ sat idle after being subscribed and C1_{H} is the time instance of handling of the first command message C1′.

$${T}_{ProcessC 1} = C {1}_{P} - C {1}_{H} , \qquad F4$$

where T_{ProcessC1} is time interval required for processing of the first command message C1′ and C1_{P} is the time instance of completion of processing of the first command message C1′.

$${T}_{TotalC 1} = C {1}_{P} - C {1}_{C} , \qquad F5$$

where T_{TotalC1} is time interval required for communication and processing of the first command message C1′.

Each time-series computation function includes a mathematical computation (e.g., the function F1 includes a mathematical operation ‘C1_{R}-C1_{C}’). Further, each time-series computation function includes one or more parameters, and parameter values for the one or more parameters are derived based on the dynamic dataset included in composition of a corresponding message node. For example, parameter values for parameters C1_{R} and C1_{C} may be derived based on the composition of the command node 1101. The dynamic dataset of the command node 1101 includes timestamps associated with the milestones associated with the first command message C1′. For example, the parameter values associated with the parameters C1_{R} and C1_{C} are derived based on timestamps associated with the milestones raised on and created on, respectively, of the first command message C1′.

The message base node 1101a of the command node 1101 is shown to be associated with a plurality of attribute vertex nodes 1104-1107. The attribute vertex node 1104 is associated with the command node 1101 via an attribute edge node 1108. The attribute edge node 1108 indicates that the attribute vertex nodes 1104 stores an attribute value for the attribute ‘Correlation ID’ of the command node 1101. The attribute edge node 1108 further includes a role ‘Root Correlation ID’ for the attribute vertex node 1104 and hence indicates that the attribute vertex node 1104 stores an attribute ‘Root Correlation ID’ of the command node 1101. The attribute vertex node 1104 stores an attribute value ‘A0’ for the attribute ‘Root Correlation ID’. The attribute vertex node 1105 associated with the command node 1101 stores an attribute value ‘Command’ for the attribute ‘Message Type’ associated with the command node 1101. The attribute value ‘Command’ stored at the attribute vertex node 1105 indicates a type (for example, a command message type) of the message that is represented by the command node 1101. The attribute vertex node 1106 is associated with the command node 1101 and stores an attribute value ‘A’ of the attribute ‘Message ID’ associated with the command node 1101. Further, the attribute vertex node 1107 is associated with the command node 1101 and stores an attribute value ‘XYZ’ of the attribute ‘User ID’ associated with the command node 1101. Moreover, the command node 1101 may be associated with one or more attribute edge nodes that further couple the command node 1101 to one or more attribute vertex nodes that store attribute values for the attributes ‘Created On’, ‘Raised On’, ‘Subscribed On’, ‘Handled On’, and ‘Processed On’. For example, the command node 1101 is associated with an attribute edge node 1109 that associates the command node 1101 to one or more attribute vertex nodes (not shown) that collectively store attribute value for the attribute ‘Created On’ associated with the command node 1101.

Referring now to FIG. 11B, the graph 1100B illustrates the command node 1101, a message edge node 1110, and the first event node E1 (hereinafter, referred to as “an event header node 1111”).

The event header node 1111 represents the first event message E1′ that is the source message for the second and third event messages E2′ and E3′. Moreover, the composition of the event header node 1111 includes a static dataset and a dynamic dataset. The static dataset includes the attribute values for the attributes ‘ID’, ‘Correlation ID’, ‘User ID’, ‘Name’, ‘Category’, ‘Topic’, ‘Key’, ‘Scope’, ‘Execution’, ‘allow retry’, ‘maximum retry allowed’, ‘source ID’, ‘source type’, ‘Created On’, ‘Raised On’, ‘publisher ID’, and ‘Action’. The static dataset further includes data associated with the first event message E1′. The attribute values of the attributes in the static dataset of the composition are non-variables and remain constant for each clone that is created for the event header node 1111. The dynamic dataset includes the attribute values for the attributes ‘Received On’, ‘Handled On’, ‘Processed On’, ‘subscriber ID’, ‘current retry count’, and ‘retry source ID’. The attribute values of the attributes in the dynamic dataset of the composition are dynamic, and hence, vary for each clone that is created for the event header node 1111.

As shown, the event header node 1111 is further associated with an attribute vertex node 1112 that stores an attribute value ‘Event’ of the attribute ‘Message type’ associated with the event header node 1111. The event header node 1111 is further associated with another attribute vertex node 1113 that stores an attribute value ‘Command’ of the attribute ‘Source type’ associated with the event header node 1111. The event header node 1111 is further associated with the attribute vertex node 1106 that stores the attribute value ‘A’ of the attribute ‘Source ID’ associated with the event header node 1111. The attribute ‘Source ID’ indicates that the attribute value ‘A’ stored at the attribute vertex node 1106 is the message ID of another message that has caused generation of the first event message E1′ represented by the event header node 1111. The attribute vertex node 1106 is further associated with another message node (e.g., the command node 1101) and stores attribute value ‘A’ for the attribute ‘Message ID’ associated therewith. This indicates that the other message (e.g., the first command message C1′ represented by the command node 1101) associated with the attribute vertex node 1106 is a source message of the first event message E1′ (represented by the event header node 1111). The event header node 1111 is further associated with the attribute vertex node 1104 that stores an attribute value ‘A0’ of the attribute ‘correlation ID’ for the event header node 1111. The event header node 1111 is associated with the attribute vertex node 1104 via an attribute edge node 1114 that includes a role ‘Root Correlation ID’ for the attribute vertex node 1104. Notably, an attribute value of the attribute ‘correlation ID’ associated with the first event message E1′ is same as the attribute value of the attribute ‘correlation ID’ associated with the first command message C1′. The event header node 1111 is further associated with attribute edge nodes 1116 and 1117. Each of the attribute edge nodes 1116 and 1117 couples the event header node 1111 to one or more attribute vertex nodes that store attribute values for the attributes ‘Raised On’ and ‘Created On’, respectively, associated with the event header node 1111. It will be apparent to a person skilled in the art that the event header node 1111 may be further coupled to one or more additional attribute vertex nodes that store attribute values of attributes ‘Handled On’, ‘Processed On’, and ‘Subscribed On’, ‘Published On’, or the like. The event header node 1111 is further associated with an attribute vertex node 1118 that stores an attribute value ‘EA’ of the attribute ‘Message ID’ for the event header node 1111.

Moreover, the event header node 1111 is extended by way of a time-series analytics overlay node 1119 that may execute corresponding set of time-series computation functions on the composition of the event header node 1111. As shown within a box 1120, the set of time-series computation functions associated with the time-series analytics overlay node 1119 includes the following function:

$${T}_{PublishE 1} = E {1}_{R} - E {1}_{C} , \qquad F6$$

where T_{PublishE1} is time required for publication of the first event message E1′ represented by the event header node 1111, E1_{R} is time instance of raising of the first event message E1′, and E1_{C} is time instance of creation of the first event message E1′.

The event header node 1111 is coupled to the command node 1101 via the message edge node 1110 that is a command-to-event header message edge node. The message edge node 1110 includes a role ‘Command’ for the command node 1101 and another role ‘Event Header’ for the event header node 1111. As shown, the message edge node 1110 is represented by way of two concentric circles that is indicative of an association with an overlay. The message edge node 1110 is associated with a time-series analytics overlay node 1121. The time-series analytics overlay node 1121 being an overlay of the message edge node 1110, may execute corresponding set of time-series computation functions on compositions of the command node 1101 and the event header node 1111 that are coupled via the message edge node 1110. As shown within a box 1122, the set of time-series computation functions associated with the time-series analytics overlay node 1121 includes the following function.

$${T}_{AsyncPublishE 1} = E {1}_{R} - C {1}_{P} , \qquad F7$$

where T_{AsyncPublishE1} is time required for publication of the first event message E1′ represented by the event header node 1111 when communicated in the asynchronous manner.

Referring now to FIG. 11C, the graph 1100C illustrates the command node 1101, the message edge node 1110, the event header node 1111, the second event node E2 (hereinafter, referred to as “a handled event node 1123”), and a message edge node 1124.

The handled event node 1123 is depicted by way of a dotted circle that encompasses the event header node 1111. Such representation of the handled event node 1123 indicates that the handled event node 1123 inherits the event header node 1111. Therefore, the composition and overlays (for example, the time-series analytics overlay node 1119) of the event header node 1111 are inherited by the handled event node 1123.

The handled event node 1123 is shown to be associated with an attribute vertex node 1125 that stores an attribute value ‘EA-1’ for the attribute ‘Message ID’ associated with the handled event node 1123. The handled event node 1123 is shown to be further associated, via an attribute edge node 1126, with an attribute vertex node 1127 that stores an attribute value ‘A1’ for the attribute ‘correlation ID’ associated with the handled event node 1123. The attribute edge node 1126 further includes a role ‘First Sub-correlation ID’ for the attribute vertex node 1127. The role ‘First Sub-correlation ID’ indicates that the attribute value ‘A1’ stored at the attribute vertex node 1127 is a ‘first sub-correlation ID’ for the handled event node 1123. The attribute edge node 1126 is shown by way of a dotted circle that encloses the attribute edge node 1114. Such representation indicates that the attribute edge node 1126 inherits the attribute edge node 1114. Therefore, the attribute edge node 1126 further inherits the association with the attribute vertex node 1104 that stores the attribute value ‘A0’. The attribute edge node 1126 inherits the role ‘Root Correlation ID’ for the attribute vertex node 1104. Therefore, the attribute edge node 1126 couples the handled event node 1123 with the attribute vertex nodes 1104 and 1127. The attribute vertex nodes 1104 and 1127 are coupled with the handled event node 1123 by way of the roles ‘Root Correlation ID’ and ‘First Sub-correlation ID’, respectively. Hence, the handled event node 1123 has the attribute values ‘A0’ and ‘A1’ for the attributes ‘Root Correlation ID’ and ‘First Sub-correlation ID’, respectively. The handled event node 1123 is further associated with attribute edge nodes 1128, 1129, and 1130 that couple the handled event node 1123 to one or more attribute vertex nodes that store attribute values for the attributes ‘Subscribed On’, ‘Handled On’, and ‘Processed On’, respectively, associated with the handled event node 1123.

The handled event node 1123 is represented by two concentric circles that indicates association thereof with at least one overlay node. The handled event node 1123 is extended by way of a time-series analytics overlay node 1131 that is represented by way of a dotted circle that encompasses the time-series analytics overlay node 1119. Such representation of the time-series analytics overlay node 1131 indicates that it inherits the time-series analytics overlay node 1119 of the event header node 1111. Therefore, the time-series analytics overlay node 1131 may execute corresponding set of time-series computation functions and the set of time-series computation functions associated with the time-series analytics overlay node 1119 on the compositions of the event header node 1111 and the handled event node 1123. The time-series analytics overlay nodes 1119 and 1131 may be managed by same overlay manager (for example, an overlay manager of the handled event node 1123). As shown within a box 1132, the set of time-series computation functions associated with the time-series analytics overlay node 1131 includes the below mentioned time-series computation functions.

$${T}_{MessageBusE 2} = E {2}_{S} - E {1}_{R} , \qquad F8$$

where T_{MessageBusE2} is time period for which the second event message E2′ was idle on the message bus before getting subscribed and E2_{S} is time instance of subscription of the second event message E2′.

$${T}_{SubscribeE 2} = E {2}_{H} - E {2}_{S} , \qquad F9$$

where T_{SubscribeE2} is time period for which the second event message E2′ was subscribed but not handled and E2_{H} is time instance of handling of the second event message E2′.

$${T}_{ProcessE 2} = E {2}_{P} - E {2}_{H} , \qquad F10$$

where T_{ProcessE2} is time period required for processing the second event message E2′ and E2_{P} is time instance of completion of processing of the second event message E2′.

$${T}_{TotalE 2} = E {2}_{P} - E {1}_{C} , \qquad F11$$

where T_{TotalE2} is total time period required for communication and processing of the second event message E2′ and E1_{C} is time instance of creation of the first event message E1′.

The handled event node 1123 is coupled to the command node 1101 by way of the message edge node 1124 that is a command-to-handled event message edge node. The message edge node 1124 is represented by a dotted circle that encompasses the message edge node 1110. This is indicative of the message edge node 1124 inheriting the message edge node 1110. The message edge node 1124 inherits the role ‘Command’ for the command node 1101 from the message edge node 1110. The message edge node 1124 further inherits every property and capability of the message edge node 1110. That is to say that, the message edge node 1124 inherits the time-series analytics overlay node 1121 and may access the command node 1101 and the event header node 1111. The message edge node 1124 includes a role ‘Handled Event’ for the handled event node 1123. Further, the message edge node 1124 is represented by two concentric circles indicating that the message edge node 1124 is extended by an overlay node, for example, a time-series analytics overlay node 1133. The time-series analytics overlay node 1133 may execute corresponding set of time-series computation functions on the compositions of the command node 1101 and the handled event node 1123. Further, the time-series analytics overlay node 1133 is shown by way of a dotted circle that encompasses the time-series analytics overlay node 1121 and such representation is indicative of the time-series analytics overlay node 1133 inheriting the time-series analytics overlay node 1121. Therefore, the time-series analytics overlay node 1133 may execute corresponding set of time-series computation functions as well as the set of time-series computation functions associated with the time-series analytics overlay node 1121 on the compositions of the command node 1101, the event header node 1111, and the handled event node 1123. As shown within a box 1134, the set of time-series computation functions associated with the time-series analytics overlay node 1133 includes the following time-series computation function.

$${T}_{CommandEventC 1 E 2} = E {2}_{P} - C {1}_{C} , \qquad F12$$

where T_{CommandEventC1E2} is time period required for creation of the first command message C1′ and processing of the second event message E2′ based on the first command message C1′.

Referring to FIG. 11D, the graph 1100D illustrates the message edge node 1110, the event header node 1111, the third event node E3 (hereinafter, referred to as “a handled event node 1135”), and a message edge node 1136.

The handled event node 1135 is depicted by way of a dotted circle that encompasses the event header node 1111. Such representation of the handled event node 1135 indicates that the handled event node 1135 inherits the event header node 1111. Therefore, the composition and overlays (for example, the time-series analytics overlay node 1119) of the event header node 1111 are inherited by the handled event node 1135.

The handled event node 1135 is shown to be associated with an attribute vertex node 1137 that stores an attribute value ‘EA-2’ for the attribute ‘Message ID’ associated with the handled event node 1135. The handled event node 1135 is shown to be further associated, via an attribute edge node 1138, with an attribute vertex node 1139 that stores an attribute value ‘A2’ for the attribute ‘correlation ID’ associated with the handled event node 1135. The attribute edge node 1138 further includes a role ‘First Sub-correlation ID’ for the attribute vertex node 1139. The role ‘First Sub-correlation ID’ indicates that the attribute value ‘A2’ stored at the attribute vertex node 1139 is a ‘first sub-correlation ID’ for the handled event node 1135. The attribute edge node 1138 is shown by way of a dotted circle that encloses the attribute edge node 1114. Such representation indicates that the attribute edge node 1138 inherits the attribute edge node 1114. Therefore, the attribute edge node 1138 further inherits the association with the attribute vertex node 1104 that stores the attribute value ‘A0’. The attribute edge node 1138 inherits the role ‘Root Correlation ID’ for the attribute vertex node 1104. Therefore, the attribute edge node 1138 couples the handled event node 1135 with the attribute vertex nodes 1104 and 1139. The attribute vertex nodes 1104 and 1139 are coupled with the handled event node 1135 by way of the roles ‘Root Correlation ID’ and ‘First Sub-correlation ID’, respectively. Hence, the handled event node 1135 has the attribute values ‘A0’ and ‘A2’ for the attributes ‘Root Correlation ID’ and ‘First Sub-correlation ID’, respectively.

The handled event node 1135 is represented by two concentric circles that indicates association thereof with at least one overlay node. The handled event node 1135 is extended by way of a time-series analytics overlay node 1140. Therefore, the time-series analytics overlay node 1140 may execute corresponding set of time-series computation functions on the compositions of the event header node 1111 and the handled event node 1135. As shown within a box 1141, the set of time-series computation functions associated with the time-series analytics overlay node 1140 includes the below mentioned time-series computation functions.

$${T}_{MessageBusE 3} = E {3}_{S} - E {1}_{R} , \qquad F13$$

where T_{MessageBusE3} is time period for which the third event message E3′ was idle on the message bus before getting subscribed and E3_{S} is time instance of subscription of the third event message E3′.

$${T}_{SubscribeE 3} = E {3}_{H} - E {3}_{S} , \qquad F14$$

where T_{SubscribeE3} is time period for which the third event message E3′ was subscribed but not handled and E3H is time instance of handling of the third event message E3′.

$${T}_{ProcessE 3} = E {3}_{P} - E {3}_{H} , \qquad F15$$

where T_{ProcessE3} is time period required for processing the third event message E3′ and E3_{P} is time instance of completion of processing of the third event message E3′.

$${T}_{TotalE 3} = E {3}_{P} - E {1}_{C} , \qquad F16$$

where T_{TotalE3} is total time period required for communication and processing of the third event message E3′.

The handled event node 1135 is coupled (not shown) to the command node 1101 by way of the message edge node 1136 that is a command-to-handled event message edge node. The message edge node 1136 is represented by a dotted circle that encompasses the message edge node 1110. This is indicative of the message edge node 1136 inheriting the message edge node 1110. The message edge node 1136 inherits the role ‘Command’ for the command node 1101 from the message edge node 1110. The message edge node 1136 includes a role ‘Handled Event’ for the handled event node 1135. The message edge node 1136 further inherits every property and capability of the message edge node 1110. That is to say that, the message edge node 1136 inherits the time-series analytics overlay 1121 and may access the command node 1101 and the event header node 1111. Further, the message edge node 1136 is represented by two concentric circles that indicates that the message edge node 1136 is extended by an overlay node, for example, a time-series analytics overlay node 1142. The time-series analytics overlay node 1142 may execute corresponding set of time-series computation functions on the compositions of the command node 1101, the handled event node 1135, and the event header node 1111 inherited by the handled event node 1135. As shown within a box 1143, the set of time-series computation functions associated with the time-series analytics overlay node 1142 includes the following function.

$${T}_{CommandEventC 1 E 3} = E {3}_{P} - C {1}_{C} , \qquad F17$$

where T_{CommandEventC1E3} is time period required for creation of the first command message C1′ and processing of the third event message E3′ based on the first transaction associated with the first command message C1′.

Referring now to FIG. 11E, the graph 1100E illustrates the handled event node 1135, a message edge node 1144 (event to command message edge), and the command node C2 (hereinafter, referred to as “a command node 1145”).

The command node 1145 is shown to be associated with an attribute vertex node 1146 that stores an attribute value ‘B’ for the attribute ‘Message ID’ associated with the command node 1145. The command node 1145 is shown to be further associated with another attribute vertex node 1147 that stores an attribute value ‘Command’ for the attribute ‘Message Type’ associated with the command node 1145. The command node 1145 is shown to be further associated with another attribute vertex node 1148 that stores an attribute value ‘Event’ for the attribute ‘Source Type’ associated with the command node 1145. The command node 1145 is shown to be further associated with the attribute vertex node 1137 the stores the attribute value ‘EA-2’ for the attribute ‘Source ID’ associated with the command node 1145. As mentioned earlier, the attribute vertex node 1137 stores the attribute value ‘EA-2’ for the attribute ‘ID’ associated with the handled event node 1135. Hence, the handled event node 1135 is a source node of the command node 1145.

The command node 1145 is shown to be further associated, via an attribute edge node 1150, with an attribute vertex node 1151 that stores an attribute value ‘A3’ for the attribute ‘correlation ID’ associated with the command node 1145. The attribute edge node 1150 further includes a role ‘Second Sub-correlation ID’ for the attribute vertex node 1151. The role ‘Second Sub-correlation ID’ indicates that the attribute value ‘A3’ stored at the attribute vertex node 1151 is a ‘second sub-correlation ID’ for the command node 1145. The attribute edge node 1150 is shown by way of a dotted circle that encloses the attribute edge node 1126. Such representation indicates that the attribute edge node 1150 inherits the attribute edge node 1126. Therefore, the attribute edge node 1150 further inherits the association with the attribute vertex node 1139 that stores the attribute value ‘A1’ and includes role first sub-correlation ID. The attribute edge node 1126 is shown by way of a dotted circle that encloses the attribute edge node 1114. Such representation indicates that the attribute edge node 1126 inherits the attribute edge node 1114. Therefore, the attribute edge node 1150 further inherits the association with the attribute vertex node 1104 that stores the attribute value ‘A0’. The attribute edge node 1150 inherits the role ‘Root Correlation ID’ for the attribute vertex node 1104. Therefore, the attribute edge node 1150 couples the command node 1145 with the attribute vertex nodes 1104, 1139, and 1151. The attribute vertex nodes 1104, 1139, and 1151 are coupled with the command node 1145 by way of the roles ‘Root Correlation ID’, ‘First Sub-correlation ID’, and ‘Second Sub-correlation ID’, respectively.

The command node 1145 is represented by two concentric circles that indicates association thereof with at least one overlay node. The command node 1145 is extended by way of a time-series analytics overlay node 1152. Therefore, the time-series analytics overlay node 1152 may execute corresponding set of time-series computation functions on the composition of the command node 1145. As shown within a box 1153, the set of time-series computation functions associated with the time-series analytics overlay node 1152 includes the below mentioned time-series computation functions.

$${T}_{PublishC 2} = C {2}_{R} - C {2}_{C} , \qquad F18$$

where T_{PublishC2} is time period required for publication of the second command message C2′ after it gets created, C2_{R} is time instance of raising of the second command message C2′, and C2_{C} is time instance of creation of the second command message C2′.

$${T}_{MessageBusC 2} = C {2}_{S} - C {2}_{R} , \qquad F19$$

where T_{MessageBusC2} is time period for which the second command message C2′ was idle on the message bus before getting subscribed and C2_{S} is time instance of subscription of the second command message C2′.

$${T}_{SubscribeC 3} = C {2}_{H} - C {2}_{S} , \qquad F20$$

where T_{SubscribeC2} is time period for which the second command message C2′ remained subscribed but not handled and C2_{H} the time instance when the second command message C2′ got handled.

$${T}_{ProcessC 2} = C {2}_{P} - C {2}_{H} , \qquad F21$$

where T_{ProcessC2} is time period required for processing of the second command message C2′ and C2_{P} is time instance of completion of processing of the second command message C2′.

$${T}_{TotalC 2} = C {2}_{P} - C {2}_{C} \qquad F22$$

where T_{TotalC2} is total time period required for communication and processing of the second command message C2′.

The command node 1145 is coupled to the handled event node 1135 by way of the message edge node 1144 that is a command-to-handled event message edge node. The message edge node 1144 is represented by two concentric circles that indicates that the message edge node 1144 is extended by an overlay node for example, a time-series analytics overlay node 1154. The time-series analytics overlay node 1154 may execute corresponding set of time-series computation functions on the compositions of the command node 1145 and the handled event node 1135. As shown within a box 1155, the set of time-series computation functions associated with the time-series analytics overlay node 1154 includes the following function:

$${T}_{EventCommandE 3 C 2} = C {2}_{P} - E {1}_{C} , \qquad F23$$

where T_{EventCommandE3C2 is} time taken for processing of the first event message E1′ and cascading second command message C2′.

Referring to FIG. 11F, the graph 1100F illustrates the command node 1145, the fourth event node E4 (hereinafter, referred to as “an event header node 1156”), and a message edge node 1157 (command to handled event message edge node).

As shown, the event header node 1156 is shown to be associated with an attribute vertex node 1158 that stores an attribute value ‘EB’ for the attribute ‘Message ID’ associated with the event header node 1156. The event header node 1156 is shown to be further associated with another attribute vertex node 1159 that stores an attribute value ‘Event’ for the attribute ‘Message Type’ associated with the event header node 1156. The event header node 1156 is shown to be further associated with another attribute vertex node 1160 that stores an attribute value ‘Command’ for the attribute ‘Source Type’ associated with the event header node 1156.

The event header node 1156 is shown to be associated with, via an attribute edge node 1161, with an attribute vertex node 1151 that stores an attribute value ‘A3’ for the attribute ‘correlation ID’ associated with the event header node 1156. The attribute edge node 1161 further includes a role ‘Second Sub-correlation ID’ for the attribute vertex node 1151. The role ‘Second Sub-correlation ID’ indicates that the attribute value ‘A3’ stored at the attribute vertex node 1139 is a ‘second sub-correlation ID’ for the command node 1145. The attribute edge node 1161 is shown by way of a dotted circle that encloses the attribute edge node 1126. Such representation indicates that the attribute edge node 1161 inherits the attribute edge node 1126. Therefore, the attribute edge node 1161 further inherits the association with the attribute vertex node 1139 that stores the attribute value ‘A1’ and includes role first sub-correlation ID. The attribute edge node 1126 is shown by way of a dotted circle that encloses the attribute edge node 1114. Such representation indicates that the attribute edge node 1126 inherits the attribute edge node 1114. Therefore, the attribute edge node 1161 further inherits the association with the attribute vertex node 1104 that stores the attribute value ‘A0’. The attribute edge node 1161 inherits the role ‘Root Correlation ID’ for the attribute vertex node 1104. Therefore, the attribute edge node 1161 couples the event header node 1156 with the attribute vertex nodes 1104, 1139, and 1151. The attribute vertex nodes 1104, 1139, and 1151 are coupled with the event header node 1156 by way of the roles ‘Root Correlation ID’, ‘First Sub-correlation ID’, and ‘Second Sub-correlation ID’, respectively.

Further, the event header node 1156 is represented by two concentric circles that indicates association thereof with at least one overlay node. The event header node 1156 is extended by way of a time-series analytics overlay node 1162. Therefore, the time-series analytics overlay node 1162 may execute corresponding set of time-series computation functions on the compositions of the event header node 1156. As shown within a box 1163, the set of time-series computation functions associated with the time-series analytics overlay node 1162 includes the below mentioned time-series computation functions.

$${T}_{PublishE 4} = E {4}_{R} - E {4}_{C} , \qquad F24$$

where T_{PublishE4} is time period required publishing of the fourth event message E4′ after creation thereof, E4_{R} is time instance of raising of the fourth event message E4′, and E4_{C} is time instance of creation of the fourth event message E4′.

The event header node 1156 is coupled to the command node 1145 via the message edge node 1157 that is represented by two concentric circles. Such representation of the message edge node 1157 indicates that the message edge node 1157 is extended by way of at least one overlay node. As shown, the message edge node 1157 is extended by way of a time-series analytics overlay node 1164 that may execute corresponding set of time-series computation functions on compositions of the command node 1145 and the event header node 1156. As shown within a box 1165, the set of time-series computation functions associated with the time-series analytics overlay node 1164 include the following time-series computation function.

$${T}_{AsyncPublishE 4} = E {4}_{R} - C {2}_{P} \qquad F25$$

where, T_{AsyncPublishE4} is time period required publishing of the fourth event message E4′ when communicated in the asynchronous manner.

Referring now to FIG. 11G, the graph 1100G illustrates the event header node 1156, the message edge node 1157, the handled event node E5 (hereinafter, referred to as “a handled event node 1166”), and a message edge node 1167 (command to handled event message edge node).

The handled event node 1166 is depicted by way of a dotted circle that encompasses the event header node 1156. Such representation of the handled event node 1166 indicates that the handled event node 1166 inherits the event header node 1156. Therefore, the composition and overlays (for example, the time-series analytics overlay node 1162) of the event header node 1156 are inherited by the handled event node 1166.

The handled event node 1166 is shown to be associated with an attribute vertex node 1168 that stores an attribute value ‘EB-1’ for the attribute ‘Message ID’ associated with the handled event node 1166. The handled event node 1166 is shown to be further associated, via an attribute edge node 1169, with an attribute vertex node 1170 that stores an attribute value ‘A4’ for the attribute ‘correlation ID’ associated with the handled event node 1166. The attribute edge node 1169 further includes a role ‘Third Sub-correlation ID’ for the attribute vertex node 1170. The role ‘Third Sub-correlation ID’ indicates that the attribute value ‘A4’ stored at the attribute vertex node 1170 is a ‘Third sub-correlation ID’ for the handled event node 1166. The attribute edge node 1169 is shown by way of a dotted circle that encloses the attribute edge node 1161. Such representation indicates that the attribute edge node 1169 inherits the attribute edge node 1161. Therefore, the attribute edge node 1169 further inherits the association with the attribute vertex node 1151 that stores the attribute value ‘A3’. The attribute edge node 1169 inherits the role ‘Second Sub-Correlation ID’ for the attribute vertex node 1151. The attribute edge node 1161 is shown by way of a dotted circle that encloses the attribute edge node 1126. Such representation indicates that the attribute edge node 1161 inherits the attribute edge node 1126. Therefore, the attribute edge node 1161 further inherits the association with the attribute vertex node 1139 that stores the attribute value ‘A1’ and includes role first sub-correlation ID. The attribute edge node 1126 is shown by way of a dotted circle that encloses the attribute edge node 1114. Such representation indicates that the attribute edge node 1126 inherits the attribute edge node 1114. Therefore, the attribute edge node 1161 further inherits the association with the attribute vertex node 1104 that stores the attribute value ‘A0’. The attribute edge node 1161 inherits the role ‘Root Correlation ID’ for the attribute vertex node 1104. Therefore, the attribute edge node 1161 couples the event header node 1156 with the attribute vertex nodes 1104, 1139, 1151, and 1170. The attribute vertex nodes 1104, 1139, 1151, and 1170 are coupled with the handled event node 1166 by way of the roles ‘Root Correlation ID’, ‘First Sub-correlation ID’, ‘Second Sub-correlation ID’, and ‘Third Sub-correlation ID’, respectively.

The handled event node 1166 is further associated with attribute vertex nodes 1171 and 1172 that store attribute values ‘Event’ and ‘Command’ for the attributes ‘Message Type’ and ‘Source Type’, respectively, associated with the handled event node 1166.

The handled event node 1166 is represented by two concentric circles that indicates association thereof with at least one overlay node. As shown, the handled event node 1166 is extended by way of a time-series analytics overlay node 1173 that is represented by way of a dotted circle that encompasses the time-series analytics overlay node 1162. Such representation of the time-series analytics overlay node 1173 indicates that it inherits the time-series analytics overlay node 1162 of the event header node 1156. Therefore, the time-series analytics overlay node 1173 may execute corresponding set of time-series computation functions and the set of time-series computation functions associated with the time-series analytics overlay node 1162 on the compositions of the event header node 1156 and the handled event node 1166. As shown within a box 1174, the set of time-series computation functions associated with the time-series analytics overlay node 1173 includes the below mentioned time-series computation functions.

$${T}_{M e s sage Bus E 4} = E {5}_{S} - E {4}_{R} , \qquad F 26$$

where T_{MessageBusE4} is time period for which the fourth event message E4′ was idle on the message bus before getting subscribed and E5_{S} is time instance of subscription of the fifth event message E5′.

$${T}_{S u b s c ribe E 5} = E {5}_{H} - E {5}_{S} , \qquad F27$$

where T_{SubscribeE5} is time period for which the fifth event message E5′ was subscribed but not handled and E5_{H} is time instance of handling of the fifth event message E5′.

$${T}_{P r o cess E 5} = E {5}_{P} - E {5}_{H} , \qquad F28$$

where T_{ProcessE5} is time period required for processing the fifth event message E5′ and E5_{P} is time instance of completion of processing of the fifth event message E5′.

$${T}_{Total E 5} = E {5}_{P} - E {4}_{C} , \qquad F29$$

where T_{TotalE5} is total time period required for communication and processing of the fifth event message E5′.

The handled event node 1166 is coupled to the command node 1145 by way of the message edge node 1167 that is a command-to-handled event message edge node. The message edge node 1167 is represented by a dotted circle that encompasses the message edge node 1157. This is indicative of the message edge node 1167 inheriting the message edge node 1157. The message edge node 1167 inherits the role ‘Command’ for the command node 1145 from the message edge node 1157. The message edge node 1167 further inherits every property and capability of the message edge node 1157. That is to say that, the message edge node 1167 inherits the time-series analytics overlay node 1164 and may access the command node 1145 and the event header node 1156. The message edge node 1167 includes a role ‘Handled Event’ for the handled event node 1166. Further, the message edge node 1167 is represented by two concentric circles that indicates that the message edge node 1167 is extended by an overlay node for example, a time-series analytics overlay node 1175. The time-series analytics overlay node 1175 may execute corresponding set of time-series computation functions on the compositions of the command node 1145 and the handled event node 1166. Further, the time-series analytics overlay node 1175 is shown by way of a dotted circle that encompasses the time-series analytics overlay node 1164 and such representation is indicative of the time-series analytics overlay node 1175 inheriting the time-series analytics overlay node 1164. Therefore, the time-series analytics overlay node 1175 may execute set of time-series computation functions associated therewith as well as the set of time-series computation functions associated with the time-series analytics overlay node 1164 on the compositions of the command node 1145, the event header node 1156, and the handled event node 1166. As shown within a box 1176, the set of time-series computation functions associated with the time-series analytics overlay node 1175 includes the below mentioned function:

$${T}_{Command Event C 2 E 5} = E {5}_{P} - C {2}_{C} , \qquad F30$$

where T_{CommandEventC2E5} is time period required for creation of the second command message C2′ and processing of the fifth event message E5′ based on the second command message C2′.

Referring now to FIG. 11H, the graph 1100H illustrates the command node 1101 and the handled event node 1166. Notably, the handled event node 1166 represents the fifth event message E5′ that is a part of the first transaction executed for processing of the first command message C1′. Therefore, the first transaction terminates only after termination of the fifth transaction associated with processing of the fifth event message E5′. The fifth transaction is a sub-transaction to the first transaction. Therefore, an analytics overlay node associated with the command node 1101 may only analyze complete life cycle of the execution of the first command message C1′ once the fifth transaction associated with processing of the fifth event message E5′ terminates. That is to say that, the time-series analytics on the executable graph-based model 100 is subject to a current state of the executable graph-based model 100. In other words, the time-series analytics on the executable graph-based model 100 is dependent on a current progress of execution of messages associated with the executable graph-based model 100.

As shown in FIG. 11H, the command node 1101 is associated with another time-series analytics overlay node 1177 that is shown as a dotted circle that indicates it is inheriting another node. The time-series analytics overlay node 1177 inherits the time-series analytics overlay node 1102. Since the first transaction associated with the first command message C1′ has completed its execution, the time-series analytics overlay node 1177 may execute corresponding set of time-series computation functions on each message node of the set of correlated message nodes (for example, the event header node 1111, the handled event nodes 1123 and 1135, the command node 1145, the event header node 1156, and the handled event node 1166). Further, the time-series analytics overlay node 1177 may also access one or more computational insights generated for each message node of the set of correlated message nodes. As shown within a box 1178, the time-series computation functions associated with the time-series analytics overlay node 1177 include the following time-series computation functions.

$${T}_{End To End} = E {5}_{P} - C {1}_{C} , \qquad F31$$

where T_{EndToEnd} is time period for completion of the lifecycle of the execution of the first command message C1′.

$${T}_{Command Total} = ( F 5 - F 2 ) + ( F 22 - F 19 ) , \qquad F32$$

where T_{CommandTotal} is total time period for which the command message C1′ and the command message correlated with the first command message C1′ have actively executed, the command message associated with the execution of the first command message C1′ is the command message C2′, (F5-F2) is time period for which the first command message C1′ has been active and being executed, and (F22-F19) is time period for which the second command message C2′ has been active and being executed.

$${T}_{Event Tota1} = ( F 11 - F 8 ) + ( F 17 - F 6 - F 13 ) + ( F 29 - F 26 ) , \qquad F33$$

where T_{EventTotal} is total time period for which event messages correlated with the first command message C1′ have actively executed, the event messages associated with the execution of the first command message C1′ are the event messages E1′, E3′, and E5′, (F11−F8) is time period for which the second event message E2′ has been active and being executed, (F17−F6−F13) is time period for which the third event message E3′ has been active and being executed and (F29−F26) is time period for which the fifth event message E5′ has been active and being executed.

$${T}_{M e s sage Bus Total} = F 2 + F 8 + F 13 + F 19 + F 26 , \qquad F34$$

where T_{MessageBusTotal} is total time period for which the first command message C1′ and the messages correlated with the first command message C1′ have been idle on the message bus, the messages correlated with the first command message C1′ are the command messages C1′ and C2′ and the event messages E2′, E3′, and E5′, F2 is time period for which the first command message C1′ has been on the message bus, F8 is time period for which the second event message E2′ has been on the message bus, F13 is time period for which the third event message E3′ has been on the message bus, F19 is time period for which the second command message C2′ has been on the message bus, and F26 is time period for which the fifth event message E5′ has been on the message bus.

It will be apparent to a person skilled in the art that the set of time-series computation functions associated with each time-series analytics overlay node illustrated in FIGS. 11A-11H are non-limiting. In other embodiments, each time-series analytics overlay node illustrated in FIGS. 11A-11H may include additional or different time-series computation functions in the corresponding set of time-series computation functions.

Although in FIGS. 11A-11H, the set of time-series computation functions associated with each time-series analytics overlay node is shown to be executed on dynamic dataset of compositions of message nodes, in some embodiments, the set of time-series computation functions associated with a time-series analytics overlay node may be further executed based on static dataset of the compositions of the message node. For example, the total time for which the messages were actively executed may be determined only when such messages have a first attribute value for the attribute ‘Topic’.

In an embodiment, the time-series analytics may be performed based on a type of analytics (e.g., descriptive analytics, diagnostic analytics, predictive analytics, prescriptive analytics, or the like) that is indicated by the stimulus 230. The descriptive analytics refers to an analytics operation that, when executed on one or more messages, yields an output that is indicative of ‘What happened?’ with the one or more messages. The diagnostic analytics refers to an analytics operation that, when executed on one or more messages, yields an output that is indicative of ‘Why did it happen?’ with the one or more messages. The predictive analytics refers to an analytics operation that, when executed on one or more messages, yields an output that is indicative of ‘What is likely to happen?’ with the one or more messages. The prescriptive analytics refers to an analytics operation that, when executed on one or more messages, yields an output that is indicative of ‘What should be done?’ with the one or more messages.

Based on loading of a time-series analytics overlay node (for example, the time-series analytics overlay node 1131) for executing corresponding set of time-series computation functions, one or more overlays that are inherited thereby (for example, the time-series analytics overlay node 1119) also gets loaded with corresponding data and processing logic.

In some instances, the time-series analytics overlay node 1177 may use one or more other time-series analytics overlay nodes (for example, the time-series analytics overlay node 1102) for executing corresponding set of time-series computation functions. In such instances, the time-series analytics overlay node 1177 may be dependent on the time-series analytics overlay node 1102. Therefore, based on loading of the time-series analytics overlay node 1177 for executing corresponding set of time-series computation functions, one or more time-series overlays nodes (for example, the time-series analytics overlay node 1102) on which the time-series analytics overlay node 1177 may have dependency also gets loaded with corresponding data and processing logic.

In some embodiments, a time-series analytics overlay node (for example, the time-series analytics overlay node 1177) may be a shared analytics overlay node. In such embodiments, the time-series analytics overlay node may be also associated with one or more other message nodes. Hence, the set of time-series computation functions associated with the time-series analytics overlay node may be also executed on compositions of the one or more other message nodes.

In some embodiments, a time-series analytics overlay node (for example, the time-series analytics overlay node 1177) may be a stateful overlay. The stateful overlay is persistent in nature and gets stored in the storage device associated with the overlay system 202. In such an embodiment, one or more computation outputs determined by the time-series analytics overlay node also gets stored along with the time-series analytics overlay node. Such computation outputs may be loaded from the storage device along with the time-series analytics overlay node and may be used as and when required. Additionally, in such embodiments, the time-series analytics overlay node may be a shared overlay. That is to say, the time-series analytics overlay node may be associated with two or more message nodes. Alternatively, the time-series analytics overlay node maybe a non-shared overlay. That is to say, the time-series analytics overlay node may be exclusive to a single message node.

In some embodiments, a time-series analytics overlay node (for example, the time-series analytics overlay node 1177) may be a stateless overlay node. The stateless overlay node is non-persistent in nature and hence is not stored in the storage device associated with the overlay system 202. In such embodiments, one or more computation outputs determined by the time-series analytics overlay node cease to persist when the time-series analytics overlay node gets unloaded. In instances, when such computation outputs is required to be re-used by the overlay system 202, the computation outputs are required to be re-generated by the time-series analytics overlay node by executing the corresponding set of time-series computation functions or some other analytics overlay node. Additionally, in such embodiments, the time-series analytics overlay node may be a shared overlay. That is to say, the time-series analytics overlay node may be associated with two or more message nodes. Alternatively, the time-series analytics overlay node maybe a non-shared overlay. That is to say, the time-series analytics overlay node may be exclusive to a single message node.

Subsequently, based on the computation outputs generated by the time-series analytics overlay node, a publisher overlay node of the time-series analytics overlay node 1177 may generate and publish a statistical insight that may be used by the processing circuitry to generate an analytics outcome indicative of the operational performance of the overlay system 202. The analytics outcome may be generated in form of an event message (not shown).

In some embodiments, the computation outputs may be stored as one or more attribute of a corresponding message node. In such embodiments, the computation outputs stored as the attributes may persist with the corresponding message node that is stored at the storage device associated with the overlay system 202.

In some embodiments, the analytics module 240 may be further configured to analyze one or more actions/recommendations that are implemented within the overlay system 202 based on the analytics outcome. Based on such analytics, the analytics module 240 is configured to determine a fitness score of the analytics outcome. In an example, when the operational performance of the overlay system 202 improves based on the implementation of the one or more actions/recommendations, the analytic outcome may have a higher fitness score. In another example, when the operational performance of the overlay system 202 does not improve or degrades based on the implementation of the one or more actions/recommendations, the analytic outcome may have a lower fitness score. In such an example, the implementation of the one or more actions/recommendations may be rolled back. Further, one or more messages that were analyzed to generate the analytics outcome may be linked to one or more messages that got affected by the implementation of the one or more actions/recommendations. Such linking of the messages may be performed to identify one or more results of the implementation of the one or more actions/recommendations. The fitness score of the analytics outcome may be determined based on the linking of the messages.

In an example, the analytics outcome of analysis of messages at a first time instance may be indicative of a recommendation for instantiation of one or more additional publisher overlay nodes in the executable graph-based model 100 to avoid long queue of messages to be raised at each publisher overlay node. Subsequently, the additional publisher overlay nodes may be instantiated in the executable graph-based model 100. Further, messages in the queue of each publisher overlay node at a second time instance may be linked to the messages in its queue at the first time instance. Based on such linking, it may be determined that the queue does not have any messages waiting to be handled. Therefore, the instantiation of the additional publisher overlay nodes is not required and hence gets rolled back.

For the sake of brevity, message base nodes of the message nodes, other than the command node 1101, that are depicted in FIGS. 11B-11H are not shown. It will be apparent to a person skilled in the art that each message node includes a corresponding message base node without deviating from the scope of the disclosure.

It will be apparent to a person skilled in the art that each message node (for example, the command node 1101, the event header node 1111, or the like) is associated with a corresponding set of attribute vertex nodes that stores attribute values of the plurality of attributes associated therewith. For the sake of brevity, only a few attribute vertex nodes are shown to be associated with the message nodes shown in FIGS. 11A-11H.

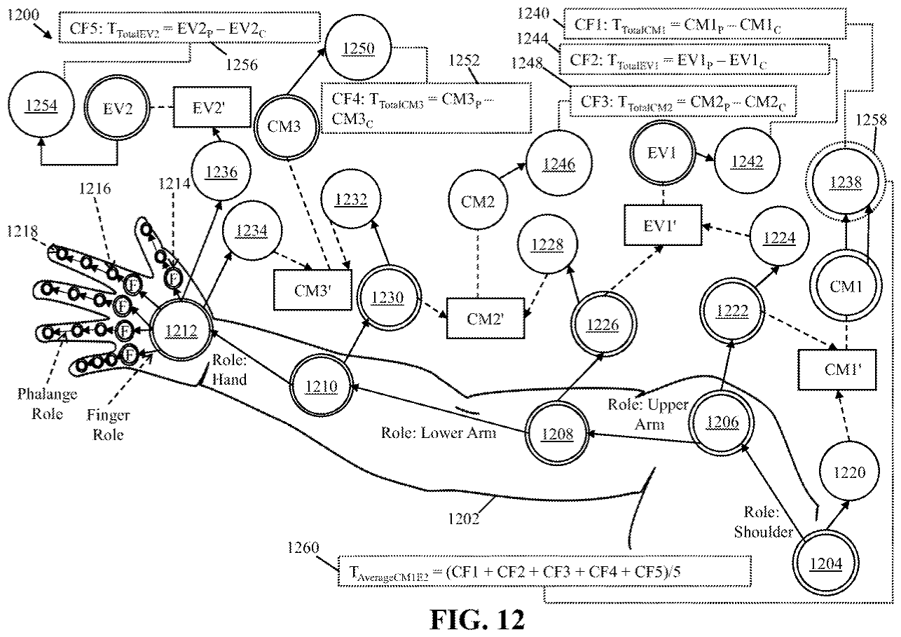

FIG. 12 is a schematic diagram that illustrates an example implementation of time-series message management in an executable graph-based robotic arm model 1200, in accordance with an embodiment of the present disclosure. Referring to FIG. 12, the executable graph-based robotic arm model 1200 corresponds to an executable graph-based model generated for a robotic arm 1202, and is hereinafter referred to as the ‘robotic arm model 1200’. The robotic arm 1202 includes various components such as a brain, a shoulder, an upper arm, a lower arm, a hand, fingers, and phalanges. In such a scenario, the robotic arm model 1200 may include various executable nodes that represent the components of the robotic arm 1202. Such executable nodes are connected to each other in a hierarchical structure. For example, the brain acts as a root, the shoulder, the upper arm, the lower arm, the hand, the fingers, and some phalanges act as intermediate nodes, and remaining phalanges act as leaves, of the hierarchical structure of the robotic arm model 1200. Roots and intermediate executable nodes of the hierarchical structure have edge node-types, whereas, leaf executable nodes of the hierarchical structure have vertex node-types. Further, the executable nodes are linked by way of executable nodes of role node-types (depicted by way of arrows in FIG. 12). Hereinafter, each node with edge node-type is referred as an edge, each node with the vertex node-type is referred as a vertex, each node with the role node-type is referred as a role.

As shown in FIG. 12, an executable graph-based model (e.g., the robotic arm model 1200) generated for the robotic arm 1202 includes a brain edge 1204, a shoulder edge 1206, an upper arm edge 1208, a lower arm edge 1210, a hand edge 1212, and a plurality of finger edges (for example, a finger edge 1214) that represent the brain, the shoulder, the upper arm, the lower arm, the hand, and the fingers of the robotic arm 1202, respectively. The robotic arm model 1200 further includes a plurality of phalange edges (for example, a phalange edge 1216) and a plurality of phalange vertices (for example, a phalange vertex 1218) that represent phalanges of the robotic arm 1202. Phalanges that represent intermediate nodes of the hierarchical structure are edges, whereas, phalanges that represent leaf nodes of the hierarchical structure are vertices. The brain edge 1204 and the shoulder edge 1206 are linked by way of a shoulder role. The shoulder edge 1206 and the upper arm edge 1208 are linked by way of an upper arm role, whereas, the upper arm edge 1208 and the lower arm edge 1210 are linked by way of a lower arm role. Similarly, the lower arm edge 1210 and the hand edge 1212 are linked by way of a hand role. Further, the hand edge 1212 is linked with each finger edge by way of a finger role. Further, each finger edge is associated with an adjacent phalange edge by way of a phalange role, two phalange edges are associated with each other by way of corresponding phalange roles, and a phalange edge and a phalange vertex are associated with each other by way of a phalange role. The vertices, edges, and role nodes (not shown) of the robotic arm model 1200, collectively, enable movement of the robotic arm 1202. Hence, timely and proper communication among the nodes of the robotic arm model 1200 becomes crucial for ensuring a seamless operation of the robotic arm 1202. Therefore, operational performance requires to be analyzed and optimized frequently. Also, the operational performance of the robotic arm model 1200 is required to be analyzed in real-time so that performance of thereof may be optimized in real-time.

As shown, the brain edge 1204 is extended to have a corresponding publisher overlay node 1220. The shoulder edge 1206 is extended to have a corresponding handler overlay node 1222, which is then further extended to have a publisher overlay node 1224. The upper arm edge 1208 is extended to have a handler overlay node 1226 which is extended to have a publisher overlay node 1228. The lower arm edge 1210 is extended to have a handler overlay node 1230 which is then further extended to have a publisher overlay node 1232. The hand edge 1212 is extended to have a handler overlay node 1234 and a publisher overlay node 1236.

In one instance, the publisher overlay node 1220 of the brain edge 1204 creates and publishes a command message CM1′ that is represented by a message node CM1 in the robotic arm model 1200. The command message CM1′ gets subscribed by the handler overlay node 1222 of the shoulder edge 1206. The handler overlay node 1222 processes the command message CM1′. Based on the processing of the command message CM1′, the publisher overlay node 1224 of the handler overlay node 1222 creates and publishes an event message EV1′ that is represented by a message node EV1 in the robotic arm model 1200. The event message EV1′ gets subscribed by the handler overlay node 1226 of the upper arm edge 1208. The handler overlay node 1226 processes the event message EV1′. Based on the processing of the event message EV1′, the publisher overlay node 1228 of the handler overlay node 1226 creates and publishes a command message CM2′ that is represented by a message node CM2 in the robotic arm model 1200. The command message CM2′ gets subscribed by the handler overlay node 1230 of the lower arm edge 1210. The handler overlay node 1230 processes the command message CM2′. Based on the processing of the command message CM2′, the publisher overlay node 1232 of the handler overlay node 1230 creates and publishes another command message CM3′ that is represented by a message node CM3 in the robotic arm model 1200. The command message CM3′ gets subscribed by the handler overlay node 1234 of the hand edge 1212. The handler overlay node 1234 processes the command message CM3′. Based on the processing of the command message CM3′, the publisher overlay node 1236 of the hand edge 1212 creates and publishes an event message EV2′ that is represented by a message node EV2 in the robotic arm model 1200. The publishing of the event message EV2′ marks completion of lifecycle of execution of a transaction associated with the command message CM1′. The event messages EV1′ and EV2′ and the command messages CM2′ and CM3′ are correlated to the command message CM1′ and are created as a part of the transaction associated with execution of the first command message CM1′.

In operation, a stimulus (for example, the stimulus 230) may be received for performing time-series analytics of the command message CM1′ and messages that are correlated therewith. Such time-series analytics may be performed to analyze an operational performance of the robotic arm model 1200. For stimulus processing of the stimulus, the message node CM1 and its correlated message nodes EV1, CM2, CM3, and EV3 are identified by the message management module 214. The message nodes CM1, EV1, CM2, CM3, and EV2 form the set of correlated message nodes. Further, one or more time-series analytics overlay nodes associated with each message node of the set of correlated message nodes is identified by the message management module 214.

As shown, the message node CM1 is extended to have a time-series analytics overlay node 1238 that may execute corresponding set of time-series computation functions on composition of the message node CM1. As shown within a dotted box 1240, the set of time-series computation functions associated with the time-series analytics overlay node 1238 includes the following function.

$${T}_{Total CM 1} = CM {1}_{P} - CM {1}_{C ,} \qquad CF1$$

where, T_{TotalCM1} is total time required for communication of the command message CM1′. CM1_{P} is a time instance of completion of the processing of the command message CM1′. CM1_{C} is a time instance of creation of the command message CM1′.

The message node EV1 is extended to have a time-series analytics overlay node 1242 that may execute corresponding set of time-series computation functions on composition of the message node EV1. As shown within a dotted box 1244, the set of time-series computation functions associated with the time-series analytics overlay node 1242 includes the following function.

$${T}_{Total EV 1} = EV {1}_{P} - EV {1}_{C ,} \qquad CF2$$

where, T_{TotalEV1} is total time required for communication of the event message EV1′. EV1_{P} is a time instance of completion of the processing of the event message EV1′. EV1_{C} is a time instance of creation of the event message EV1′.

As shown, the message node CM2 is extended to have a time-series analytics overlay node 1246 that may execute corresponding set of time-series computation functions on composition of the message node CM2. As shown within a dotted box 1248, the set of time-series computation functions associated with the time-series analytics overlay node 1246 includes the following function.

$${T}_{Total CM 2} = CM {2}_{P} - CM {2}_{C ,} \qquad CF3$$

where, T_{TotalCM2} is total time required for communication of the command message CM2′. CM2_{P} is a time instance of completion of the processing of the command message CM2′. CM2_{C} is a time instance of creation of the command message CM2′.

As shown, the message node CM3 is extended to have a time-series analytics overlay node 1250 that may execute corresponding set of time-series computation functions on composition of the message node CM3. As shown within a dotted box 1252, the set of time-series computation functions associated with the time-series analytics overlay node 1250 includes the following function.

$${T}_{Tota l CM 3} = CM {3}_{P} - CM {3}_{C ,} \qquad CF4$$

where, T_{TotalCM3} is total time required for communication of the command message CM3′. CM3_{P} is a time instance of completion of the processing of the command message CM3′. CM3_{C} is a time instance of creation of the command message CM3′.

As shown, the message node EV2 is extended to have a time-series analytics overlay node 1254 that may execute corresponding set of time-series computation functions on composition of the message node EV2. As shown within a dotted box 1256, the set of time-series computation functions associated with the time-series analytics overlay node 1254 includes the following function.

$${T}_{Total EV 2} = EV {2}_{P} - EV {2}_{C ,} \qquad CF5$$

where, T_{TotalEV2} is total time required for communication of the event message EV2′. EV2_{P} is a time instance of completion of the processing of the event message EV2′. EV2_{C} is a time instance of creation of the event message EV2′.

The message node CM1 is further extended to have another time-series analytics overlay node 1258 that is shown as a dotted circle that indicates it is inheriting another node. As shown, the time-series analytics overlay node 1258 encompasses the time-series analytics overlay node 1238 and hence, inherits the time-series analytics overlay node 1238. When a transaction associated with the command message CM1′ has completed its execution, the time-series analytics overlay node 1258 may execute corresponding set of operations on its correlated message nodes (for example, the message nodes EV1, CM2, CM3, and EV2). Further, the time-series analytics overlay node 1258 may also access one or more computation outputs generated by time-series analytics overlay nodes for each message node of the set of correlated message nodes. As shown within a dotted box 1260, the set of time-series computation functions associated with the time-series analytics overlay node 1258 include the following time-series computation function.

$${T}_{A v erage CM 1 E 2} = ( C F 1 + C F 2 + C F 3 + C F 4 + CF 5 ) / 5 , \qquad CF6$$

where, T_{AverageCM1E2} is average time required for communication of each message of the set of correlated messages. Such average time provides an insight regarding the average time required for each node of the robotic arm model 1200 to execute corresponding operation, CF1 is total time required for communication of the command message CM1′, CF2 is total time required for communication of the event message EV1′, CF3 is total time required for communication of the command message CM2′, CF4 is total time required for communication of the command message CM3′, and CF5 is total time required for communication of the event message EV2′.

Further, computation outputs determined by the time-series analytics overlay nodes shown in FIG. 12 includes values of T_{TotalCM1}, T_{TotalEV1}, T_{TotalCM2}, T_{TotalCM3}, T_{TotalEV2}, and T_{AverageCM1E2}. The computation outputs and static dataset associated with the message nodes CM1, EV1, CM2, CM3, and EV2 may be used by one or more publisher overlay nodes (not shown) associated with at least one of the time-series analytics overlay nodes 1238, 1242, 1246, 1250, 1254, and 1258 to generate one or more statistical insights. The statistical insights may indicate information associated with the operational performance of the robotic arm model 1200. In an example, the statistical insights may include one or more facts such as (i) wait-time for each message to get processed, (ii) processing time required for processing of message in each queue, (iii) topics with messages that are being processed slow, or the like. Subsequently, the analytics module 240 may generate an analytics outcome that may be one of a descriptive analytics outcome, a diagnostic analytics outcome, a predictive analytics outcome, and a prescriptive analytics outcome.

In an instance, the analytics outcome may be the descriptive analytics outcome. In such an instance, the analytics outcome may be indicative of ‘What happened?’ in the robotic arm model 1200. The analytics outcome may be ‘an increase in complexity of movements of the robotic arm 1202’. In another instance, the analytics outcome may be the diagnostic analytics outcome. In such an instance, the analytics outcome may be indicative of ‘Why did it happen?’ in the robotic arm model 1200. The analytics outcome may be ‘increase in complexity of movements of the robotic arm 1200 due to a recent update in processing logic associated with the robotic arm model 1200’. In yet another instance, the analytics outcome may be the prescriptive analytics outcome. In such an instance, the analytics outcome may be indicative of ‘What should be done?’ in the robotic arm model 1200. The analytics outcome may be ‘requirement of a rollback operation to be performed on the processing logic associated with the robotic arm model 1200’. In yet another instance, the analytics outcome may be the predictive analytics outcome. In such an instance, the analytics outcome may be indicative of ‘What is likely to happen?’ in the robotic arm model 1200. The analytics outcome may be ‘Delayed movements in the robotic arm 1202’.

In some embodiments, such time-series based analytics may be performed with specific goals. In an example, the time-series based analytics performed by a time-series analytics overlay node to generate computation outputs that may be used to identify one or more categories that are being processed slow. That is to say that, such analytics may be performed to identify categories that have messages that are being processed slowly. In another example, time-series analytics may be performed to identify one or more slow queues. In yet another example, time-series analytics may be performed to identify time consuming operations associated with communication of messages in the robotic arm model 1200.

It will be apparent to a person skilled in the art that in different embodiments, the robotic arm 1202 may include additional or different components configured to perform similar or dissimilar operations. Although, the time-series analytics overlays nodes shown in FIG. 12 are shown to be the descriptive time-series analytics overlay node, the diagnostic time-series analytics overlay node, the predictive time-series analytics overlay node, and the prescriptive time-series analytics overlay node, in other embodiments, the time-series analytics overlay nodes may have any other time-series analytics overlay node type without deviating from the scope of the disclosure.

FIG. 13 shows an example computing system 1300 for carrying out the methods of the present disclosure, in accordance with an embodiment of the present disclosure. Specifically, FIG. 13 shows a block diagram of an embodiment of the computing system 1300 according to example embodiments of the present disclosure.

The computing system 1300 may be configured to perform any of the operations disclosed herein, such as, for example, any of the operations discussed with reference to the functional modules described in relation to FIG. 2. The computing system 1300 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1300 is a distributed system configured to function using multiple computing machines interconnected via a data network or bus system.

The computing system 1300 includes computing devices (such as a computing device 1302). The computing device 1302 includes one or more processors (such as a processor 1304) and a memory 1306. The processor 1304 may be any general-purpose processor(s) configured to execute a set of instructions. For example, the processor 1304 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1304 may be multiple processing units, a single processing core, multiple processing cores, special purpose processing cores, co-processors, or any combination thereof. The processor 1304 may be communicatively coupled to the memory 1306 via an address bus 1308, a control bus 1310, a data bus 1312, and a messaging bus 1314.

The memory 1306 may include non-volatile memories such as a read Only memory (ROM), a programable read Only memory (PROM), an erasable programmable read Only memory (EPROM), a flash memory, or any other device capable of storing program instructions or data with or without applied power. The memory 1306 may also include volatile memories, such as a random-access memory (RAM), a static random-access memory (SRAM), a dynamic random-access memory (DRAM), and a synchronous dynamic random-access memory (SDRAM). The memory 1306 may include single or multiple memory modules. While the memory 1306 is depicted as part of the computing device 1302, a person skilled in the art will recognize that the memory 1306 can be separate from the computing device 1302.

The memory 1306 may store information that can be accessed by the processor 1304. For instance, the memory 1306 (e.g., one or more non-transitory computer-readable storage mediums, memory devices) may include computer-readable instructions (not shown) that can be executed by the processor 1304. The computer-readable instructions may be software written in any suitable programming language or may be implemented in hardware. Additionally, or alternatively, the computer-readable instructions may be executed in logically and/or virtually separate threads on the processor 1304. For example, the memory 1306 may store instructions (not shown) that when executed by the processor 1304 cause the processor 1304 to perform operations such as any of the operations and functions for which the computing system 1300 is configured, as described herein. Additionally, or alternatively, the memory 1306 may store data (not shown) that can be obtained, received, accessed, written, manipulated, created, and/or stored. The data can include, for instance, the data and/or information described herein in relation to FIGS. 1-12. In some implementations, the computing device 1302 may obtain from and/or store data in one or more memory device(s) that are remote from the computing system 1300.

The computing device 1302 may further include an input/output (I/O) interface 1316 communicatively coupled to the address bus 1308, the control bus 1310, and the data bus 1312. The data bus 1312 and messaging bus 1314 may include a plurality of tunnels that may support parallel execution of messages by the overlay system 202. The I/O interface 1316 is configured to couple to one or more external devices (e.g., to receive and send data from/to one or more external devices). Such external devices, along with the various internal devices, may also be known as peripheral devices. The I/O interface 1316 may include both electrical and physical connections for operably coupling the various peripheral devices to the computing device 1302. The I/O interface 1316 may be configured to communicate data, addresses, and control signals between the peripheral devices and the computing device 1302. The I/O interface 1316 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, Fire Wire, various video buses, or the like. The I/O interface 1316 is configured to implement only one interface or bus technology. Alternatively, the I/O interface 1316 is configured to implement multiple interfaces or bus technologies. The I/O interface 1316 may include one or more buffers for buffering transmissions between one or more external devices, internal devices, the computing device 1302, or the processor 1304. The I/O interface 1316 may couple the computing device 1302 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1316 may couple the computing device 1302 to various output devices, including video displays, speakers, printers, projectors, tactile feedback devices, automation control, robotic components, actuators, motors, fans, solenoids, valves, pumps, transmitters, signal emitters, lights, and so forth.

The computing system 1300 may further include a storage unit 1318, a network interface 1320, an input controller 1322, and an output controller 1324. The storage unit 1318, the network interface 1320, the input controller 1322, and the output controller 1324 are communicatively coupled to the central control unit (e.g., the memory 1306, the address bus 1308, the control bus 1310, and the data bus 1312) via the I/O interface 1316. The network interface 1320 communicatively couples the computing system 1300 to one or more networks such as wide area networks (WAN), local area networks (LAN), intranets, the Internet, wireless access networks, wired networks, mobile networks, telephone networks, optical networks, or combinations thereof. The network interface 1320 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1318 is a computer-readable medium, preferably a non-transitory computer-readable medium, comprising one or more programs, the one or more programs comprising instructions which when executed by the processor 1304 cause the computing system 1300 to perform the method steps of the present disclosure. Alternatively, the storage unit 1318 is a transitory computer-readable medium. The storage unit 1318 can include a hard disk, a floppy disk, a compact disc read Only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1318 stores one or more operating systems, application programs, program modules, data, or any other information. The storage unit 1318 is part of the computing device 1302. Alternatively, the storage unit 1318 is part of one or more other computing machines that are in communication with the computing device 1302, such as servers, database servers, cloud storage, network attached storage, and so forth.

The input controller 1322 may include suitable logic, circuitry, interfaces, and/or code, executable by the circuitry, that may be configured to control one or more input devices that may be configured to receive an input (the stimulus 230) for the overlay system 202. The output controller 1324 may include suitable logic, circuitry, interfaces, and/or code, executable by the circuitry, that may be configured to control one or more output devices that may be configured to render/output the outcome of the operation executed to process the received input (the stimulus 230).

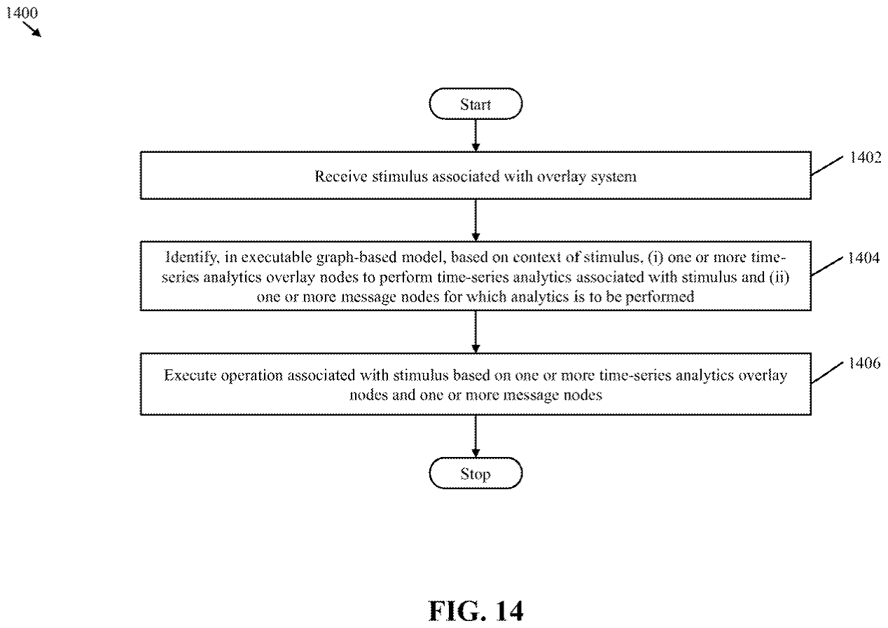

FIG. 14 is a flowchart 1400 that illustrates a method for facilitating time-series message management using the executable graph-based model 100, in accordance with an embodiment of the present disclosure. Referring to FIG. 14, at 1402, the controller module 206 (e.g., the processing circuitry of the overlay system 202) receives a stimulus (e.g., the stimulus 230) of the overlay system 202. At 1404, the message management module 214 identifies, in the executable graph-based model 100, based on the context of the stimulus 230, (i) one or more time-series analytics overlay nodes to perform time-series analytics associated with the stimulus 230 and (ii) one or more message nodes, of the plurality of message nodes, for which the time-series analytics is to be performed. The one or more time-series analytics overlay nodes include at least one time-series analytics overlay node of each message node of the one or more message nodes. At 1406, the analytics module 240 executes the operation associated with the stimulus 230 based on the one or more time-series analytics overlay nodes and the one or more message nodes.

The disclosed embodiments encompass numerous advantages including an efficient and seamless approach for facilitation of real-time message management using executable graph-based models. The systems and methods disclosed herein provide for an ability to perform time-series computation functions at a single message level. The systems and methods disclosed herein are capable of performing time-series computation functions on any number of messages. That is to say that the systems and methods disclosed herein allow for dynamic scale-up and scale-down in message analysis. Such analytics of messages is performed in real-time and simultaneously and, hence, exhibits negligible to no wait time. Further, such analytics is performed based on a current progress of execution of messages associated with the overlay system 202. Hence, such analytics is performed based on a current state of the executable graph-based model 100. Therefore, such analytics provides analytics outcomes that is relevant for the current state of the executable graph-based model 100. Further, the disclosed systems and methods exhibit consistent performance regardless of a count of messages that are to be analyzed. Also, a concept of value shared attributes disclosed herein allows for efficient storage and retrieval of compositions of messages associated with the overlay system 202. Hence, while looking for messages with a specific attribute value, only a vertex node that stores the attribute value is required to be tracked to identify message nodes with that attribute value. Therefore, performing search for messages requires significantly less time. Such analytics and identification of messages may be used to determine the statistical insights for improving performance of the overlay system 202. Also, the message nodes in the executable graph-based model 100 are loaded as and when they are required. The systems and methods disclosed herein allow for the segregation of data and processing logic and hence ensure mutual independence thereof. Application areas of the systems and methods disclosed herein may include, but are not limited to, industrial processes, robotics, home security, automation industry, or the like.

Certain embodiments of the disclosure may be found in the disclosed systems, methods, and non-transitory computer-readable medium, for facilitating time-series based message management using executable graph-based models. The methods and systems disclosed herein include various operations performed by the processing circuitry (e.g., the controller module 206, the transaction module, 208, the message management module 214, the analytics module 240, any other element of the overlay system 202, or a combination of two or more elements of the overlay system 202). The systems disclosed herein includes a storage element configured to store an executable graph-based model that comprises a plurality of message nodes and a plurality of time-series analytics overlay nodes, with each message node having a first set of time-series analytics overlay nodes associated therewith. Each message node represents a message associated with the overlay system and has a composition that includes a dynamic dataset associated with the message. The dynamic dataset includes one or more timestamps of one or more milestones associated with the corresponding message. Each time-series analytics overlay node, of the set of time-series analytics overlay nodes, is configured to execute a set of time-series computation functions on the dynamic dataset of the corresponding message node. The systems disclosed herein further include processing circuitry that is coupled to the storage element. The processing circuitry is configured to receive a first stimulus associated with the overlay system. The processing circuitry is further configured to identify, in the executable graph-based model, based on a context of the first stimulus, (i) one or more time-series analytics overlay nodes, of the plurality of time-series analytics overlay nodes, to perform time-series analytics associated with the first stimulus and (ii) one or more message nodes, of the plurality of message nodes, for which the time-series analytics is to be performed. The one or more time-series analytics overlay nodes comprise at least one of the set of time-series analytics overlay nodes of each message node of the one or more message nodes. The processing circuitry is further configured to execute an operation associated with the first stimulus based on the one or more time-series analytics overlay nodes and the one or more message nodes.

In some embodiments, each time-series computation function of the set of time-series computation functions includes one or more mathematical computations that, when performed on the dynamic dataset of the corresponding message node, generates a computation output indicative of performance of the overlay system.

In some embodiments, the processing circuitry is further configured to generate an analytics outcome by executing one or more database operations on the computation output of each time-series computation function of the set of time-series computation functions of the one or more time-series analytics overlay nodes.

In some embodiments, the one or more database operations include at least one of a group consisting of (i) an intersection operation and (ii) a union operation.

In some embodiments, the executable graph-based model further comprises a plurality of publisher overlay nodes. Each publisher overlay node is associated with at least one time-series analytics overlay node of the plurality of time-series analytics overlay nodes, and configured to generate and publish one or more statistical insights associated with performance of the overlay system based on the set of time-series computation functions executed by the corresponding time-series analytics overlay node. The processing circuitry executes the operation associated with the first stimulus further based on a set of publisher overlay nodes, of the plurality of publisher overlay nodes, associated with the one or more time-series analytics overlay nodes. The processing circuitry is further configured to generate an analytics outcome based on the one or more statistical insights generated by each publisher overlay node of the set of publisher overlay nodes.

In some embodiments, based on the first stimulus, each of the one or more time-series analytics overlay nodes executes the first set of time-series computation functions on the dynamic dataset of the corresponding message node to determine a corresponding set of computation outputs that is indicative of performance of the overlay system while completing the one or more milestones of the corresponding message node. Each publisher overlay node of the set of publisher overlay nodes is coupled to at least one of the one or more time-series analytics overlay nodes, and generates and publishes the one or more statistical insights based on the set of computation outputs determined by the corresponding time-series analytics overlay node. The execution of the operation associated with the first stimulus corresponds to the generation and publication of the one or more statistical insights by each publisher overlay node of the set of publisher overlay nodes and generation of the analytics outcome.

In some embodiments, the dynamic dataset of each message node of the plurality of message nodes includes at least one of a group consisting of a received on attribute, a handled on attribute, a processed on attribute, a subscriber identifier, an allow retry attribute, a maximum retry allowed attribute, a current retry count, a retry source identifier, a source identifier, and a source type, associated with a corresponding message.

In some embodiments, the composition of each message node of the plurality of message nodes further includes a static dataset that includes at least one of a group consisting of an identifier, one or more correlation identifiers, a user identifier, a name, a category, a topic, a key, a scope attribute, an execution attribute, an action attribute, created on attribute, raised on attribute, publisher identifier, and data, associated with a corresponding message.

In some embodiments, each time-series analytics overlay node of the plurality of time-series analytics overlay nodes, is further configured to execute the corresponding first set of time-series computation functions on the static dataset. The operation associated with the first stimulus is executed further based on the first set of time-series computation functions executed by each of the one or more time-series analytics overlay nodes on the static dataset of the corresponding message node.

In some embodiments, each time-series computation function of the first set of time-series computation functions includes one or more parameters, where a parameter value of each of the one or more parameters is derived from the dynamic dataset of the corresponding message node. Each time-series analytics overlay of the one or more time-series analytics overlay is further configured to execute each time-series computation function of the corresponding first set of time-series computation functions based on the derived one or more parameter values of the associated one or more parameters, respectively. For each time-series analytics overlay node of the one or more time-series analytics overlay nodes one or more statistical insights indicative of performance of the overlay system are determined based on the execution of each time-series computation function of the corresponding first set of time-series computation functions. During the processing of the first stimulus, the processing circuitry is further configured to generate an analytics outcome based on the one or more statistical insights associated with each of the one or more time-series analytics overlay nodes.

In some embodiments, for each time-series analytics overlay node of the plurality of time-series analytics overlay nodes, the processing circuitry is further configured to define the one or more parameters of each time-series computation function of the corresponding first set of time-series computation functions based on the one or more milestones associated with the message represented by the corresponding message node.

In some embodiments, for each time-series analytics overlay node of the plurality of time-series analytics overlay nodes, the processing circuitry is further configured to define the one or more parameters of each time-series computation function of the corresponding first set of time-series computation functions based on a user input.

In some embodiments, for each time-series analytics overlay node of the plurality of time-series analytics overlay nodes, the processing circuitry is further configured to define one or more time-series computation functions of the first set of time-series computation functions based on a user input.

In some embodiments, for each time-series analytics overlay node of the plurality of time-series analytics overlay nodes, the first set of time-series computation functions further includes a subset of non-executable computation functions. Each non-executable computation function includes at least one parameter with an absence of parameter value based on an incomplete status of a corresponding milestone of a message represented by the corresponding message node.

In some embodiments, the one or more milestones associated with each message of the overlay system include at least one of a group consisting of a creation event, a raise event, a subscription event, a handle event, and a process event.

In some embodiments, a plurality of messages are associated with the overlay system. The processing circuitry is further configured to generate the executable graph-based model based on the plurality of messages and store the executable graph-based model in the storage element. To generate the executable graph-based model, the processing circuitry is further configured to instantiate one message node for each message of the plurality of messages associated with the overlay system and instantiate a time-series analytics overlay node, of the plurality of time-series analytics overlay nodes as an overlay of the instantiated message node for facilitating the time-series analytics on the corresponding message node.

In some embodiments, a set of messages associated with the overlay system is correlated such that a first message of the set of messages has a causal association with a second message of the set of messages, and as a result, a first message node, of the plurality of message nodes, representing the first message has a causal association with a second message node, of the plurality of message nodes, representing the second message. The executable graph-based model further comprises a plurality of message edge nodes, with a first message edge node coupling the first message node and the second message node. The first message edge node includes a first message role and a second message role that enable coupling thereof to the first message node and the second message node, respectively, and collectively defines the causal association between the first message node and the second message node. The identification of the one or more message nodes associated with the first stimulus is enabled based on one or more message edge nodes, of the plurality of message nodes, associated with each of the one or more message nodes. The operation associated with the first stimulus is executed further based on the one or more message edge nodes associated with each of the one or more message nodes.

In some embodiments, the processing circuitry is further configured to generate the executable graph-based model based on the set of messages and the plurality of message nodes, and store the executable graph-based model in the storage element. To generate the executable graph-based model, the processing circuitry is further configured to instantiate one message node for each message of the set of messages and instantiate a message edge node, of the plurality of message nodes, between each pair of message nodes that are correlated.

In some embodiments, each message edge node of the plurality of message edge nodes is associated with a second set of time-series analytics overlay nodes of the plurality of time-series analytics overlay nodes. Each time-series analytics overlay node of the corresponding set of time-series analytics overlay nodes is configured to execute a corresponding set of time-series computation functions on composition of each of a pair of message nodes coupled to the corresponding message edge node. The processing circuitry executes the operation associated with the first stimulus further based on the second set of time-series computation functions associated with each of the one or more message edge nodes.

In some embodiments, a first message represented by a first message node of the one or more message nodes identified for stimulus processing of the first stimulus is associated with a set of messages. The set of messages is correlated such that each message of the set of messages has a causal association with at least one other message of the set of messages. The set of messages is generated based on at least a second stimulus received prior to the first stimulus. The processing circuitry is further configured to identify, for the stimulus processing of the first stimulus, a set of message nodes associated with the set of messages and at least one time-series analytics overlay node associated with each message node of the set of message nodes. The processing circuitry executes the operation associated with the first stimulus further based on the identified set of message nodes and the identified time-series analytics overlay node associated with each message node of the set of message nodes.

In some embodiments, the first message node and the set of message nodes are linked by way of one or more correlation identifiers.

In some embodiments, the set of message nodes is instantiated in the executable graph-based model in response to the second stimulus. The set of message nodes includes a parent message node and one or more child message nodes. The processing circuitry is further configured to (i) instantiate the parent message node based on generation of a root message of the set of messages, where the root message is generated based on stimulus processing of the second stimulus, and (ii) instantiate a first set of child message nodes of the one or more child message nodes for a first set of child messages that is generated based on processing of the root message.

In some embodiments, the first message is generated based on processing of the first set of child message nodes.

In some embodiments, the parent message node and the first set of child message nodes are associated with a root correlation identifier that is indicative of a transactional operation associated with the root message for executing a first transaction in the executable graph-based model in response to the second stimulus. The association of the root correlation identifier with the parent message node and the first set of child message nodes indicates a causal association between the root message and the first set of child messages.

In some embodiments, the processing circuitry is further configured to instantiate a second set of child message nodes of the one or more child message nodes for a second set of child messages generated based on the processing of the first set of child messages. The first message is generated based on processing of the second set of child message nodes.

In some embodiments, a root correlation identifier is associated with each of the parent message node, the first set of child message nodes, and the second set of child message nodes. the root correlation identifier is indicative of a transactional operation that is associated with the root message. The transactional operation pertains to a second transaction that is executed in the executable graph-based model in response to the second stimulus. The association of the root correlation identifier with each of the parent message node, the first set of child message nodes, and the second set of child message nodes indicates a causal association therebetween. Each of the second set of child message nodes is further associated with a sub-correlation identifier. A value of the sub-correlation identifier associated with each of the second set of child message nodes is unique. Each unique value of the sub-correlation identifier is indicative of a distinct transactional operation associated with a corresponding child message node of the second set of child message nodes. The distinct transactional operation associated with each child message node of the second set of child message nodes is executed for performing a corresponding transaction in the executable graph-based model.

In some embodiments, the executable graph-based model further comprises a plurality of attribute vertex nodes and a plurality of attribute edge nodes. Each message node of the plurality of message nodes is associated with one or more attribute vertex nodes of the plurality of attribute vertex nodes, with the one or more attribute vertex nodes configured to store the composition of the corresponding message node. The executable graph-based model further comprises a plurality of attribute edge nodes. Each message node of the plurality of message nodes is associated with the one or more attribute vertex nodes by way of one or more attribute edge nodes of the plurality of attribute edge nodes, respectively, with the one or more attribute edge nodes defining the association between the one or more vertex nodes and the corresponding message node, respectively.

In some embodiments, during the processing of the first stimulus, the processing circuitry is further configured to determine the composition of each message node of the one or more message nodes by tracking at least one of a group consisting of (i) the one or more attribute vertex nodes and (ii) the one or more attribute edge nodes coupled thereto.

In some embodiments, prior to the execution of the operation associated with the first stimulus, the processing circuitry is further configured to load, in the executable graph-based model, at least one of a group consisting of (i) the one or more message nodes, (ii) the one or more attribute vertex nodes and the one or more attribute edge nodes associated with each message node of the one or more message nodes, and (iii) the one or more time-series analytics overlay nodes, with corresponding data and processing logic.

In some embodiments, at least one time-series analytics overlay node, of the plurality of time-series analytics overlay nodes, is associated with two or more message nodes of the plurality of message nodes.

In some embodiments, a first time-series analytics overlay node, of a first message node of the one or more message nodes, inherits a second time-series analytics overlay node of a second message node that is different from the one or more message nodes. The processing circuitry is further configured to load the second time-series analytics overlay node with data and processing logic based on a loading of the first time-series analytics overlay node with data and processing logic.

Each time-series analytics overlay node of the plurality of time-series analytics overlay nodes is one of (i) a stateful time-series analytics overlay node and (ii) a stateless time-series analytics overlay node. Each time-series computation function of the first set of time-series computation functions includes one or more mathematical computations that, when performed on the dynamic dataset of the corresponding message node, generates a computation output indicative of performance of the overlay system. Each computation output of the stateful time-series analytics overlay node is persistent and is accessible to the processing circuitry for performing the time-series analytics during a predefined time-interval. Each computation output of the stateless time-series analytics overlay node is non-persistent and the time-series analytics for the computation output is performed at a time of execution of the corresponding first set of time-series computation functions.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for facilitating message management using executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. An overlay system, comprising:
   a storage element configured to store an executable graph-based model that comprises a plurality of message nodes and a plurality of time-series analytics overlay nodes, where each message node has a first set of time-series analytics overlay nodes associated therewith,
      wherein each message node represents a message associated with the overlay system and has a composition that includes a dynamic dataset associated with the message, where the dynamic dataset includes one or more timestamps of one or more milestones associated with the corresponding message, and
      wherein each time-series analytics overlay node, of the first set of time-series analytics overlay nodes, is configured to execute a first set of time-series computation functions on the dynamic dataset of the corresponding message node; and
   processing circuitry that is coupled to the storage element, and configured to:
      receive a first stimulus associated with the overlay system;
      identify, in the executable graph-based model, based on a context of the first stimulus, (i) one or more time-series analytics overlay nodes, of the plurality of time-series analytics overlay nodes, to perform time-series analytics associated with the first stimulus and (ii) one or more message nodes, of the plurality of message nodes, for which the time-series analytics is to be performed, wherein the one or more time-series analytics overlay nodes comprise at least one of the first set of time-series analytics overlay nodes of each message node of the one or more message nodes; and
      execute an operation associated with the first stimulus based on the one or more time-series analytics overlay nodes and the one or more message nodes.
2. The overlay system of 1, wherein each time-series computation function of the first set of time-series computation functions includes one or more mathematical computations that, when performed on the dynamic dataset of the corresponding message node, generates a computation output indicative of performance of the overlay system.
3. The overlay system of 2, wherein the processing circuitry is further configured to generate an analytics outcome by executing one or more database operations on the computation output of each time-series computation function of the first set of time-series computation functions of the one or more time-series analytics overlay nodes.
4. The overlay system of 3, wherein the one or more database operations include at least one of a group consisting of (i) an intersection operation and (ii) a union operation.
5. The overlay system of 1,
   wherein the executable graph-based model further comprises a plurality of publisher overlay nodes,
   wherein each publisher overlay node is associated with at least one time-series analytics overlay node of the plurality of time-series analytics overlay nodes, and configured to generate and publish one or more statistical insights associated with performance of the overlay system based on the first set of time-series computation functions executed by the corresponding time-series analytics overlay node,
   wherein the processing circuitry executes the operation associated with the first stimulus further based on a set of publisher overlay nodes, of the plurality of publisher overlay nodes, associated with the one or more time-series analytics overlay nodes, and
   wherein the processing circuitry is further configured to generate an analytics outcome based on the one or more statistical insights generated by each publisher overlay node of the set of publisher overlay nodes.
6. The overlay system of 5,
   wherein based on the first stimulus, each of the one or more time-series analytics overlay nodes executes the first set of time-series computation functions on the dynamic dataset of the corresponding message node to determine a corresponding set of computation outputs, that is indicative of performance of the overlay system, while completing the one or more milestones of the corresponding message node,
   wherein each publisher overlay node of the set of publisher overlay nodes is coupled to at least one of the one or more time-series analytics overlay nodes, and generates and publishes the one or more statistical insights based on the set of computation outputs determined by the corresponding time-series analytics overlay node, and
   wherein the execution of the operation associated with the first stimulus corresponds to the generation and publication of the one or more statistical insights by each publisher overlay node of the set of publisher overlay nodes and generation of the analytics outcome.
7. The overlay system of 1, wherein the dynamic dataset of each message node of the plurality of message nodes includes at least one of a group consisting of a received on attribute, a handled on attribute, a processed on attribute, a subscriber identifier, an allow retry attribute, a maximum retry allowed attribute, a current retry count, a retry source identifier, a source identifier, and a source type, associated with a corresponding message.
8. The overlay system of 1, wherein the composition of each message node of the plurality of message nodes further includes a static dataset that includes at least one of a group consisting of an identifier, one or more correlation identifiers, a user identifier, a name, a category, a topic, a key, a scope attribute, an execution attribute, an action attribute, a created on attribute, a raised on attribute, a publisher identifier, and data, associated with a corresponding message.
9. The overlay system of 8,
   wherein each time-series analytics overlay node, of the plurality of time-series analytics overlay nodes, is further configured to execute the corresponding first set of time-series computation functions on the static dataset, and
   wherein the operation associated with the first stimulus is executed further based on the first set of time-series computation functions executed by each of the one or more time-series analytics overlay nodes on the static dataset of the corresponding message node.
10. The overlay system of 1,
   wherein each time-series computation function of the first set of time-series computation functions includes one or more parameters, where a parameter value of each of the one or more parameters is derived from the dynamic dataset of the corresponding message node,
   wherein each time-series analytics overlay node of the one or more time-series analytics overlay node is further configured to execute each time-series computation function of the corresponding first set of time-series computation functions based on the derived one or more parameter values of the associated one or more parameters, respectively,
   wherein for each time-series analytics overlay node of the one or more time-series analytics overlay nodes, one or more statistical insights indicative of performance of the overlay system are determined based on the execution of each time-series computation function of the corresponding first set of time-series computation functions, and
   wherein during the processing of the first stimulus, the processing circuitry is further configured to generate an analytics outcome based on the one or more statistical insights associated with each of the one or more time-series analytics overlay nodes.
11. The overlay system of 10, wherein for each time-series analytics overlay node of the plurality of time-series analytics overlay nodes, the processing circuitry is further configured to define the one or more parameters of each time-series computation function of the corresponding first set of time-series computation functions based on the one or more milestones associated with the message represented by the corresponding message node.
12. The overlay system of 10, wherein for each time-series analytics overlay node of the plurality of time-series analytics overlay nodes, the processing circuitry is further configured to define the one or more parameters of each time-series computation function of the corresponding first set of time-series computation functions based on a user input.
13. The overlay system of 10, wherein for each time-series analytics overlay node of the plurality of time-series analytics overlay nodes, the first set of time-series computation functions further includes a subset of non-executable computation functions, where each non-executable computation function includes at least one parameter with an absence of parameter value based on an incomplete status of a corresponding milestone of a message represented by the corresponding message node.
14. The overlay system of 1, wherein the one or more milestones associated with each message of the overlay system include at least one of a group consisting of a creation event, a raise event, a subscription event, a handle event, and a process event.
15. The overlay system of 1,
   wherein a plurality of messages are associated with the overlay system,
   wherein the processing circuitry is further configured to generate the executable graph-based model based on the plurality of messages and store the executable graph-based model in the storage element, and
   wherein, to generate the executable graph-based model, the processing circuitry is further configured to instantiate one message node for each message of the plurality of messages associated with the overlay system and instantiate a time-series analytics overlay node, of the plurality of time-series analytics overlay nodes, as an overlay of the instantiated message node for facilitating the time-series analytics on the corresponding message node.
16. The overlay system of 1,
   wherein a set of messages associated with the overlay system is correlated such that a first message of the set of messages has a causal association with a second message of the set of messages, and as a result, a first message node, of the plurality of message nodes, representing the first message has a causal association with a second message node, of the plurality of message nodes, representing the second message,
   wherein the executable graph-based model further comprises a plurality of message edge nodes, with a first message edge node coupling the first message node and the second message node,
   wherein the first message edge node includes a first message role and a second message role that enable coupling thereof to the first message node and the second message node, respectively, and collectively defines the causal association between the first message node and the second message node,
   wherein the identification of the one or more message nodes associated with the first stimulus is enabled based on one or more message edge nodes associated with each of the one or more message nodes, and
   wherein the operation associated with the first stimulus is executed further based on the one or more message edge nodes associated with each of the one or more message nodes.
17. The overlay system of 16,
   wherein the processing circuitry is further configured to generate the executable graph-based model based on the set of messages and the plurality of message nodes, and store the executable graph-based model in the storage element, and
   wherein, to generate the executable graph-based model, the processing circuitry is further configured to instantiate one message node for each message of the set of messages and instantiate a message edge node, of the plurality of message nodes, between each pair of message nodes that are correlated.
18. The overlay system of 16,
   wherein each message edge node of the plurality of message edge nodes is associated with a second set of time-series analytics overlay nodes of the plurality of time-series analytics overlay nodes,
   wherein each time-series analytics overlay node of the second set of time-series analytics overlay nodes is configured to execute a second set of time-series computation functions on the composition of each of a pair of message nodes coupled to the corresponding message edge node, and
   wherein the processing circuitry executes the operation associated with the first stimulus further based on the second set of time-series computation functions associated with each of the one or more message edge nodes.
19. The overlay system of 1,
   wherein a first message represented by a first message node, of the one or more message nodes identified for stimulus processing of the first stimulus, is associated with a set of messages, wherein the set of messages is correlated such that each message of the set of messages has a causal association with at least one other message of the set of messages,
   wherein the set of messages is generated based on at least a second stimulus received prior to the first stimulus,
   wherein the processing circuitry is further configured to identify, for the stimulus processing of the first stimulus, a set of message nodes associated with the set of messages and at least one time-series analytics overlay node associated with each message node of the set of message nodes, and
   wherein the processing circuitry executes the operation associated with the first stimulus further based on the identified set of message nodes and the identified time-series analytics overlay node associated with each message node of the set of message nodes.
20. The overlay system of 19, wherein the first message node and the set of message nodes are linked by way of one or more correlation identifiers.
21. The overlay system of 19,
   wherein the set of message nodes is instantiated in the executable graph-based model in response to the second stimulus, where the set of message nodes includes a parent message node and one or more child message nodes, and
   wherein the processing circuitry is further configured to (i) instantiate the parent message node based on generation of a root message of the set of messages, where the root message is generated based on stimulus processing of the second stimulus, and (ii) instantiate a first set of child message nodes of the one or more child message nodes for a first set of child messages that is generated based on processing of the root message.
22. The overlay system of 21, wherein the first message is generated based on processing of the first set of child message nodes.
23. The overlay system of 21,
   wherein the parent message node and the first set of child message nodes are associated with a root correlation identifier that is indicative of a transactional operation associated with the root message for executing a first transaction in the executable graph-based model in response to the second stimulus, and
   wherein the association of the root correlation identifier with the parent message node and the first set of child message nodes indicates a causal association between the root message and the first set of child messages.
24. The overlay system of 21,
   wherein the processing circuitry is further configured to instantiate a second set of child message nodes of the one or more child message nodes for a second set of child messages generated based on the processing of the first set of child messages, and
   wherein the first message is generated based on processing of the second set of child message nodes.
25. The overlay system of 24,
   wherein a root correlation identifier is associated with each of the parent message node, the first set of child message nodes, and the second set of child message nodes, where the root correlation identifier is indicative of a transactional operation that is associated with the root message, where the transactional operation pertains to a second transaction that is executed in the executable graph-based model in response to the second stimulus,
   wherein the association of the root correlation identifier with each of the parent message node, the first set of child message nodes, and the second set of child message nodes indicates a causal association therebetween,
   wherein each of the second set of child message nodes is further associated with a sub-correlation identifier, and
   wherein a value of the sub-correlation identifier associated with each of the second set of child message nodes is unique, where each unique value of the sub-correlation identifier is indicative of a distinct transactional operation associated with a corresponding child message node of the second set of child message nodes, where the distinct transactional operation associated with each child message node of the second set of child message nodes is executed for performing a corresponding transaction in the executable graph-based model.
26. The overlay system of 1, wherein the executable graph-based model further comprises:
   a plurality of attribute vertex nodes, wherein each message node of the plurality of message nodes is associated with one or more attribute vertex nodes, of the plurality of attribute vertex nodes, with the one or more attribute vertex nodes configured to store the composition of the corresponding message node; and
   a plurality of attribute edge nodes, wherein each message node of the plurality of message nodes is associated with the one or more attribute vertex nodes by way of one or more attribute edge nodes of the plurality of attribute edge nodes, respectively, with the one or more attribute edge nodes defining the association between the one or more vertex nodes and the corresponding message node, respectively.
27. The overlay system of 26, wherein during the processing of the first stimulus, the processing circuitry is further configured to determine the composition of each message node of the one or more message nodes by tracking at least one of a group consisting of (i) the one or more attribute vertex nodes and (ii) the one or more attribute edge nodes coupled thereto.
28. The overlay system of 26, wherein prior to the execution of the operation associated with the first stimulus, the processing circuitry is further configured to load, in the executable graph-based model, at least one of a group consisting of (i) the one or more message nodes, (ii) the one or more attribute vertex nodes and the one or more attribute edge nodes associated with each message node of the one or more message nodes, and (iii) the one or more time-series analytics overlay nodes, with corresponding data and processing logic.
29. The overlay system of 1, wherein at least one time-series analytics overlay node, of the plurality of time-series analytics overlay nodes, is associated with two or more message nodes of the plurality of message nodes.
30. The overlay system of 1, wherein a first time-series analytics overlay node, of a first message node of the one or more message nodes, inherits a second time-series analytics overlay node of a second message node that is different from the one or more message nodes, and wherein the processing circuitry is further configured to load the second time-series analytics overlay node with data and processing logic based on a loading of the first time-series analytics overlay node with data and processing logic.
31. The overlay system of 1,
   wherein each time-series analytics overlay node of the plurality of time-series analytics overlay nodes is one of (i) a stateful time-series analytics overlay node and (ii) a stateless time-series analytics overlay node,
   wherein each time-series computation function of the first set of time-series computation functions includes one or more mathematical computations that, when performed on the dynamic dataset of the corresponding message node, generates a computation output indicative of performance of the overlay system,
   wherein each computation output of the stateful time-series analytics overlay node is persistent and is accessible to the processing circuitry for performing the time-series analytics during a predefined time-interval, and
   wherein each computation output of the stateless time-series analytics overlay node is non-persistent and the time-series analytics for the computation output is performed at a time of execution of the corresponding first set of time-series computation functions.
32. The overlay system of 1, wherein the processing circuitry is further configured to define one or more time-series computation functions of the first set of time-series computation functions based on a user input.
33. A method, comprising:
   receiving, by processing circuitry of an overlay system, a stimulus associated with the overlay system,
      wherein an executable graph-based model is stored in a storage element of the overlay system,
      wherein the executable graph-based model comprises a plurality of message nodes and a plurality of time-series analytics overlay nodes, with each message node having a set of time-series analytics overlay nodes associated therewith,
      wherein each message node represents a message associated with the overlay system and has a composition that includes a dynamic dataset associated with the message, where the dynamic dataset includes one or more timestamps of one or more milestones associated with the corresponding message, and
      wherein each time-series analytics overlay node, of the set of time-series analytics overlay nodes, executes a set of time-series computation functions on the dynamic dataset of the corresponding message node;
   identifying, in the executable graph-based model, based on a context of the stimulus, (i) one or more time-series analytics overlay nodes, of the plurality of time-series analytics overlay nodes, to perform time-series analytics associated with the stimulus and (ii) one or more message nodes, of the plurality of message nodes, for which the time-series analytics is to be performed, wherein the one or more time-series analytics overlay nodes comprise at least one of the set of time-series analytics overlay nodes of each message node of the one or more message nodes; and
   executing an operation associated with the stimulus based on the one or more time-series analytics overlay nodes and the one or more message nodes.

What is claimed is:

1. An overlay system, comprising:
a storage element configured to store an executable graph-based model that comprises a plurality of message nodes and a plurality of time-series analytics overlay nodes, where each message node has a first set of time-series analytics overlay nodes associated therewith,
wherein each message node represents a message associated with the overlay system and has a composition that includes a dynamic dataset associated with the message, where the dynamic dataset includes one or more timestamps of one or more milestones associated with the corresponding message, and
wherein each time-series analytics overlay node, of the first set of time-series analytics overlay nodes, is configured to execute a first set of time-series computation functions on the dynamic dataset of the corresponding message node; and
processing circuitry that is coupled to the storage element, and configured to:
receive a first stimulus associated with the overlay system;
identify, in the executable graph-based model, based on a context of the first stimulus, (i) one or more time-series analytics overlay nodes, of the plurality of time-series analytics overlay nodes, to perform time-series analytics associated with the first stimulus and (ii) one or more message nodes, of the plurality of message nodes, for which the time-series analytics is to be performed, wherein the one or more time-series analytics overlay nodes comprise at least one of the first set of time-series analytics overlay nodes of each message node of the one or more message nodes; and
execute an operation associated with the first stimulus based on the one or more time-series analytics overlay nodes and the one or more message nodes.

2. The overlay system of claim 1,
wherein each time-series computation function of the first set of time-series computation functions includes one or more mathematical computations that, when performed on the dynamic dataset of the corresponding message node, generates a computation output indicative of performance of the overlay system, and
wherein the processing circuitry is further configured to generate an analytics outcome by executing one or more database operations on the computation output of each time-series computation function of the first set of time-series computation functions of the one or more time-series analytics overlay nodes.

3. The overlay system of claim 1,
wherein the executable graph-based model further comprises a plurality of publisher overlay nodes,
wherein each publisher overlay node is associated with at least one time-series analytics overlay node of the plurality of time-series analytics overlay nodes, and configured to generate and publish one or more statistical insights associated with performance of the overlay system based on the first set of time-series computation functions executed by the corresponding time-series analytics overlay node,
wherein the processing circuitry executes the operation associated with the first stimulus further based on a set of publisher overlay nodes, of the plurality of publisher overlay nodes, associated with the one or more time-series analytics overlay nodes, and
wherein the processing circuitry is further configured to generate an analytics outcome based on the one or more statistical insights generated by each publisher overlay node of the set of publisher overlay nodes.

4. The overlay system of claim 3,
wherein based on the first stimulus, each of the one or more time-series analytics overlay nodes executes the first set of time-series computation functions on the dynamic dataset of the corresponding message node to determine a corresponding set of computation outputs, that is indicative of performance of the overlay system, while completing the one or more milestones of the corresponding message node,
wherein each publisher overlay node of the set of publisher overlay nodes is coupled to at least one of the one or more time-series analytics overlay nodes, and generates and publishes the one or more statistical insights based on the set of computation outputs determined by the corresponding time-series analytics overlay node, and
wherein the execution of the operation associated with the first stimulus corresponds to the generation and publication of the one or more statistical insights by each publisher overlay node of the set of publisher overlay nodes and generation of the analytics outcome.

5. The overlay system of claim 1, wherein the dynamic dataset of each message node of the plurality of message nodes includes at least one of a group consisting of a received on attribute, a handled on attribute, a processed on attribute, a subscriber identifier, an allow retry attribute, a maximum retry allowed attribute, a current retry count, a retry source identifier, a source identifier, and a source type, associated with a corresponding message.

6. The overlay system of claim 1,
wherein the composition of each message node of the plurality of message nodes further includes a static dataset that includes at least one of a group consisting of an identifier, one or more correlation identifiers, a user identifier, a name, a category, a topic, a key, a scope attribute, an execution attribute, an action attribute, a created on attribute, a raised on attribute, a publisher identifier, and data, associated with a corresponding message,
wherein each time-series analytics overlay node, of the plurality of time-series analytics overlay nodes, is further configured to execute the corresponding first set of time-series computation functions on the static dataset, and
wherein the operation associated with the first stimulus is executed further based on the first set of time-series computation functions executed by each of the one or more time-series analytics overlay nodes on the static dataset of the corresponding message node.

7. The overlay system of claim 1,
wherein each time-series computation function of the first set of time-series computation functions includes one or more parameters, where a parameter value of each of the one or more parameters is derived from the dynamic dataset of the corresponding message node,
wherein each time-series analytics overlay node of the one or more time-series analytics overlay node is further configured to execute each time-series computation function of the corresponding first set of time-series computation functions based on the derived one or more parameter values of the associated one or more parameters, respectively,
wherein for each time-series analytics overlay node of the one or more time-series analytics overlay nodes, one or more statistical insights indicative of performance of the overlay system are determined based on the execution of each time-series computation function of the corresponding first set of time-series computation functions, and
wherein during the processing of the first stimulus, the processing circuitry is further configured to generate an analytics outcome based on the one or more statistical insights associated with each of the one or more time-series analytics overlay nodes.

8. The overlay system of claim 7, wherein for each time-series analytics overlay node of the plurality of time-series analytics overlay nodes, the processing circuitry is further configured to define the one or more parameters of each time-series computation function of the corresponding first set of time-series computation functions based on one of a group consisting of (i) the one or more milestones associated with the message represented by the corresponding message node and (ii) a user input.

9. The overlay system of claim 1, wherein the one or more milestones associated with each message of the overlay system include at least one of a group consisting of a creation event, a raise event, a subscription event, a handle event, and a process event.

10. The overlay system of claim 1,
wherein a plurality of messages are associated with the overlay system,
wherein the processing circuitry is further configured to generate the executable graph-based model based on the plurality of messages and store the executable graph-based model in the storage element, and
wherein, to generate the executable graph-based model, the processing circuitry is further configured to instantiate one message node for each message of the plurality of messages associated with the overlay system and instantiate a time-series analytics overlay node, of the plurality of time-series analytics overlay nodes, as an overlay of the instantiated message node for facilitating the time-series analytics on the corresponding message node.

11. The overlay system of claim 1,
wherein a set of messages associated with the overlay system is correlated such that a first message of the set of messages has a causal association with a second message of the set of messages, and as a result, a first message node, of the plurality of message nodes, representing the first message has a causal association with a second message node, of the plurality of message nodes, representing the second message,
wherein the executable graph-based model further comprises a plurality of message edge nodes, with a first message edge node coupling the first message node and the second message node,
wherein the first message edge node includes a first message role and a second message role that enable coupling thereof to the first message node and the second message node, respectively, and collectively defines the causal association between the first message node and the second message node,
wherein the identification of the one or more message nodes associated with the first stimulus is enabled based on one or more message edge nodes associated with each of the one or more message nodes, and
wherein the operation associated with the first stimulus is executed further based on the one or more message edge nodes associated with each of the one or more message nodes.

12. The overlay system of claim 1,
wherein a first message represented by a first message node, of the one or more message nodes identified for stimulus processing of the first stimulus, is associated with a set of messages,
wherein the set of messages is correlated such that each message of the set of messages has a causal association with at least one other message of the set of messages,
wherein the set of messages is generated based on at least a second stimulus received prior to the first stimulus,
wherein the processing circuitry is further configured to identify, for the stimulus processing of the first stimulus, a set of message nodes associated with the set of messages and at least one time-series analytics overlay node associated with each message node of the set of message nodes, and
wherein the processing circuitry executes the operation associated with the first stimulus further based on the identified set of message nodes and the identified time-series analytics overlay node associated with each message node of the set of message nodes.

13. The overlay system of claim 12, wherein the first message node and the set of message nodes are linked by way of one or more correlation identifiers.

14. The overlay system of claim 12,
wherein the set of message nodes is instantiated in the executable graph-based model in response to the second stimulus, where the set of message nodes includes a parent message node and one or more child message nodes, and
wherein the processing circuitry is further configured to (i) instantiate the parent message node based on generation of a root message of the set of messages, where the root message is generated based on stimulus processing of the second stimulus, and (ii) instantiate a first set of child message nodes of the one or more child message nodes for a first set of child messages that is generated based on processing of the root message.

15. The overlay system of claim 14, wherein the first message is generated based on processing of the first set of child message nodes.

16. The overlay system of claim 14,
wherein the parent message node and the first set of child message nodes are associated with a root correlation identifier that is indicative of a transactional operation associated with the root message for executing a first transaction in the executable graph-based model in response to the second stimulus, and
wherein the association of the root correlation identifier with the parent message node and the first set of child message nodes indicates a causal association between the root message and the first set of child messages.

17. The overlay system of claim 14,
wherein the processing circuitry is further configured to instantiate a second set of child message nodes of the one or more child message nodes for a second set of child messages generated based on the processing of the first set of child messages, and
wherein the first message is generated based on processing of the second set of child message nodes.

18. The overlay system of claim 17,
wherein a root correlation identifier is associated with each of the parent message node, the first set of child message nodes, and the second set of child message nodes, where the root correlation identifier is indicative of a transactional operation that is associated with the root message, where the transactional operation pertains to a second transaction that is executed in the executable graph-based model in response to the second stimulus,
wherein the association of the root correlation identifier with each of the parent message node, the first set of child message nodes, and the second set of child message nodes indicates a causal association therebetween,
wherein each of the second set of child message nodes is further associated with a sub-correlation identifier, and
wherein a value of the sub-correlation identifier associated with each of the second set of child message nodes is unique, where each unique value of the sub-correlation identifier is indicative of a distinct transactional operation associated with a corresponding child message node of the second set of child message nodes, where the distinct transactional operation associated with each child message node of the second set of child message nodes is executed for performing a corresponding transaction in the executable graph-based model.

19. The overlay system of claim 1,
wherein the executable graph-based model further comprises a plurality of attribute vertex nodes and a plurality of attribute edge nodes,
wherein each message node of the plurality of message nodes is associated with one or more attribute vertex nodes, of the plurality of attribute vertex nodes, with the one or more attribute vertex nodes configured to store the composition of the corresponding message node,
wherein each message node of the plurality of message nodes is associated with the one or more attribute vertex nodes by way of one or more attribute edge nodes of the plurality of attribute edge nodes, respectively, with the one or more attribute edge nodes defining the association between the one or more vertex nodes and the corresponding message node, respectively, and
wherein during the processing of the first stimulus, the processing circuitry is further configured to determine the composition of each message node of the one or more message nodes by tracking at least one of a group consisting of (i) the one or more attribute vertex nodes and (ii) the one or more attribute edge nodes coupled thereto.

20. A method, comprising:
receiving, by processing circuitry of an overlay system, a stimulus associated with the overlay system,
wherein an executable graph-based model is stored in a storage element of the overlay system,
wherein the executable graph-based model comprises a plurality of message nodes and a plurality of time-series analytics overlay nodes, with each message node having a set of time-series analytics overlay nodes associated therewith,
wherein each message node represents a message associated with the overlay system and has a composition that includes a dynamic dataset associated with the message, where the dynamic dataset includes one or more timestamps of one or more milestones associated with the corresponding message, and
wherein each time-series analytics overlay node, of the set of time-series analytics overlay nodes, executes a set of time-series computation functions on the dynamic dataset of the corresponding message node;
identifying, in the executable graph-based model, based on a context of the stimulus, (i) one or more time-series analytics overlay nodes, of the plurality of time-series analytics overlay nodes, to perform time-series analytics associated with the stimulus and (ii) one or more message nodes, of the plurality of message nodes, for which the time-series analytics is to be performed, wherein the one or more time-series analytics overlay nodes comprise at least one of the set of time-series analytics overlay nodes of each message node of the one or more message nodes; and
executing an operation associated with the stimulus based on the one or more time-series analytics overlay nodes and the one or more message nodes.
